(19) United States
(12) Patent Application Publication
(10) Pub. No.: US 2008/0255000 A1
(43) Pub. Date: Oct. 16, 2008

(54) Method Evolved for Recognition and Testing of Age Related Macular Degeneration (Mert-Armd)

(76) Inventors: Cigdem F. Dogulu, Bethesda, MD (US); Owen M. Rennert, Potomac, MD (US); Wai-yee Chan, Potomac, MD (US)

Correspondence Address: KLARQUIST SPARKMAN, LLP, 121 S.W. SALMON STREET, SUITE #1600, PORTLAND, OR, 97204-2988, US

(21) Appl. No.: 12/089,694

(22) PCT Filed: Nov. 2, 2006
(86) PCT No.: PCT/US06/42903

§ 371 Date: Apr. 9, 2008

Related U.S. Application Data
(60) Provisional application No. 60/733,042, filed on Nov. 2, 2005.

(51) Int. Cl. C40B 30/04; C40B 40/08

(52) U.S. Cl. 506/9; 506/17

(57) ABSTRACT

Methods for predicting an individual's genetic risk for developing ARMD is disclosed, as are arrays and kits which can be used to practice the method. The method includes screening for mutations and/or polymorphisms in ARMD-associated molecules, such as CFH, LOC387715, BF, C2, ABCR, Fibulin 5, VMD2, TLR4, CX3CR1, CST3, MnSOD, MEHE, paraoxonase, APOE, ELOVL4 and hemicentin-1.

### CROSS REFERENCE TO RELATED APPLICATION

This application claims the benefit of U.S. Provisional Application No. 60/733,042 filed Nov. 2, 2005, which is hereby incorporated by reference in its entirety.

### FIELD

This application relates to methods of predicting an individual's genetic susceptibility to age-related macular degeneration, as well as arrays that can be used to practice the disclosed methods.

### BACKGROUND

Age-related macular degeneration (ARMD) is a degenerative eye disease that affects the macula, which is a photoreceptor-rich area of the central retina that provides detailed vision. ARMD results in a sudden worsening of central vision that usually only leaves peripheral vision intact. Macular degeneration is the most common cause of severe vision loss in the United States and in developed countries among people aged 65 years and older. The disease typically presents with a decrease in central vision in one eye, followed within months or years by a similar loss of central vision on the other eye. Clinical signs of the disease include the presence of deposits (drusen) in the macula.

Despite being a major public health burden, the etiology and pathogenesis of ARMD are still poorly understood. Although there have been relatively few studies of the genetic epidemiology for a condition as common as ARMD, there is nonetheless enough evidence to propose ARMD as a multifactorial disorder that is caused by environmental factors triggering disease phenotype in genetically susceptible subjects. ARMD is a multigenic disorder with a number of variably penetrant genetic mutations and/or polymorphisms that impart in developing ARMD. The risk that is associated with each genetic defect may be relatively low in isolation but the simultaneous presence of several variants may dramatically increase disease susceptibility in the presence of conditions or risk factors that contribute to ARMD, such as aging, smoking, and diet.

Previous reports describe screening for one or more polymorphisms associated with ARMD (see, for example PCT Publication No. WO2005077006; U.S. Pat. No. 5,498,521). In general, these assays are limited because they do not have clinical predictive value. Therefore, there is a need for a method that can accurately predict the risk of an individual for developing ARMD, which in some examples can be used to screen multiple ethnic populations.

### SUMMARY

The inventors have determined that concurrent genetic testing for ARMD can accurately assess genetic susceptibility risk and has sufficient predictive power to be clinically applicable. In one example, the combinations of mutations including polymorphisms in molecules known to be associated with ARMD allow for prediction of the overall genetic susceptibility of an individual to developing ARMD with high accuracy.

The disclosed statistical analysis regarding concurrent testing of at least 11 ARMD risk-associated genetic variations in at least 9 genes using the disclosed method in some examples demonstrated that the prediction of ARMD is up to 98%. The disclosed methods, herein termed method evolved for recognition and testing of ARMD (MERT-ARMD), provide a rapid and cost-effective assay that allows for concurrent genetic testing in all molecules that are currently associated with ARMD susceptibility, for example, complement factor H (CFH), LOC387715, complement factor B (BF), complement component 2 (C2), ATP-binding cassette R (ABCR), Fibulin 5 (FBLN5), vitelliform macular dystrophy (VMD2), toll-like receptor 4 (TLR4), CX3CR1, cystatin C (CST3), manganese superoxide dismutase (MnSOD), microsomal epoxide hydrolase (MEHE), paraoxonase, apolipoprotein E (APOE), ELOVL4 and hemicentin-1. In one embodiment, the method includes determining whether a subject has one or more mutations, polymorphisms, or both, in ARMD-associated molecules that comprise, consist essentially of, or consist of, sequences from CFH, LOC387715, BF, C2, ABCR, Fibulin 5, VMD2, TLR4, CX3CR1, CST3, MnSOD, MEHE, paraoxonase, APOE, ELOVL4 and hemicentin-1. In particular embodiments, screening is performed for 105 ARMD associated mutations including polymorphisms in 16 different genes, for example by using hybridization based high density oligonucleotide array technology. In one example, the oligonucleotide array includes probes for at least 210 alleles, including wild type and mutant alleles. The 105 ARMD associated mutations in the 16 different genes for this example are shown in Table 1A.

In other examples, screening is performed for at least 14 ARMD associated susceptibility genotypes in at least 11 ARMD associated genes with an established prevalence both in a control population and ARMD patients, such as those genes in Table 2.

Testing for an individual mutation or a polymorphism provides limited predictive information about the probability of developing ARMD (the posterior probability of disease ranges from 0.1% to 0.98% for each test alone). In a particular example, the posterior probability of ARMD increases to 98% by using MERT-ARMD, an increase of greater than 90-fold. The methods and arrays disclosed herein are the first offering a highly accurate, overall ARMD genetic susceptibility prediction, for example by screening mutations and/or polymorphisms in all genes associated with ARMD. In particular examples, the 105 mutations and/or polymorphisms (Table 1A) currently associated with ARMD are screened, or a subset of all such known mutations and/or polymorphisms such as at least 10, at least 20, at least 30, at least 40, at least 50, at least 60, at least 70, at least 75, at least 80, at least 90, at least 95, at least 100 such as 10, 20, 30, 40, 50, 60, 70, 75, 80, 90, 95, 96, 97, 98, 99, 101, 102, 103, and 104 of such mutations and/or polymorphisms.

In particular examples, the method uses genomic DNA microarray technology to detect a subject's overall genetic susceptibility to ARMD, and links the microarray data directly to the combined likelihood ratio for the panel of ARMD-associated susceptibility genes.

In a particular example, the method includes amplifying nucleic acid molecules obtained from a subject to obtain amplification products. For example, the amplification products can comprise, consist essentially of, or consist of, sequences from CFH, LOC387715, BF, C2, ABCR, Fibulin 5, VMD2, TLR4, CX3CR1, CST3, MnSOD, MEHE, paraoxonase, APOE, ELOVL4 and hemicentin-1 such as at least 100, or at least 200, contiguous nucleotides of such sequences. The resulting amplification products are contacted with or applied to an array. The array can include oligonucleotide probes capable of hybridizing to CFH, LOC387715, BF, C2, ABCR, Fibulin 5, VMD2, TLR4, CX3CR1, CST3, MnSOD, MEHE, paraoxonase, APOE, ELOVL4 and hemicentin-1 sequences that include one or more mutations and/or polymorphisms. Examples of particular mutations are provided in Table 1A though the disclosure is not limited to these as one skilled in the art will appreciate that other mutations and/or polymorphisms may be identified in the future. In some examples, the array further includes oligonucleotides capable of hybridizing to wild-type CFH, wild-type LOC387715, wild-type BF, wild-type C2, wild-type ABCR, wild-type Fibulin 5, wild-type VMD2, wild-type TLR4, wild-type CX3CR1, wild-type CST3, wild-type MnSOD, wild-type MEHE, wild-type paraoxonase, wild-type APOE, wild-type ELOVL4 and wild-type hemicentin-1. The amplification products are incubated with the array under conditions sufficient to allow hybridization between the amplification products and oligonucleotide probes, thereby forming amplification products:oligonucleotide probe complexes. The amplification products:oligonucleotide probe complexes are then analyzed to determine if the amplification products include one or more mutations and/or polymorphisms in CFH, LOC387715, BF, C2, ABCR, Fibulin 5, VMD2, TLR4, CX3CR1, CST3, MnSOD, MEHE, paraoxonase, APOE, ELOVL4 and hemicentin-1. Detection of one or more mutations or one or more polymorphisms indicates that the subject has a genetic predisposition for ARMD. In particular examples, the presence of more than one mutation and/or polymorphism (such as at least 2, at least 3, at least 4, at least 5, at least 6, at least 7, at least 8, at least 9, at least 10, or at least 11 mutations and/or polymorphisms) indicates that the subject is at a greater risk for ARMD than is a subject having only one mutation or polymorphism.

The disclosed methods can accurately assess the overall genetic risk of developing ARMD and thereby lead to reducing or avoiding ARMD, for example by offering a therapeutic approach that combines environmental, dietary and future pharmacological modalities to minimize the impact of genetic susceptibility and preserve sight. The results presented herein demonstrate that concurrent use of a panel of genetic tests for at least 11 molecules associated with ARMD increases the positive predictive value more than 90-fold, when used for detecting ARMD or a predisposition to its development. Therefore, methods of selecting ARMD therapy are disclosed, which include detecting a mutation (such as one or more substitutions, deletions or insertions) in at least one ARMD-related molecule of a subject, or a statistically significant number of ARMD-related molecules, using the methods disclosed herein and if such mutations and/or polymorphisms are identified, selecting a therapeutic approach (such as one that combines environmental, dietary and future pharmacological modalities) to minimize the impact of genetic susceptibility to treat ARMD (such as avoid ARMD, delay the onset of ARMD, or minimize its consequences).

Also disclosed are arrays capable of rapid, cost-effective multiple genetic testing for ARMD genetic susceptibility, such as overall ARMD genetic susceptibility. Such arrays in some examples include oligonucleotides that are complementary to at least 10, such as 25 contiguous nucleotides of CFH, LOC387715, BF, C2, ABCR, Fibulin 5, VMD2, TLR4, CX3CR1, CST3, MnSOD, MEHE, paraoxonase, APOE, ELOVL4 and hemicentin-1 wild-type or mutated sequences, or both. Kits including such arrays for detecting a genetic predisposition to ARMD in a subject are also disclosed.

The foregoing and other features and advantages of the disclosure will become more apparent from the following detailed description of a several embodiments.

### SEQUENCE LISTING

Nucleic acid sequences useful in the methods of the present disclosure are described below. The actual nucleotide and amino acid sequences are known in the art. The Accession Nos. provided below are examples of possible sequences that may be used in the methods of the disclosure.

SEQ ID NOs: 1-210 are exemplary nucleic acid probes that can be used to detect the presence of CFH, LOC387715, BF, C2, ABCR, Fibulin 5, VMD2, TLR4, CX3CR1, CST3, MnSOD, MEHE, paraoxonase, APOE, ELOVL4 and hemicentin-1.

### DETAILED DESCRIPTION OF SEVERAL EMBODIMENTS

### I. Introduction

Although age-related macular degeneration is the leading cause of blindness in the elderly, there is no currently available treatment once the disease is diagnosed. Thus, identification of individuals who have an increased risk for developing ARMD before they are symptomatic or have serious pathology is important to offer a therapeutic approach (such as one that combines environmental, dietary and future pharmacological modalities) to minimize the impact of genetic susceptibility and preserve sight.

The disclosed MERT-ARMD methods and oligonucleotide microarray offer a highly accurate ARMD prediction by concurrent screening of all currently known genetic defects that have been associated with ARMD susceptibility.

### II. Abbreviations and Terms

ABC adenosine triphosphate-binding cassette
Apo E apolipoprotein E
ARMD age-related macular degeneration
BF complement factor B
bp base pair
C2 complement component C2
CFH complement factor H
CST3 cystatin C
ELOVL4 Elongation of very long chain fatty acids 4
FBLN5 fibulin 5
MEHE Microsomal Epoxide Hydrolase
MERT-ARMD method evolved for recognition and testing of age-related macular degeneration
MnSOD Manganese Superoxide Dismutase
SNP single nucleotide polymorphism
TRL4 Toll-like receptor 4
VMD2 Vitelliform macular dystrophy gene 2

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. For example, the term “comprising a nucleic acid” includes single or plural nucleic acids and is considered equivalent to the phrase “comprising at least one nucleic acid.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. For example, the phrase “mutations or polymorphisms” or “one or more mutations or polymorphisms” means a mutation, a polymorphism, or combinations thereof, wherein “a” can refer to more than one.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

ABCR: The ABCR protein is a member of the adenosine triphosphate-binding cassette (ABC) transporter superfamily and is involved in the transport of lipids, hydrophobic drugs and peptides. In particular, it is believed to transport retinal and/or retinal-phospholipid complexes from the rod photoreceptor outer segment disks to the cytoplasm, facilitating phototransduction. ABCR is also known as ABCA4.

The term ABCR includes any ABCR gene, cDNA, mRNA, or protein from any organism and that is ABCR and involved in the development of ARMD.

Nucleic acid sequences for ABCR are publicly available. For example,

GenBank Accession Nos: NM_{—}00350 and NM_{—}007378 disclose exemplary ABCR nucleic acid sequences.

In one example, ABCR includes a full-length wild-type (or native) sequence, as well as ABCR allelic variants, fragments, homologs or fusion sequences that retain the ability to be involved with the development of ARMD. In certain examples, ABCR has at least 80% sequence identity, for example at least 85%, 90%, 95% or 98% sequence identity to ABCR. In other examples, ABCR has a sequence that hybridizes under very high stringency conditions to a sequence set forth in GenBank Accession Nos. NM_{—}00350 and NM_{—}007378 and retains ABCR activity (e.g., ability to be involved with the development of ARMD).

African: A human racial classification that includes persons having origins in any of the black racial groups of Africa. In some examples, includes dark-skinned persons who are natives or inhabitants of Africa, as well as persons of African descent, such as African-Americans, wherein such persons also retain substantial genetic similarity to natives or inhabitants of Africa. In a particular example, an African is at least 1/64 African.

Age-related macular degeneration (ARMD): A medical condition where the light sensing cells in the macula malfunction and over time cease to work. In macular degeneration the final form results in missing or blurred vision in the central, reading part of vision. The outer, peripheral part of the vision remains intact. ARMD is further divided into a “dry,” or nonexudative, form and a “wet,” or exudative, form. Eighty-five to ninety percent of cases are categorized as “dry” macular degeneration where fatty tissue, known as drusen, will slowly build up behind the retina. Ten to fifteen percent of cases involve the growth of abnormal blood vessels under the retina. These cases are called “wet” macular degeneration due to the leakage of blood and other fluid from behind the retina into the eye. Wet macular degeneration usually begins as the dry form. If allowed to continue without treatment it will completely destroy the macula. Medical, photodynamic, laser photocoagulation and laser treatment of wet macular degeneration are available.

Risk factors for ARMD include aging, smoking, family history, exposure to sunlight especially blue light, hypertension, cardiovascular risk factors such as high cholesterol and obesity, high fat intake, oxidative stress, and race.

Age-related macular degeneration-related (or associated) molecule: A molecule that is involved in the development of ARMD. Such molecules include, for instance, nucleic acids (such as DNA, cDNA, or mRNAs) and proteins. For example those listed in Table 1A and 1B, as well as fragments of the full-length genes or cDNAs that include the mutation(s) responsible for increasing an individual's susceptibility to ARMD, and proteins and protein fragments encoded thereby.

ARMD-related molecules can be involved in or influenced by ARMD in many different ways, including causative (in that a change in an ARMD-related molecule leads to development of or progression to ARMD) or resultive (in that development of or progression to ARMD causes or results in a change in the ARMD-related molecule).

Allele: A polymorphic variant of a gene.

Amplifying a nucleic acid molecule: To increase the number of copies of a nucleic acid molecule, such as a gene or fragment of a gene, for example a region of an age-related macular degeneration (ARMD)-associated gene. The resulting amplified products are called amplification products.

An example of in vitro amplification is the polymerase chain reaction (PCR), in which a biological sample obtained from a subject is contacted with a pair of oligonucleotide primers, under conditions that allow for hybridization of the primers to a nucleic acid molecule in the sample. The primers are extended under suitable conditions, dissociated from the template, and then re-annealed, extended, and dissociated to amplify the number of copies of the nucleic acid molecule. Other examples of in vitro amplification techniques include quantitative real-time PCR, strand displacement amplification (see U.S. Pat. No. 5,744,311); transcription-free isothermal amplification (see U.S. Pat. No. 6,033,881); repair chain reaction amplification (see WO 90/01069); ligase chain reaction amplification (see European Patent Application 320 308); gap filling ligase chain reaction amplification (see U.S. Pat. No. 5,427,930); coupled ligase detection and PCR (see U.S. Pat. No. 6,027,889); and NASBA™ RNA transcription-free amplification (see U.S. Pat. No. 6,025,134).

Apolipoprotein E (Apo E): Apolipoproteins are a class of apoproteins, which are proteins that depend on the presence of other small molecules, or cofactors, to function. Thus, apolipoproteins are the protein constituents of lipoproteins, which also consist of phospholipids, triacylglycerols, cholesterol, and cholesterol esters. There are five major types of apolipoproteins: A, B, C, D, and E.

The Apo E protein is 299 amino acids long, and a core apoprotein of the chylomicron, which transports lipoproteins, fat-soluble vitamins, and cholesterol into the lymph system and then into the blood.

The apo E gene, which encodes the Apo E protein, is located on chromosome 19, and consists of four exons and three introns totaling 3597 base pairs. The gene is polymorphic, with three major alleles, apo E-3, apo E-2, and apo E-4, which translate into three isoforms of the protein: E3 (normal), and E2 and E4 (dysfunctional). These isoforms differ from each other only by single amino acid substitutions at positions 112 and 158, but have profound physiological consequences.

The term Apo E includes any Apo E gene, cDNA, mRNA, or protein from any organism and that is Apo E and involved in the development of ARMD. Nucleic acid sequences for Apo E are publicly available. For example, GenBank Accession Nos: NM_{—}000041, NM_{—}009696 and NM_{—}138828 disclose exemplary Apo E nucleic acid sequences.

In one example, Apo E includes a full-length wild-type (or native) sequence, as well as Apo E allelic variants, fragments, homologs or fusion sequences that retain the ability to be involved with the development of Apo E. In certain examples, Apo E has at least 80% sequence identity, for example at least 85%, 90%, 95% or 98% sequence identity to Apo E. In other examples, Apo E has a sequence that hybridizes under very high stringency conditions to a sequence set forth in GenBank Accession Nos.: NM_{—}000041, NM_{—}009696 and NM_{—}138828 and retains Apo E activity (e.g., ability to be involved with the development of ARMD).

Array: An arrangement of molecules, such as biological macromolecules (such as polypeptides or nucleic acids) or biological samples (such as tissue sections), in addressable locations on or in a substrate. A “microarray” is an array that is miniaturized so as to require or be aided by microscopic examination for evaluation or analysis. Arrays are sometimes called DNA chips or biochips.

The array of molecules (“features”) makes it possible to carry out a very large number of analyses on a sample at one time. In certain example arrays, one or more molecules (such as an oligonucleotide probe) will occur on the array a plurality of times (such as twice), for instance to provide internal controls. The number of addressable locations on the array can vary, for example from a few (such as three) to at least 50, at least 100, at least 200, at least 250, at least 300, at least 500, at least 600, at least 1000, at least 10,000, or more. In particular examples, an array includes nucleic acid molecules, such as oligonucleotide sequences that are at least 15 nucleotides in length, such as about 15-40 nucleotides in length, such as at least 18 nucleotides in length, at least 21 nucleotides in length, or even at least 25 nucleotides in length. In one example, the molecule includes oligonucleotides attached to the array via their 5′- or 3′-end.

In particular examples, an array includes sequences from SEQ ID NOS:1-210, or subsets thereof, such as SEQ ID NOS:1, 3, 5, 7, 9, 11, 13, 15, 17, 19, 21, 23, 25, 27, 29, 31, 33, 35, 37, 39, 41, 43, 45, 47, 49, 51, 53, 55, 57, 59, 61, 63, 65, 67, 69, 71, 73, 75, 77, 79, 81, 83, 85, 87, 89, 91, 93, 95, 97, 99, 101, 103, 105, 107, 109, 111, 113, 115, 117, 119, 121, 123, 125, 127, 129, 131, 133, 135, 137, 139, 141, 143, 145, 147, 149, 151, 153, 155, 157, 159, 161, 163, 165, 167, 169, 171, 173, 175, 177, 179, 181, 183, 185, 187, 189, 191, 193, 195, 197, 199, 201, 203, 205, 207, and 209 (to detect wild-type ARMD-associated sequences), or SEQ ID NOS:2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, 190, 192, 194, 196, 198, 200, 202, 204, 206, 208 and 210 (to detect mutant ARMD-associated sequences), as well as at least 20 of the sequences shown in SEQ ID NOS:1-210, such as at least 50, at least 75, at least 100 of the sequences shown in SEQ ID NOS:1-210.

Within an array, each arrayed sample is addressable, in that its location can be reliably and consistently determined within the at least two dimensions of the array. The feature application location on an array can assume different shapes. For example, the array can be regular (such as arranged in uniform rows and columns) or irregular. Thus, in ordered arrays the location of each sample is assigned to the sample at the time when it is applied to the array, and a key may be provided in order to correlate each location with the appropriate target or feature position. Often, ordered arrays are arranged in a symmetrical grid pattern, but samples could be arranged in other patterns (such as in radially distributed lines, spiral lines, or ordered clusters). Addressable arrays usually are computer readable, in that a computer can be programmed to correlate a particular address on the array with information about the sample at that position (such as hybridization or binding data, including for instance signal intensity). In some examples of computer readable formats, the individual features in the array are arranged regularly, for instance in a Cartesian grid pattern, which can be correlated to address information by a computer.

Also contemplated herein are protein-based arrays, where the probe molecules are or include proteins, or where the target molecules are or include proteins, and arrays including nucleic acids to which proteins/peptides are bound, or vice versa.

Asian: A human racial classification that includes persons having origins in any of the original peoples of the Far East, Southeast Asia, the Indian subcontinent, or the Pacific Islands. This area includes, for example, China, India, Japan, Korea, the Philippine Islands, and Samoa. In particular examples, Asians include persons of Asian descent, such as Asian-Americans, that retain substantial genetic similarity to natives or inhabitants of Asia. In a particular example, an Asian is at least 1/64 Asian.

Binding or stable binding: An association between two substances or molecules, such as the hybridization of one nucleic acid molecule to another (or itself). An oligonucleotide molecule binds or stably binds to a target nucleic acid molecule if a sufficient amount of the oligonucleotide molecule forms base pairs or is hybridized to its target nucleic acid molecule, to permit detection of that binding. Binding can be detected by any procedure known to one skilled in the art, such as by physical or functional properties of the target:oligonucleotide complex. For example, binding can be detected functionally by determining whether binding has an observable effect upon a biosynthetic process such as expression of a gene, DNA replication, transcription, translation, and the like.

Physical methods of detecting the binding of complementary strands of nucleic acid molecules, include but are not limited to, such methods as DNase I or chemical footprinting, gel shift and affinity cleavage assays, Northern blotting, dot blotting and light absorption detection procedures. For example, one method involves observing a change in light absorption of a solution containing an oligonucleotide (or an analog) and a target nucleic acid at 220 to 300 nm as the temperature is slowly increased. If the oligonucleotide or analog has bound to its target, there is a sudden increase in absorption at a characteristic temperature as the oligonucleotide (or analog) and target disassociate from each other, or melt. In another example, the method involves detecting a signal, such as a detectable label, present on one or both complementary strands.

The binding between an oligomer and its target nucleic acid is frequently characterized by the temperature (Tₘ) at which 50% of the oligomer is melted from its target. A higher (Tₘ) means a stronger or more stable complex relative to a complex with a lower (Tₘ).

Caucasian: A human racial classification traditionally distinguished by physical characteristics such as very light to brown skin pigmentation and straight to wavy or curly hair, which includes persons having origins in any of the original peoples of Europe, North Africa, or the Middle East. Popularly, the word “white” is used synonymously with “Caucasian” in North America. Such persons also retain substantial genetic similarity to natives or inhabitants of Europe, North Africa, or the Middle East. In a particular example, a Caucasian is at least 1/64 Caucasian.

Complementarity and percentage complementarity: Molecules with complementary nucleic acids form a stable duplex or triplex when the strands bind, (hybridize), to each other by forming Watson-Crick, Hoogsteen or reverse Hoogsteen base pairs. Stable binding occurs when an oligonucleotide molecule remains detectably bound to a target nucleic acid sequence under the required conditions.

Complementarity is the degree to which bases in one nucleic acid strand base pair with the bases in a second nucleic acid strand. Complementarity is conveniently described by percentage, that is, the proportion of nucleotides that form base pairs between two strands or within a specific region or domain of two strands. For example, if 10 nucleotides of a 15-nucleotide oligonucleotide form base pairs with a targeted region of a DNA molecule, that oligonucleotide is said to have 66.67% complementarity to the region of DNA targeted.

In the present disclosure, “sufficient complementarity” means that a sufficient number of base pairs exist between an oligonucleotide molecule and a target nucleic acid sequence (such as CFH, LOC387715, BF, C2, ABCR, Fibulin 5, VMD2, TLR4, CX3CR1, CST3, MnSOD, MEHE, paraoxonase, APOE, ELOVL4, hemicentin-1 GPR75, LAMC1, LAMC2, and LAMB3) to achieve detectable binding. When expressed or measured by percentage of base pairs formed, the percentage complementarity that fulfills this goal can range from as little as about 50% complementarity to full (100%) complementary. In general, sufficient complementarity is at least about 50%, for example at least about 75% complementarity, at least about 90% complementarity, at least about 95% complementarity, at least about 98% complementarity, or even at least about 100% complementarity (such as at least about 50%, for example at least about 75% complementarity, at least about 90% complementarity, at least about 95% complementarity, at least about 98% complementarity, or even at least about 100% complementarity to target nucleic acid sequences for genes listed in Table 1A).

A thorough treatment of the qualitative and quantitative considerations involved in establishing binding conditions that allow one skilled in the art to design appropriate oligonucleotides for use under the desired conditions is provided by Beltz et al. Methods Enzymol 100:266-285, 1983, and by Sambrook et al. (ed.), Molecular Cloning: A Laboratory Manual, 2nd ed., vol. 1-3, Cold Spring Harbor Laboratory Press, Cold Spring Harbor, N.Y., 1989.

Complement Factor H (CFH): A serum glycoprotein that controls the function of the alternative complement pathway and acts as a cofactor with factor I (C3b inactivator). Complement Factor H regulates the activity of the C3 convertases such as C4b2a. It is also known as beta-1H.

The term CFH includes any CFH gene, cDNA, mRNA, or protein from any organism and that is CFH and involved in the development of ARMD.

Nucleic acid sequences for CFH are publicly available. For example, GenBank Accession Nos: DQ_{—}233256 and BC012610 disclose exemplary CFH nucleic acid sequences.

In one example, CFH includes a full-length wild-type (or native) sequence, as well as CFH allelic variants, fragments, homologs or fusion sequences that retain the ability to be involved with the development of CFH. In certain examples, CFH has at least 80% sequence identity, for example at least 85%, 90%, 95% or 98% sequence identity to CFH. In other examples, CFH has a sequence that hybridizes under very high stringency conditions to a sequence set forth in GenBank Accession Nos.: DQ_{—}233256 and BC012610 and retains CFH activity (e.g., ability to be involved with the development of ARMD).

Complement Factor B (BF): A serine protease that is involved in the function of the alternative pathway of complement activation. Complement Factor complexes with C3b to create the active C3 convertase.

The term BF includes any BF gene, cDNA, mRNA, or protein from any organism and that is BF and involved in the development of ARMD.

Nucleic acid sequences for BF are publicly available. For example,

GenBank Accession Nos: NM_{—}001710, NM_{—}008198, and BC087084 disclose exemplary BF nucleic acid sequences.

In one example, BF includes a full-length wild-type (or native) sequence, as well as BF allelic variants, fragments, homologs or fusion sequences that retain the ability to be involved with the development of BF. In certain examples, BF has at least 80% sequence identity, for example at least 85%, 90%, 95% or 98% sequence identity to BF. In other examples, BF has a sequence that hybridizes under very high stringency conditions to a sequence set forth in GenBank Accession Nos.: NM_{—}001710, NM_{—}008198, and BC087084 and retains BF activity (e.g., ability to be involved with the development of ARMD).

Complement component C2 (C2): A protein that is part of the classical complement pathway. Complement component C2 is involved in activation of C3 and C5.

The term C2 includes any C2 gene, cDNA, mRNA, or protein from any organism and that is C2 and involved in the development of ARMD.

Nucleic acid sequences for C2 are publicly available. For example,

GenBank Accession Nos: NM_{—}000063 and NM_{—}013484 disclose exemplary C2 nucleic acid sequences.

In one example, C2 includes a full-length wild-type (or native) sequence, as well as C2 allelic variants, fragments, homologs or fusion sequences that retain the ability to be involved with the development of C2. In certain examples, C2 has at least 80% sequence identity, for example at least 85%, 90%, 95% or 98% sequence identity to C2. In other examples, C2 has a sequence that hybridizes under very high stringency conditions to a sequence set forth in GenBank Accession Nos.: NM_{—}000063 and NM_{—}013484 and retains C2 activity (e.g., ability to be involved with the development of ARMD).

Cystatin C (CST3): A serum protein that is filtered out of the blood by the kidneys and that serves as a measure of kidney function. Cystatin C is produced steadily by all types of nucleated cells in the body. Its low molecular mass allows it to be freely filtered by the glomerular membrane in the kidney. Its concentration in blood correlates with the glomerular filtration rate. The levels of cystatin C are independent of weight and height, muscle mass, age (over a year of age), and sex. Measurements can be made and interpreted from a single random sample. Cystatin C is a better marker of the glomerular filtration rate and hence of kidney function than creatinine which was the most commonly used measure of kidney function.

The term cystatin C includes any cystatin C gene, cDNA, mRNA, or protein from any organism and that is cystatin C and involved in the development of ARMD.

Nucleic acid sequences for cystatin C are publicly available. For example,

GenBank Accession Nos: NM_{—}000099 and NM_{—}009976 disclose exemplary cystatin C nucleic acid sequences.

In one example, cystatin C includes a full-length wild-type (or native) sequence, as well as cystatin C allelic variants, fragments, homologs or fusion sequences that retain the ability to be involved with the development of cystatin C. In certain examples, cystatin C has at least 80% sequence identity, for example at least 85%, 90%, 95% or 98% sequence identity to cystatin C. In other examples, cystatin C has a sequence that hybridizes under very high stringency conditions to a sequence set forth in GenBank Accession Nos.: NM_{—}000099 and NM_{—}009976 and retains cystatin C activity (e.g., ability to be involved with the development of ARMD).

CX3CR1: A seven-transmembrane high-affinity receptor that mediates both the adhesive and migratory functions of fractalkine, which is involved in leukocyte migration and adhesion and is expressed in retina and RPE cells.

The term CX3CR1 includes any CX3CR1 gene, cDNA, mRNA, or protein from any organism and that is CX3CR1 and involved in the development of ARMD.

Nucleic acid sequences for CX3CR1 are publicly available. For example,

GenBank Accession Nos: NM_{—}001337 and NM_{—}009987 disclose exemplary CX3CR1 nucleic acid sequences.

In one example, CX3CR1 includes a full-length wild-type (or native) sequence, as well as CX3CR1 allelic variants, fragments, homologs or fusion sequences that retain the ability to be involved with the development of CX3CR1. In certain examples, CX3CR1 has at least 80% sequence identity, for example at least 85%, 90%, 95% or 98% sequence identity to CX3CR1. In other examples, CX3CR1 has a sequence that hybridizes under very high stringency conditions to a sequence set forth in GenBank Accession Nos.: NM_{—}001337 and NM_{—}009987 and retains CX3CR1 activity (e.g., ability to be involved with the development of ARMD).

DNA (deoxyribonucleic acid): A long chain polymer which includes the genetic material of most living organisms (some viruses have genes including ribonucleic acid, RNA). The repeating units in DNA polymers are four different nucleotides, each of which includes one of the four bases, adenine, guanine, cytosine and thymine bound to a deoxyribose sugar to which a phosphate group is attached. Triplets of nucleotides, referred to as codons, in DNA molecules code for amino acid in a polypeptide. The term codon is also used for the corresponding (and complementary) sequences of three nucleotides in the mRNA into which the DNA sequence is transcribed.

Deletion: The removal of one or more nucleotides from a nucleic acid sequence (or one or more amino acids from a protein sequence), the regions on either side of the removed sequence being joined together.

ELOVL4: A photoreceptor cell-specific factor involved in the elongation of very long chain fatty acids.

The term ELOVL4 includes any ELOVL4 gene, cDNA, mRNA, or protein from any organism and that is ELOVL4 and involved in the development of ARMD. Nucleic acid sequences for ELOVL4 are publicly available. For example, GenBank Accession Nos: AF279654, AF277093, and AY037298 disclose exemplary ELOVL4 nucleic acid sequences.

In one example, ELOVL4 includes a full-length wild-type (or native) sequence, as well as ELOVL4 allelic variants, fragments, homologs or fusion sequences that retain the ability to be involved with the development of ELOVL4.

In certain examples, ELOVL4 has at least 80% sequence identity, for example at least 85%, 90%, 95% or 98% sequence identity to ELOVL4. In other examples, ELOVL4 has a sequence that hybridizes under very high stringency conditions to a sequence set forth in GenBank Accession Nos.: AF279654, AF277093, and AY037298 and retains ELOVL4 activity (e.g., ability to be involved with the development of ARMD).

Fibulin 5 (FBLN5): A protein that belongs to a family of extracellular proteins expressed in the basement membranes of blood vessels. Fibulin 5 may be important for the polymerization of elastin. Missense mutations in FBLN5, the gene that encodes fibulin 5, appear responsible for 1-2% of cases of age-related macular degeneration (ARMD). FBLN5 is located on chromosome 14 in band 14q32.1.

The term FBLN5 includes any FBLN5 gene, cDNA, mRNA, or protein from any organism and that is FBLN5 and involved in the development of ARMD.

Nucleic acid sequences for FBLN5 are publicly available. For example,

GenBank Accession Nos: NM_{—}006329 and NM_{—}011812 disclose exemplary FBLN5 nucleic acid sequences.

In one example, FBLN5 includes a full-length wild-type (or native) sequence, as well as FBLN5 allelic variants, fragments, homologs or fusion sequences that retain the ability to be involved with the development of FBLN5. In certain examples, FBLN5 has at least 80% sequence identity, for example at least 85%, 90%, 95% or 98% sequence identity to FBLN5. In other examples, FBLN5 has a sequence that hybridizes under very high stringency conditions to a sequence set forth in GenBank Accession Nos.: NM_{—}006329 and NM_{—}011812 and retains FBLN5 activity (e.g., ability to be involved with the development of ARMD).

Genetic predisposition: Susceptibility of a subject to a genetic disease, such as ARMD. However, having such susceptibility may or may not result in actual development of the disease.

Genotype: Specific genetic makeup of an individual, in the form of DNA.

Hemicentin-1: Encodes proteins containing a series of predicted calcium-binding epidermal growth factor-like (cbEGF) domains followed by a single unusual EGF-like domain at their carboxy termini. Hemicentin-1 is a conserved extracellular matrix protein with 48 tandem immunoglobulin repeats flanked by novel terminal domains. Hemicentin-1 is also known as Fibulin 6. Hemicentin-1 is secreted from skeletal muscle and gonadal leader cells, hemicentin assembles into fine tracks at specific sites, where it contracts broad regions of cell contact into oriented linear junctions. Some tracks organize hemidesmosomes in the overlying epidermis. Hemicentin tracks facilitate mechanosensory neuron anchorage to the epidermis, gliding of the developing gonad along epithelial basement membranes and germline cellularization (Vogel and Hedgecock, Development 128(6):883-894, 2001).

The term hemicentin-1 includes any hemicentin-1 gene, cDNA, mRNA, or protein from any organism and that is hemicentin-1 and involved in the development of ARMD.

Nucleic acid sequences for hemicentin-1 are publicly available. For example, GenBank Accession Nos: NM_{—}031935 and BC016539 disclose exemplary hemicentin-1 nucleic acid sequences.

In one example, hemicentin-1 includes a full-length wild-type (or native) sequence, as well as hemicentin-1 allelic variants, fragments, homologs or fusion sequences that retain the ability to be involved with the development of hemicentin-1. In certain examples, hemicentin-1 has at least 80% sequence identity, for example at least 85%, 90%, 95% or 98% sequence identity to hemicentin-1. In other examples, hemicentin-1 has a sequence that hybridizes under very high stringency conditions to a sequence set forth in GenBank Accession Nos.: NM_{—}001337 and BC016539 and retains hemicentin-1 activity (e.g., ability to be involved with the development of ARMD).

Human G Protein Coupled Receptor-75 (GPR75) gene: A member of the G protein-coupled receptor family. GPRs are cell surface receptors that activate guanine-nucleotide binding proteins upon the binding of a ligand.

The term GPR75 includes any GPR75 gene, cDNA, mRNA, or protein from any organism and that is GPR75 and involved in the development of ARMD.

Nucleic acid sequences for GPR75 are publicly available. For example, GenBank Accession Nos: NM_{—}006794 and NM_{—}175490 disclose exemplary GPR75 nucleic acid sequences.

In one example, GPR75 includes a full-length wild-type (or native) sequence, as well as GPR75 allelic variants, fragments, homologs or fusion sequences that retain the ability to be involved with the development of GPR75. In certain examples, GPR75 has at least 80% sequence identity, for example at least 85%, 90%, 95% or 98% sequence identity to GPR75. In other examples, GPR75 has a sequence that hybridizes under very high stringency conditions to a sequence set forth in GenBank Accession Nos.: NM_{—}001337 and NM_{—}175490 and retains GPR75 activity (e.g., ability to be involved with the development of ARMD).

Hybridization: To form base pairs between complementary regions of two strands of DNA, RNA, or between DNA and RNA, thereby forming a duplex molecule. Hybridization conditions resulting in particular degrees of stringency will vary depending upon the nature of the hybridization method and the composition and length of the hybridizing nucleic acid sequences. Generally, the temperature of hybridization and the ionic strength (such as the Na⁺ concentration) of the hybridization buffer will determine the stringency of hybridization. Calculations regarding hybridization conditions for attaining particular degrees of stringency are discussed in Sambrook et al., (1989) Molecular Cloning, second edition, Cold Spring Harbor Laboratory, Plainview, N.Y. (chapters 9 and 11). The following is an exemplary set of hybridization conditions and is not limiting:

Very High Stringency (Detects Sequences that Share at Least 90% Identity)
Hybridization: 5×SSC at 65° C. for 16 hours
Wash twice: 0.5×SSC at 65° C. for 20 minutes each
Wash twice: 0.1×-0.2×SSC at room temperature (RT) to 65° C. for 15 minutes each

High Stringency (Detects Sequences that Share at Least 80% Identity)
Hybridization: 5×-6×SSC at 65° C.-70° C. for 16-20 hours
Wash twice: 1×SSC at 55° C.-70° C. for 30 minutes each
Wash twice: 0.5×SSC or 0.5% SSC with 0.5% SDS at RT to 65° C.

for 5-20 minutes each

Low Stringency (Detects Sequences that Share at Least 50% Identity)
Hybridization: 6×SSC at RT to 65° C. for 16-20 hours
Wash at least twice: 2×-4×SSC or 2×SSC with 0.5% SDS at RT to 65° C. for 15-30 minutes each.

Insertion: The addition of one or more nucleotides to a nucleic acid sequence, or the addition of one or more amino acids to a protein sequence.

Isolated: An “isolated” biological component (such as a nucleic acid molecule, protein, or organelle) has been substantially separated or purified away from other biological components in the cell of the organism in which the component naturally occurs, such as other chromosomal and extra-chromosomal DNA and RNA, proteins and organelles. Nucleic acid molecules and proteins that have been “isolated” include nucleic acid molecules and proteins purified by standard purification methods. The term also embraces nucleic acid molecules and proteins prepared by recombinant expression in a host cell as well as chemically synthesized nucleic acid molecules and proteins.

Label: An agent capable of detection, for example by ELISA, spectrophotometry, flow cytometry, or microscopy. For example, a label can be attached to a nucleic acid molecule (such as a probe specific for one of the genes listed in Table 1A such as those shown in SEQ ID NOs: 1-210 shown in Table 1B or to an amplification product), thereby permitting detection of the nucleic acid molecule. Examples of labels include, but are not limited to, radioactive isotopes, enzyme substrates, co-factors, ligands, chemiluminescent agents, fluorophores, haptens, enzymes, and combinations thereof. Methods for labeling and guidance in the choice of labels appropriate for various purposes are discussed for example in Sambrook et al. (Molecular Cloning: A Laboratory Manual, Cold Spring Harbor, N.Y., 1989) and Ausubel et al. (In Current Protocols in Molecular Biology, John Wiley & Sons, New York, 1998).

LAMC1: Laminins, a family of extracellular matrix glycoproteins, are the major noncollagenous constituent of basement membranes. They have been implicated in cell adhesion, differentiation, migration, signaling, neurite outgrowth and metastasis. Laminins are composed of 3 non identical chains: laminin alpha, beta and gamma (formerly A, B1, and B2, respectively) and they form a cruciform structure consisting of 3 short arms, each formed by a different chain, and a long arm composed of all 3 chains. Each laminin chain is a multidomain protein encoded by a distinct gene. Several isoforms of each chain have been described. Different alpha, beta and gamma chain isomers combine to give rise to different heterotrimeric laminin isoforms which are designated by Arabic numerals in the order of their discovery, e.g., alpha1beta1gamma1 heterotrimer is laminin 1. The biological functions of the different chains and trimer molecules are largely unknown, but some of the chains have been shown to differ with respect to their tissue distribution, presumably reflecting diverse functions in vivo. The LAMC1 gene encodes the gamma chain isoform laminin, gamma 1. The gamma 1 chain, formerly thought to be a beta chain, contains structural domains similar to beta chains, however, lacks the short alpha region separating domains I and II. The structural organization of the LAMC1 gene also suggested that it had diverged considerably from the beta chain genes. Embryos of transgenic mice in which both alleles of the gamma 1 chain gene were inactivated by homologous recombination, lacked basement membranes, indicating that laminin, gamma 1 chain is necessary for laminin heterotrimer assembly. It has been inferred by analogy with the strikingly similar 3′ UTR sequence in mouse laminin gamma 1 cDNA, that multiple polyadenylation sites are utilized in human to generate the 2 different sized mRNAs (5.5 and 7.5 kb) seen on Northern analysis.

The term LAMC1 includes any LAMC1 gene, cDNA, mRNA, or protein from any organism and that is LAMC1 and involved in the development of ARMD.

Nucleic acid sequences for LAMC1 are publicly available. For example, GenBank Accession Nos: NM_{—}002293 and NM_{—}010683 disclose exemplary LAMC1 nucleic acid sequences.

In one example, LAMC1 includes a full-length wild-type (or native) sequence, as well as LAMC1 allelic variants, fragments, homologs or fusion sequences that retain the ability to be involved with the development of LAMC1. In certain examples, LAMC1 has at least 80% sequence identity, for example at least 85%, 90%, 95% or 98% sequence identity to LAMC1. In other examples, LAMC1 has a sequence that hybridizes under very high stringency conditions to a sequence set forth in GenBank Accession Nos.: NM_{—}002293 and NM_{—}010683 and retains LAMC1 activity (e.g., ability to be involved with the development of ARMD).

LAMC2: Encodes the gamma chain isoform laminin, gamma 2. The gamma 2 chain, formerly thought to be a truncated version of beta chain (B2t), is highly homologous to the gamma 1 chain; however, it lacks domain VI, and domains V, IV and III are shorter. It is expressed in several fetal tissues but differently from gamma 1, and is specifically localized to epithelial cells in skin, lung and kidney. The gamma 2 chain together with alpha 3 and beta 3 chains constitute laminin 5 (earlier known as kalinin), which is an integral part of the anchoring filaments that connect epithelial cells to the underlying basement membrane. The epithelium-specific expression of the gamma 2 chain implied its role as an epithelium attachment molecule, and mutations in this gene have been associated with junctional epidermolysis bullosa, a skin disease characterized by blisters due to disruption of the epidermal-dermal junction. Two transcript variants resulting from alternative splicing of the 3′ terminal exon, and encoding different isoforms of gamma 2 chain, have been described. The two variants are differentially expressed in embryonic tissues. Transcript variants utilizing alternative polyA signal have also been noted in literature.

The term LAMC2 includes any LAMC2 gene, cDNA, mRNA, or protein from any organism and that is LAMC2 and involved in the development of ARMD.

Nucleic acid sequences for LAMC2 are publicly available. For example, GenBank Accession Nos: AH006634 and NM_{—}008485 disclose exemplary LAMC2 nucleic acid sequences.

In one example, LAMC2 includes a full-length wild-type (or native) sequence, as well as LAMC2 allelic variants, fragments, homologs or fusion sequences that retain the ability to be involved with the development of LAMC2. In certain examples, LAMC2 has at least 80% sequence identity, for example at least 85%, 90%, 95% or 98% sequence identity to LAMC2. In other examples, LAMC2 has a sequence that hybridizes under very high stringency conditions to a sequence set forth in GenBank Accession Nos.: AH006634 and NM_{—}008485 and retains LAMC2 activity (e.g., ability to be involved with the development of ARMD).

LAMB3: Encodes the beta 3 subunit of laminin. Laminin is composed of three subunits (alpha, beta, and gamma), and refers to a family of basement membrane proteins. For example, LAMB3 serves as the beta chain in laminin-5. Mutations in LAMB3 have been identified as the cause of various types of epidermolysis bullosa. Two alternatively spliced transcript variants encoding the same protein have been found for this gene.

The term LAMB3 includes any LAMB3 gene, cDNA, mRNA, or protein from any organism and that is LAMB3 and involved in the development of ARMD.

Nucleic acid sequences for LAMB3 are publicly available. For example, GenBank Accession Nos: L25541, U43298, and NM_{—}008484 disclose exemplary LAMB3 nucleic acid sequences.

In one example, LAMB3 includes a full-length wild-type (or native) sequence, as well as LAMB3 allelic variants, fragments, homologs or fusion sequences that retain the ability to be involved with the development of LAMB3. In certain examples, LAMB3 has at least 80% sequence identity, for example at least 85%, 90%, 95% or 98% sequence identity to LAMB3. In other examples, LAMB3 has a sequence that hybridizes under very high stringency conditions to a sequence set forth in GenBank Accession Nos.: L25541, U43298, and NM_{—}008484 and retains LAMB3 activity (e.g., ability to be involved with the development of ARMD).

LOC387715: A two-exon gene with an unknown biology and encodes a 107 amino acid protein that is expressed mainly in placenta and has recently been reported to be weakly expressed in the retina (Rivera et al., Hum. Mol. Genet. 14:3227-3236, 2005; Schmidt et al., Am. J. Hum. Genet. 78:852-864, 2006).

The term LOC387715 includes any LOC387715 gene, cDNA, mRNA, or protein from any organism and that is LOC387715 and involved in the development of ARMD.

Nucleic acid sequences for LOC387715 are publicly available. For example,

GenBank Accession Nos: NW 924884, NT_{—}030059, XM_{—}001131263, and XM_{—}001131282 disclose exemplary LOC387715 nucleic acid sequences.

In one example, LOC387715 includes a full-length wild-type (or native) sequence, as well as LOC387715 allelic variants, fragments, homologs or fusion sequences that retain the ability to be involved with the development of LOC387715. In certain examples, LOC387715 has at least 80% sequence identity, for example at least 85%, 90%, 95% or 98% sequence identity to LOC387715. In other examples, LOC387715 has a sequence that hybridizes under very high stringency conditions to a sequence set forth in GenBank Accession Nos.: NW_{—}924884, NT_{—}030059, XM_{—}001131263, and XM_{—}001131282 and retains LOC387715 activity (e.g., ability to be involved with the development of ARMD).

Manganese Superoxide Dismutase (MnSOD): Catalyzes the dismutation of two molecules of superoxide anion into water and hydrogen peroxide and is expressed in retina and RPE cells.

The term MnSOD includes any MnSOD gene, cDNA, mRNA, or protein from any organism and that is MnSOD and involved in the development of ARMD.

Nucleic acid sequences for MnSOD are publicly available. For example, GenBank Accession Nos: X65965, AH004779 and D85499 disclose exemplary MnSOD nucleic acid sequences.

In one example, MnSOD includes a full-length wild-type (or native) sequence, as well as MnSOD allelic variants, fragments, homologs or fusion sequences that retain the ability to be involved with the development of MnSOD. In certain examples, MnSOD has at least 80% sequence identity, for example at least 85%, 90%, 95% or 98% sequence identity to MnSOD. In other examples, MnSOD has a sequence that hybridizes under very high stringency conditions to a sequence set forth in GenBank Accession Nos.: X65965, AH004779 and D85499 and retains MnSOD activity (e.g., ability to be involved with the development of ARMD).

Microsomal Epoxide Hydrolase (MEHE): Catalyzes the hydrolysis of the epoxides derived from the oxidative metabolism of xenobiotic chemicals and pollutants and is expressed in retina and RPE cells.

The term MEHE includes any MEHE gene, cDNA, mRNA, or protein from any organism and that is MEHE and involved in the development of ARMD.

Nucleic acid sequences for MEHE are publicly available. For example, GenBank Accession Nos: NM_{—}000120 and NM_{—}010145 disclose exemplary MEHE nucleic acid sequences.

In one example, MEHE includes a full-length wild-type (or native) sequence, as well as MEHE allelic variants, fragments, homologs or fusion sequences that retain the ability to be involved with the development of MEHE. In certain examples, MEHE has at least 80% sequence identity, for example at least 85%, 90%, 95% or 98% sequence identity to MEHE. In other examples, MEHE has a sequence that hybridizes under very high stringency conditions to a sequence set forth in GenBank Accession Nos.: NM_{—}000120 and NM_{—}010145 and retains MEHE activity (e.g., ability to be involved with the development of ARMD).

Mutation: Any change of a nucleic acid sequence as a source of genetic variation such as a polymorphism. For example, mutations can occur within a gene or chromosome, including specific changes in non-coding regions of a chromosome, for instance changes in or near regulatory regions of genes. Types of mutations include, but are not limited to, base substitution point mutations (such as transitions or transversions), deletions, and insertions. Missense mutations are those that introduce a different amino acid into the sequence of the encoded protein; nonsense mutations are those that introduce a new stop codon; and silent mutations are those that introduce the same amino acid often with a base change in the third position of codon. In the case of insertions or deletions, mutations can be in-frame (not changing the frame of the overall sequence) or frame shift mutations, which may result in the misreading of a large number of codons (and often leads to abnormal termination of the encoded product due to the presence of a stop codon in the alternative frame).

Throughout the disclosure, the various mutations are abbreviated according to nomenclature generally used by and known to those of ordinary skill in the art. For example, a substitution for a nucleotide encoding a V instead of an I at a certain amino acid position (such as position 62) for Y gene is represented by I62V. In one example, a nucleotide sequence encoding a 5196+1G→A variant has an A instead of a G at nucleotide residue 5197. In a further example, a nucleotide encoding a 6519Δ11 bp variant represents a nucleotide sequence with a 11 bp deletion starting at nucleotide position 6519.

Nucleic acid array: An arrangement of nucleic acid molecules (such as DNA or RNA) in assigned locations on a matrix, such as that found in cDNA arrays, or oligonucleotide arrays.

Nucleic acid molecules representing genes: Any nucleic acid molecule, for example DNA (intron or exon or both), cDNA or RNA, of any length suitable for use as a probe or other indicator molecule, and that is informative about the corresponding gene.

Nucleic acid molecules: A deoxyribonucleotide or ribonucleotide polymer including, without limitation, cDNA, mRNA, genomic DNA, and synthetic (such as chemically synthesized) DNA. The nucleic acid molecule can be double-stranded or single-stranded. Where single-stranded, the nucleic acid molecule can be the sense strand or the antisense strand. In addition, nucleic acid molecule can be circular or linear.

The disclosure includes isolated nucleic acid molecules that include specified lengths of an ARMD-related nucleotide sequence. Such molecules can include at least 10, at least 15, at least 20, at least 21, at least 25, at least 30, at least 35, at least 40, at least 45 or at least 50 consecutive nucleotides of these sequences or more.

Nucleotide: Includes, but is not limited to, a monomer that includes a base linked to a sugar, such as a pyrimidine, purine or synthetic analogs thereof, or a base linked to an amino acid, as in a peptide nucleic acid (PNA). A nucleotide is one monomer in a polynucleotide. A nucleotide sequence refers to the sequence of bases in a polynucleotide.

Oligonucleotide: An oligonucleotide is a plurality of joined nucleotides joined by native phosphodiester bonds, such as at least 6 nucleotides in length. An oligonucleotide analog refers to moieties that function similarly to oligonucleotides but have non-naturally occurring portions. For example, oligonucleotide analogs can contain non-naturally occurring portions, such as altered sugar moieties or inter-sugar linkages, such as a phosphorothioate oligodeoxynucleotide.

Particular oligonucleotides and oligonucleotide analogs can include linear sequences up to about 200 nucleotides in length, for example a sequence (such as DNA or RNA) that is at least 6 bases, for example at least 8, at least 10, at least 15, at least 20, at least 21, at least 25, at least 30, at least 35, at least 40, at least 45, at least 50, at least 100 or even at least 200 bases long, or from about 6 to about 50 bases, for example about 10-25 bases, such as 12, 15, 20, 21, or 25 bases.

Paraoxonase: A calcium-dependent glycoprotein that is associated with high density lipoprotein and has been shown to prevent LDL oxidation.

The term paraoxonase includes any paraoxonase gene, cDNA, mRNA, or protein from any organism and that is paraoxonase and involved in the development of ARMD.

Nucleic acid sequences for paraoxonase are publicly available. For example, GenBank Accession Nos: NM_{—}000446 and NM_{—}011134 disclose exemplary paraoxonase nucleic acid sequences.

In one example, paraoxonase includes a full-length wild-type (or native) sequence, as well as paraoxonase allelic variants, fragments, homologs or fusion sequences that retain the ability to be involved with the development of paraoxonase. In certain examples, paraoxonase has at least 80% sequence identity, for example at least 85%, 90%, 95% or 98% sequence identity to paraoxonase. In other examples, paraoxonase has a sequence that hybridizes under very high stringency conditions to a sequence set forth in GenBank Accession Nos.: NM_{—}000446 and NM_{—}011134 and retains paraoxonase activity (e.g., ability to be involved with the development of ARMD).

Polymorphism: As a result of mutations, a gene sequence may differ among individuals. The differing sequences are referred to as alleles. The alleles that are present at a given locus (a gene's location on a chromosome is termed as a locus) are referred to as the individual's genotype. Some loci vary considerably among individuals. If a locus has two or more alleles whose frequencies each exceed 1% in a population, the locus is said to be polymorphic. The polymorphic site is termed a polymorphism. The term polymorphism also encompasses variations that produce gene products with altered function, that is, variants in the gene sequence that lead to gene products that are not functionally equivalent. This term also encompasses variations that produce no gene product, an inactive gene product, or increased or decreased activity gene product or even no biological effect.

Polymorphisms can be referred to, for instance, by the nucleotide position at which the variation exists, by the change in amino acid sequence caused by the nucleotide variation, or by a change in some other characteristic of the nucleic acid molecule or protein that is linked to the variation.

Primers: Short nucleic acid molecules, for instance DNA oligonucleotides 10-100 nucleotides in length, such as about 15, 20, 21, 25, 30 or 50 nucleotides or more in length. Primers can be annealed to a complementary target DNA strand by nucleic acid hybridization to form a hybrid between the primer and the target DNA strand. Primer pairs can be used for amplification of a nucleic acid sequence, such as by PCR or other nucleic acid amplification methods known in the art.

Methods for preparing and using nucleic acid primers are described, for example, in Sambrook et al. (In Molecular Cloning: A Laboratory Manual, CSHL, New York, 1989), Ausubel et al. (ed.) (In Current Protocols in Molecular Biology, John Wiley & Sons, New York, 1998), and Innis et al. (PCR Protocols, A Guide to Methods and Applications, Academic Press, Inc., San Diego, Calif., 1990). PCR primer pairs can be derived from a known sequence, for example, by using computer programs intended for that purpose such as Primer (Version 0.5., © 1991, Whitehead Institute for Biomedical Research, Cambridge, Mass.). One of ordinary skill in the art will appreciate that the specificity of a particular primer increases with its length. Thus, for example, a primer including 30 consecutive nucleotides of an ARMD-related protein encoding nucleotide will anneal to a target sequence, such as another homolog of the designated ARMD-related protein, with a higher specificity than a corresponding primer of only 15 nucleotides. Thus, in order to obtain greater specificity, primers can be selected that includes at least 20, at least 21, at least 25, at least 30, at least 35, at least 40, at least 45, at least 50 or more consecutive nucleotides of an ARMD-related protein-encoding nucleotide sequences.

Probes: An isolated nucleic acid molecule such as an oligonucleotide of at least 10 nucleotides and can include at least one detectable label that permits detection of a target nucleic acid. Methods for preparing and using probes are described, for example, in Sambrook et al. (In Molecular Cloning. A Laboratory Manual, Cold Spring Harbor, N.Y., 1989), Ausubel et al. (In Current Protocols in Molecular Biology, Greene Publ. Assoc. and Wiley-Intersciences, 1992), and Innis et al. (PCR Protocols, A Guide to Methods and Applications, Academic Press, Inc., San Diego, Calif., 1990).

The disclosure thus includes probes that include specified lengths of the ARMD-associated gene sequences. Such molecules can include at least 20, 25, 30, 35 or 40 consecutive nucleotides of these sequences, and can be obtained from any region of the disclosed sequences such as a region that can detect a mutation and/or polymorphism associated with ARMD. Nucleic acid molecules can be selected as probe sequences that comprise at least 20, 25, 30, 35 or 40 consecutive nucleotides of any of portions of the ARMD-associated gene. In particular examples, probes include a label that permits detection of probe:target sequence hybridization complexes.

Probes for use with the methods disclosed herein can be designed from the known nucleotide sequences of the ARMD-associated molecules. For example, Genbank Accession Nos. provide possible nucleotide sequences useful for designing probes to detect wild-type alleles. Variant sequences are described that can be used to design probes to detect the polymorphic/variant alleles. The probes can include fragments of the ARMD-associated gene sequences and can comprise, for example, at least 20, 25, 30, 35 or 40 consecutive nucleotides of these ARMD-associated sequences. The probes can detect the presence of a variant allele.

Purified: The term “purified” does not require absolute purity; rather, it is intended as a relative term. Thus, for example, a purified protein preparation is one in which the protein referred to is more pure than the protein in its natural environment within a cell. For example, a preparation of a protein is purified such that the protein represents at least 50% of the total protein content of the preparation. Similarly, a purified oligonucleotide preparation is one in which the oligonucleotide is more pure than in an environment including a complex mixture of oligonucleotides.

Sample: A biological specimen, such as those containing genomic DNA, RNA (including mRNA), protein, or combinations thereof. Examples include, but are not limited to, peripheral blood, urine, saliva, tissue biopsy, surgical specimen, amniocentesis samples, and autopsy material.

Sequence identity/similarity: The identity/similarity between two or more nucleic acid sequences, or two or more amino acid sequences, is expressed in terms of the identity or similarity between the sequences. Sequence identity can be measured in terms of percentage identity; the higher the percentage, the more identical the sequences are. Sequence similarity can be measured in terms of percentage similarity (which takes into account conservative amino acid substitutions); the higher the percentage, the more similar the sequences are. Homologs or orthologs of nucleic acid or amino acid sequences possess a relatively high degree of sequence identity/similarity when aligned using standard methods.

Methods of alignment of sequences for comparison are well known in the art. Various programs and alignment algorithms are described in: Smith & Waterman, Adv. Appl Math. 2:482, 1981; Needleman & Wunsch, J. Mol. Biol. 48:443, 1970; Pearson & Lipman, Proc. Natl. Acad. Sci. USA 85:2444, 1988; Higgins & Sharp, Gene, 73:237-44, 1988; Higgins & Sharp, CABIOS 5:151-3, 1989; Corpet et al., Nuc. Acids Res. 16:10881-90, 1988; Huang et al. Computer Appls. in the Biosciences 8, 155-65, 1992; and Pearson et al., Meth. Mol. Bio. 24:307-31, 1994. Altschul et al., J. Mol. Biol. 215:403-10, 1990, presents a detailed consideration of sequence alignment methods and homology calculations.

The NCBI Basic Local Alignment Search Tool (BLAST) (Altschul et al., J. Mol. Biol. 215:403-10, 1990) is available from several sources, including the National Center for Biological Information (NCBI, National Library of Medicine, Building 38A, Room 8N805, Bethesda, Md. 20894) and on the Internet, for use in connection with the sequence analysis programs blastp, blastn, blastx, tblastn and tblastx. Additional information can be found at the NCBI web site.

BLASTN is used to compare nucleic acid sequences, while BLASTP is used to compare amino acid sequences. To compare two nucleic acid sequences, the options can be set as follows: -i is set to a file containing the first nucleic acid sequence to be compared (such as C:\seq1.txt); -j is set to a file containing the second nucleic acid sequence to be compared (such as C:\seq2.txt); -p is set to blastn; -o is set to any desired file name (such as C:\output.txt); -q is set to −1; -r is set to 2; and all other options are left at their default setting. For example, the following command can be used to generate an output file containing a comparison between two sequences: C:\B12seq -i c:\seq1.txt -j c:\seq2.txt -p blastn -o c:\output.txt q-1-r 2.

To compare two amino acid sequences, the options of B12seq can be set as follows: -i is set to a file containing the first amino acid sequence to be compared (such as C:\seq1.txt); -j is set to a file containing the second amino acid sequence to be compared (such as C:\seq2.txt); -p is set to blastp; -o is set to any desired file name (such as C:\output.txt); and all other options are left at their default setting. For example, the following command can be used to generate an output file containing a comparison between two amino acid sequences: C:B12seq -i c:\seq1.txt -j c:\seq2.txt -p blastp -o c:\output.txt. If the two compared sequences share homology, then the designated output file will present those regions of homology as aligned sequences. If the two compared sequences do not share homology, then the designated output file will not present aligned sequences.

Once aligned, the number of matches is determined by counting the number of positions where an identical nucleotide or amino acid residue is presented in both sequences. The percent sequence identity is determined by dividing the number of matches either by the length of the sequence set forth in the identified sequence, or by an articulated length (such as 100 consecutive nucleotides or amino acid residues from a sequence set forth in an identified sequence), followed by multiplying the resulting value by 100. For example, a nucleic acid sequence that has 1166 matches when aligned with a test sequence having 1154 nucleotides is 75.0 percent identical to the test sequence (i.e., 1166÷1554*100=75.0). The percent sequence identity value is rounded to the nearest tenth. For example, 75.11, 75.12, 75.13, and 75.14 are rounded down to 75.1, while 75.15, 75.16, 75.17, 75.18, and 75.19 are rounded up to 75.2. The length value will always be an integer. In another example, a target sequence containing a 20-nucleotide region that aligns with 20 consecutive nucleotides from an identified sequence as follows contains a region that shares 75 percent sequence identity to that identified sequence (that is, 15÷20*100=75).

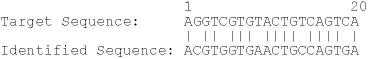

For comparisons of amino acid sequences of greater than about 30 amino acids, the Blast 2 sequences function is employed using the default BLOSUM62 matrix set to default parameters, (gap existence cost of 11, and a per residue gap cost of 1). Homologs are typically characterized by possession of at least 70% sequence identity counted over the full-length alignment with an amino acid sequence using the NCBI Basic Blast 2.0, gapped blastp with databases such as the nr or swissprot database. Queries searched with the blastn program are filtered with DUST (Hancock and Armstrong, 1994, Comput. Appl. Biosci. 10:67-70). Other programs use SEG. In addition, a manual alignment can be performed. Proteins with even greater similarity will show increasing percentage identities when assessed by this method, such as at least 75%, at least 80%, at least 85%, at least 90%, at least 95%, at least 98%, or at least 99% sequence identity to the proteins encoded by the genes listed in Table 1A.

One indication that two nucleic acid molecules are closely related is that the two molecules hybridize to each other under stringent conditions, as described above. Nucleic acid sequences that do not show a high degree of identity may nevertheless encode identical or similar (conserved) amino acid sequences, due to the degeneracy of the genetic code. Changes in a nucleic acid sequence can be made using this degeneracy to produce multiple nucleic acid molecules that all encode substantially the same protein. Such homologous nucleic acid sequences can, for example, possess at least 60%, at least 70%, at least 80%, at least 90%, at least 95%, at least 98%, or at least 99% sequence identity determined by this method. For example, homologous nucleic acid sequences can have at least 60%, at least 70%, at least 75%, at least 80%, at least 85%, at least 90%, at least 95%, at least 98%, or at least 99% sequence identity to the nucleic acid sequences for the genes listed in Table 1A. An alternative (and not necessarily cumulative) indication that two nucleic acid sequences are substantially identical is that the polypeptide which the first nucleic acid encodes is immunologically cross reactive with the polypeptide encoded by the second nucleic acid.

One of skill in the art will appreciate that the particular sequence identity ranges are provided for guidance only; it is possible that strongly significant homologs could be obtained that fall outside the ranges provided.

Single nucleotide polymorphism (SNP): A single base (nucleotide) difference in a DNA sequence among individuals in a population. SNPs can be causative (actually involved in or influencing the condition or trait to which the SNP is linked) or associative (linked to but not having any direct involvement in or influence on the condition or trait to which the SNP is linked).

Subject: Living multi-cellular vertebrate organisms, a category that includes human and non-human mammals (such as veterinary subjects).

Target sequence: A sequence of nucleotides located in a particular region in a genome (such as a human genome or the genome of any mammal) that corresponds to one or more specific genetic abnormalities, such as one or more nucleotide substitutions, deletions, insertions, amplifications, or combinations thereof. The target can be for instance a coding sequence; it can also be the non-coding strand that corresponds to a coding sequence. Examples of target sequences include those sequences associated with ARMD, such as those listed in Table 1A and 1B.

Toll-like receptor 4 (TRL4): TLR4 gene has been implicated in modulating susceptibility to atherosclerosis by its role in mediation of pro-inflammatory signaling pathways and cholesterol efflux (Castrillo et al., Mol. Cell. 12:805-816, 2003; Gordon S. Dev. Cell. 5:666-668, 2003; Zareparsi et al., Hum. Mol. Genet. 14: 1449-1455, 2005). TRL4 has shown to participate in the phagocytosis of photoreceptor outer segments by the retinal pigment epithelium that its impairment may lead to ARMD (Bok D. Proc. Natl. Acad. Sci. USA. 99:14619-14621, 2002; Kindzelskii et al., J. Gen. Physiol. 124:139-149, 2004; Zareparsi et al., Hum. Mol. Genet. 14: 1449-1455, 2005).

The term TLR4 includes any TLR4 gene, cDNA, mRNA, or protein from any organism and that is TLR4 and involved in the development of ARMD.

Nucleic acid sequences for TLR4 are publicly available. For example, GenBank Accession Nos: NM_{—}138554 and NM_{—}019178 disclose exemplary TLR4 nucleic acid sequences.

In one example, TLR4 includes a full-length wild-type (or native) sequence, as well as TLR4 allelic variants, fragments, homologs or fusion sequences that retain the ability to be involved with the development of TLR4. In certain examples, TLR4 has at least 80% sequence identity, for example at least 85%, 90%, 95% or 98% sequence identity to TLR4. In other examples, TLR4 has a sequence that hybridizes under very high stringency conditions to a sequence set forth in GenBank Accession Nos.: NM_{—}138554 and NM_{—}019178 and retains TLR4 activity (e.g., ability to be involved with the development of ARMD).

Treating a disease: “Treatment” refers to a therapeutic intervention that ameliorates a sign or symptom of a disease or pathological condition, such as a sign or symptom of ARMD. Treatment can also induce remission or cure of a condition, such as ARMD. In particular examples, treatment includes preventing a disease, for example by inhibiting the full development of a disease, such as preventing development of ARMD. Prevention of a disease does not require a total absence of the disease. For example, a decrease of at least 50% can be sufficient.

Under conditions sufficient for: A phrase that is used to describe any environment that permits the desired activity.

In one example, includes incubating samples (such as amplification products) for a sufficient time to allow the desired activity. In particular examples, the desired activity is hybridization of samples to their substrate. For example, the desired activity is hybridization of amplification products to oligonucleotide probes thereby forming amplification products:oligonucleotide probe complexes allowing one or more ARMD mutations to be detected.

Vitelliform macular dystrophy gene 2 (VMD2): A retina-specific gene (alternatively referred to as the Bestrophin gene) that encodes a 585-amino acid protein with a molecular mass of 68 kD and an isoelectric point of 6.9. VMD2 has been identified as the casual gene of dominant juvenile onset vitelliform macular dystrophy, commonly known as Best disease.

The term VMD2 includes any VMD2 gene, cDNA, mRNA, or protein from any organism and that is VMD2 and involved in the development of ARMD.

Nucleic acid sequences for VMD2 are publicly available. For example, GenBank Accession Nos: NM_{—}004183, AH006947, and AY450527 disclose exemplary VMD2 nucleic acid sequences.

In one example, VMD2 includes a full-length wild-type (or native) sequence, as well as VMD2 allelic variants, fragments, homologs or fusion sequences that retain the ability to be involved with the development of VMD2. In certain examples, VMD2 has at least 80% sequence identity, for example at least 85%, 90%, 95% or 98% sequence identity to VMD2. In other examples, VMD2 has a sequence that hybridizes under very high stringency conditions to a sequence set forth in GenBank Accession Nos.: NM_{—}004183, AH006947, and AY450527 and retains VMD2 activity (e.g., ability to be involved with the development of ARMD).

Wild-type: A genotype that predominates in a natural population of organisms, in contrast to that of mutant forms.

### III. Mutations Involved in Age-Related Macular Degeneration (ARMD)

Complex traits such as ARMD can be understood by assuming an interaction between different mutations (such as polymorphisms) in candidate susceptibility genes. The risk that is associated with each genetic defect may be relatively low in isolation but the simultaneous presence of several mutations or polymorphisms can dramatically increase disease susceptibility in the presence of the conditions or risk factors that contribute to ARMD, such as aging, smoking, and diet.

Several mutations and polymorphisms (such as one or more nucleotide substitutions, insertions, deletions, or combinations thereof) in genes associated with a risk of developing ARMD are known. However, a combination of mutations and polymorphisms (such as in genes statistically associated with ARMD) that permit accurate prediction of a subject's overall genetic predisposition to ARMD, in multiple ethnic groups, has not been previously identified.

### Complement Factor H (CFH)

A significant association between a polymorphism, a T→C substitution at nucleotide 1277 in exon 9, which results in a tyrosine→histidine change (Y402H) in the complement factor H gene and increased risk of ARMD has been reported (Klein et al., Science. 308:385-389, 2005; Haines et al., Science. 308:419-421, 2005; Edwards et al., Science. 308:421-424, 2005). These studies reported odd ratios for ARMD ranging between 3.3 and 4.6 for carriers of the C allele and between 3.3 and 7.4 for CC homozygotes. This association has been confirmed (Zareparsi et al., Am. J. Hum. Genet. 77:149-153, 2005; Hageman et al., PNAS. 102:7227-7232, 2005; Li et al., Nat. Genet. 38:1049-1054, 2006; Maller et al., Nat. Genet. 38:1055-1059, 2006).

In three studies, unexpectedly 27 other common SNPs were found to be associated with ARMD in addition to Y402H polymorphism (Hageman et al., PNAS. 102:7227-7232, 2005; Li et al., Nat. Genet. 38:1049-1054, 2006; Maller et al., Nat. Genet. 38:1055-1059, 2006).

Hageman et al. showed that eight CFH polymorphisms were in linkage disequilibrium and one common at-risk haplotype with a set of these polymorphisms were detected in 50% of cases versus 29% of controls [OR=2.46, 95% CI (1.95-3.11)]. Homozygotes for this haplotype were found in 24.2% of cases and 8.3% of the controls. Also two common protective haplotypes were found in 34% of controls and 18% of cases [OR=0.48, 95% CI (0.33-0.69)] and [OR=0.54, 95% CI (0.33-0.69)].

Li et al. reported significant association between 22 additional CFH variants (two of which have already been reported by Hageman et al.) and susceptibility to ARMD. Eighteen among those CFH variants have shown stronger association with disease susceptibility than the Y402H variant. Therefore, even if the Y402H variant plays a casual role in the etiology of ARMD, it is unlikely to be the only major determinant of susceptibility to ARMD.

Maller et al. has showed a second association, independent of Y402H variant, between a common, noncoding CFH variant (among the 22 CFH variants that have been reported by Li et al.) and susceptibility to ARMD.

### LOC387715 Gene

Genomewide linkage scans of ARMD families have identified a significant linkage peak on chromosome 10q26 (Majewski et al., Am. J. Hum. Genet. 73:540-550, 2003; Seddon et al., Am. J Hum. Genet. 73:780-790, 2003; Iyengar et al., Am. J. Hum. Genet. 74:20-39, 2004; Weeks et al., Am. J. Hum. Genet. 75:174-189, 2004; Kenealy et al., Mil. Vis. 10:57-61, 2004) and three studies have reported 10q26 variants conferring to ARMD susceptibility. (Jakobsdottir et al., Am. J. Hum. Genet. 77:389-407, 2005; Rivera et al., Hum. Mol. Genet. 14:3227-3236, 2005; Schmidt et al., Am. J. Hum. Genet. 78:852-864, 2006). Among the 10q26 variants, a strong association between an Ala69Ser polymorphism, at LOC387715 gene and ARMD has been reported. (Rivera et al., Hum. Mol. Genet. 14:3227-3236, 2005; Schmidt et al., Am. J. Hum. Genet. 78:852-864, 2006).

An Ala69Ser (G→T) polymorphism in exon 1 of LOC387715 is more frequent in ARMD patients than in controls (Rivera et al., Hum. Mol. Genet. 14:3227-3236, 2005; Schmidt et al., Am. J. Hum. Genet. 78:852-864, 2006; Maller et al., Nat. Genet. 38:1055-1059, 2006), conferring an ˜2.7-fold increased risk of developing ARMD for the individuals heterozygous for the T allele and a 8.2-fold increased risk for TT homozygosity compared with GG homozygotes (OR=8.21; 95% CI: 5.79, 11.65) (Rivera et al., Hum. Mol. Genet. 14:3227-3236, 2005).

### Complement Factor B (BF) and Complement Component 2 (C2) Genes

Since inflammation has a role in the pathobiology of ARMD and CFH gene, the major inhibitor of the alternative complement pathway has been reported to be associated with ARMD susceptibility. Significant association between four variants and reduced risk for ARMD has been observed. L9H variant of BF, which is in nearly complete linkage disequilibrium with the E318D variant of C2 and R32Q variant of BF, which is in nearly complete linkage disequilibrium with the rs547154 SNP in intron 10 of C2 is highly protective for ARMD (Gold et al., Nat. Genet. 38:458-462, 2006; Maller et al., Nat. Genet. 38:1055-1059, 2006).

BF, an activator of the alternative complement pathway, and C2, an activator of the classical complement pathway, are located 500 bp apart in the major histocompability complex (MHC) class III region on human chromosome 6p21 and expressed in the neural retina, RPE and choroid.

### ABCR

Stargardt macular dystrophy 1 (STGD1) is an autosomal recessive retinal dystrophic disease sharing many features with ARMD. The ABCR gene, STGD1 gene, is a member of the ATP-binding cassette (ABC) transporter superfamily and encodes a rod photoreceptor-specific membrane protein, located on chromosome 1p22.2-1p22.3 region. The ABCR gene has been found in association with ARMD.

Thirty-three ABCR alterations are interpreted as disease risk-increasing alterations; those found significantly more frequently in ARMD patients than control subjects and those found in ARMD and not in control subjects. Two polymorphisms (D2177N and G1961E) have been reported to be statistically significant in association with ARMD (Fisher's two-sided exact test, p<0.0001), with an approximately threefold increased risk for D1177N carriers and fivefold increased risk for G1961E carriers (Allikmets et al., Am. J. Hum. Genet. 67:487-491, 2000). Thirty-one alterations in ABCR gene including missense mutations and deletions were described in 54 of 654 ARMD patients (8.3%) and none in 467 (0/467) control subjects (Allikmets et al., Science. 277:1805-1807, 1997; De La Paz et al., Opthalmology. 106:1531-1536, 1999; Webster et al., Invest. Opthalmol. Vis. Sci. 42:1179-1189, 2001, Baum et al., Opthalmologica. 217:111-114, 2003). This comparison showed a significant association between these alterations and ARMD (Yates Chi-square=38.7, p<0.0001) even though the frequencies of each alteration individually in patients and control subjects did not have any statistical evidence for an association with AMD due to their very low frequencies.

### Fibulin 5 (FBLN5)

After the discovery of fibulin 3 accumulation between the retinal pigment epithelium and drusen, but absence of fibulin 3-coding sequence variants in ARMD patients, a fibulin 5 has shown a significant association between amino acid variants and ARMD [seven different variants in seven different ARMD patients (7/402) and none in controls (0/429), (X²=5.59 p=0.0181)] (Marmorstein et al., Proc. Natl. Acad. Sci. USA. 99:13067-13072, 2002; Stone et al. N. Engl. J. Med. 352:346-353, 2004). In addition, two novel FBLN5 variants in ARMD patients have been found, but none in controls (Lotery et al., Hum. Mut. 27:568-574, 2006).

### VMD2

Vitelliform macular dystrophy (Best disease, VMD2) is an autosomal dominant juvenile-onset macular degeneration sharing some clinical and histological features with ARMD. The Best disease gene was localized to 11q13 and identified as the VMD2 gene. The VMD2 gene encodes bestrophin, which is selectively expressed in the RPE. Nine different VMD2 mutations in eleven of 580 ARMD patients (1.9%) but none in 388 controls revealed a significant association between VMD2 variants and ARMD (Yates X²=5.85, p=0.0156) when the two studies were combined, even though each study alone detected no statistical significance (Allikmets et al., Hum. Genet. 104:449-453, 1999; Lotery et al., Inves. Opthalmol. Vis. Sci. 41:1292-1296, 2000).

### Toll-Like Receptor 4 (TLR4) Gene

Cardiovascular disease and hypertension have been reported as risk factors for ARMD and atherosclerosis has been implicated in the pathogenesis of ARMD (Klein et al., Am. J. Hum. Genet. 137:486-495, 2004; Anderson et al., Am. J. Opthalmol. 131:767-781, 2001; Hageman et al., Prog. Retin. Eye. Res. 20:705-732, 2001; Zarbin M A. Arch. Ophthalmol. 122:598-614, 2004; Ambati et al., Surv. Opthalmol. 48:257-293, 2003; Zareparsi et al., Hum. Mol. Genet. 14: 1449-1455, 2005).

TLR4 gene, located within the region on chromosome 9q32-33, has been implicated in modulating susceptibility to atherosclerosis by its role in mediation of pro-inflammatory signaling pathways and cholesterol efflux (Castrillo et al., Mol. Cell. 12:805-816, 2003; Gordon S. Dev. Cell. 5:666-668, 2003; Zareparsi et al., Hum. Mol. Genet. 14:1449-1455, 2005).

A TRL4 D299G (A/G) variant has been reported to be significantly frequent in ARMD patients than in controls with conferring at least a 2-fold increased risk of developing ARMD in G allele carriers (Zareparsi et al., Hum. Mol. Genet. 14: 1449-1455, 2005).

### CX3CR1

CX3CR1 encodes the fractalkine (chemokine, CX3CL1) receptor. An association between two CX3CR1 SNPs, V249I and T280M, has been found in ARMD patients, with a significant increase in the prevalence of M280 and 1249 carriers in ARMD cases (55.3% and 39.3%) versus controls (41.7% and 23.9%) (X²=4.88, p=0.0272 and (X²=9.57, p=0.002) (Tuo et al., FASEB. J. 18:1297-1299, 2004). These two polymorphisms are in complete linkage disequilibrium.

### Cystatin C Gene (CST3)

Cystatin C is a cysteine protease inhibitor, mainly localized to the retinal pigment epithelium (RPE) in the posterior segment of the eye that inhibits several cathepsins, including cathepsin S.

The cystatin C gene (CST3) maps to chromosome 20p11.2. Three polymorphisms, −157 G/C, −72 A/C and +73 G/A, have been reported in a 220-bp fragment from the promoter region of the CST3 gene (Balbin and Abrahamson. Hum. Genet. 87:751-752, 1991). These three polymorphisms are in strong linkage disequilibrium and only two haplotypes are observed: CST3 A and B. The CST3 B/B genotype (−157 C, −72 C, +73 A) has recently shown to be associated with exudative ARMD in a case-control study including 167 ARMD patients and 517 controls. The CS3 B/B genotype has been found significantly frequent in ARMD patients (11/167) than in controls (12/517) (X²=7.07, p=0.0078) (Zurdel et al., Br. J Opthalmol 86:214-219, 2002).

### The Genes Encoding Antioxidant Enzymes, Manganese Superoxide Dismutase (MnSOD) Gene, Microsomal Epoxide Hydrolase (MEHE) Gene and Paraoxonase Gene

Oxidative stress from reactive oxygen species can cause age-related disorders, including ARMD, in which the RPE is considered a primary target (Kasahara et al. Invest. Opthalmol. Vis, Sci. 46:3426-3434, 2005). Xenobiotic-metabolizing and anti oxidant enzymes contribute to the development of ARMD in Japanese patients (Kimura et al., Am. J. Opthalmol. 130:769-773, 2000; Ikeda et al., Am. J. Opthalmol. 132:191-195, 2001). The MnSOD gene Ala/Ala genotype [X² (Yates)=9.86, p=0.0017)], MEHE exon 3, H113T polymorphism (X²=5.1, p≦0.025) and paraoxonase Gln-Arg 192 B/B genotype (X²=6.21, p=0.0127) and Leu-Met 54 L/L genotype (X²=6.82, p=0.009) were significantly frequent in Japanese exudative ARMD patients than in controls.

### Apolipoprotein E (Apo E) ε4 Allele

Apolipoprotein E (ApoE) is involved in lipoprotein metabolism and plays a role in neuronal response to injury. Apo E is located on chromosome 19q and has three common polymorphic alleles: ε2, ε3, and ε4. There is a reduced Apo E ε4 allele frequency in ARMD patients, consistent with a protective effect (Zareparsi et al., Invest. Opthalmol. Vis. Sci. 45:1306-1310, 2004; Klayer et al., Am. J. Hum. Genet. 63:200-206, 1998; Schmidt et al., Ophthal. Genet. 23:209-223, 2002). The ε2 Apo E allele has been reported to be slightly higher in ARMD patients than control subjects, although not significantly, indicating a weak causative role for ε2 allele in ARMD (Klayer et al., Am. J. Hum. Genet. 63:200-206, 1998: Simonelli et al. Ophthal. Res. 33:325-328, 2001).

### ELOVL4

Although one group did not find an association of the Met299Val variant in ELOVL4 with ARMD (Ayyagari et al., Ophthalmic. Genet. 22:233-239, 2001), it was found to be significantly associated with ARMD in a study using familial and case-control subjects (P=0.001 for allele test; P=0.001 for genotype test; P<0.0001 for family and case-control tests) with an OR of 0.45 (95% CI: 0.29-0.71) for ELOVL4, indicating that a valine at residue 299 is protective (Conley et al., Hum. Mol. Genet. 14:1991-2002, 2005).

### Hemicentin-1 Gene

The human hemicentin-1 gene has 107 exons and encodes a 5635-amino acid, 600-kDa protein which is a member of the family of fibulins (Schultz et al., Ophthalmic. Genet. 26:101-105, 2005). Fibulins contribute to the extracellular matrix and are widely expressed in basement membranes of epithelia and blood vessels (Schultz et al., Ophthalmic. Genet. 26:101-105, 2005).

An A16, 263G (Gln5345Arg) mutation causing a glutamine-to-arginine change at amino acid position 5345 in exon 104 of the hemicentin-1 (FIBULIN-6) gene which maps to the q25-31 region of chromosome 1, has been reported to be segregated with ARMD phenotype (Schultz et al., Hum. Mol. Genet. 12:3315-3323, 2003; Klein et al., Arch. Opthalmol. 116:1082-1088, 1998; Weeks et al., Am. J. Opthalmol. 132:682-692, 2001; Weeks et al., Am. J. Hum. Genet. 75:174-189, 2004; Seddon et al., Am. J. Hum. Genet. 73:780-790, 2003).

The Gln5345Arg variant has been found in 3 families among 100 families with ARMD and 5 individuals among 2,110 ARMD cases and three individuals among 981 control subjects (Schultz et al., Hum. Mol. Genet. 12:3315-3323, 2003; Stone et al., N. Engl. J. Med. 351:346-353, 2004; Hayashi et al., Ophthalmic. Genet. 25:111-119, 2004; McKay et al., Mol. Vis. 10:682-687, 2004; Schultz et al., Ophthalmic. Genet. 26:101-105, 2005).

Eleven other rare missense variants in the hemicentin-1 gene, Met2328Ile, Ala2463Pro, Glu2494Gln, Ile4638Val, Asp4744Glu, Asp5088Val, Arg5173H is, His5245Gln, Ile5256Thr, Leu5372Phe and Tyr5382Cys, have been detected in 16 of total 851 patients and not found in total 612 controls from two different studies, but the Tyr5382Cys variant has shown to be not segregated with the disease phenotype in a pair of affected siblings (Stone et al., N. Engl. J. Med. 351:346-353, 2004; Hayashi et al., Ophthalnic. Genet. 25:111-119, 2004).

### Human G Protein Coupled Receptor-75 (GPR75)

GPR75 codes for a member of the superfamily of G protein coupled receptors. Direct sequence analysis of the entire coding region and the flanking splice site, 5′-UTR and 3′-UTR sequences determined six different variants in 535 unrelated ARMD patients but none in 252 matched controls (Sauer et al., Br. J Ophthalmol. 85:969-975, 2001).

Genes encoding laminins; LAMC1, LAMC2 and LAMB3

The genes encoding laminins, a class of extracellular matrix proteins, are localized in the 1q25-31 region (Hayashi et al., Ophthalmic. Genet. 25:111-119, 2004). Twelve sequence variants in the LAMC1, LAMC2, and LAMB3 genes of ARMD patients were detected, but none in control subjects without statistical significance.

### IV. Determining Genetic Predisposition to ARMD

Provided herein are methods of determining whether a subject, such as an otherwise healthy subject, is susceptible to developing ARMD. The methods involve detecting an abnormality (such as a mutation) in at least one ARMD-related molecule, such as a nucleotide variant that is present in a subject with ARMD but not in control subjects or a nucleotide variant that is statistically associated with ARMD susceptibility. Specific encompassed embodiments include diagnostic or prognostic methods in which one or more mutations or polymorphisms in an ARMD-related nucleic acid molecule in cells of the individual is detected. In particular embodiments, an abnormality is detected in a subset of ARMD-related molecules (such as nucleic acid sequences), or all known ARMD-related molecules, that selectively detect a genetic predisposition of a subject to develop ARMD.

In particular examples, the subset of molecules includes a set of at least 7, 8, 9, 10, 11, 12, 13, 14, 15, 16, 17, 18, 19, or 20 ARMD-related susceptibility genotypes associated with ARMD, wherein the ARMD-related susceptibility genotypes are present up to 80, 81, 82, 83, 84, 85, 86, 87, 88, 89, 90, 91, 92, 93, 94, 95, 96, 97, or 98%, such as at least 80, 81, 82, 83, 84, 85, 86, 87, 88, 89, 90, 91, 92, 93, 94, 95, 96, or 97%, for example 80-98% of subjects who are at risk for ARMD. In one example, the subset of molecules includes a set of at least 16, 17, 18, 19, 20, 21, 22, 23, 24, 25, 26, 27, 28, 29, 30, or 31 ARMD-related susceptibility genotypes associated with ARMD.

In yet other examples, the number of ARMD-related susceptibility genotypes screened is at least 10, for example at least 12, at least 15, at least 20, at least 50, at least 80, at least 100, at least 120, at least 140, at least 160, at least 180, at least 200, at least 201, at least 202, at least 203, at least 204, at least 205, at least 206, at least 207, at least 208, at least 209, at least 210, at least 211, at least 212, at least 213, at least 214, at least 215, at least 216, at least 217, at least 218, at least 219, at least 220, at least 221, at least 222, at least 223, at least 224, at least 225, at least 226, at least 227, at least 228, at least 229, at least 230, at least 231, at least 232, at least 233, at least 234, at least 235, at least 236, at least 237, at least 238, at least 239, at least 240, at least 241, at least 242, at least 243, at least 244, at least 245, at least 246, at least 247, at least 248, at least 249, at least 250, at least 255, at least 260, at least 265, at least 270, at least 275, at least 280, at least 285, at least 290, at least 295, at least 300, at least 325, at least 350, at least 400, or at least 500 genotypes. In other examples, the methods employ screening no more than 500 genotypes, no more than 400, no more than 350, no more than 300, no more than 295, no more than 290, no more than 285, no more than 280, no more than 275, no more than 270, no more than 265, no more than 260, no more than 255, no more than 250, no more than 249, no more 248, no more than 247, no more than 246, no more than 245, no more than 244, no more than 243, no more than 242, no more than 241, no more than 240, no more than 230, no more than 229, no more than 228, no more than 227, no more than 226, no more than 225, no more than 224, no more than 223, no more than 222, no more than 221, no more than 220, no more than 219, no more than 218, no more than 217, no more than 216, no more than 215, no more than 214, no more than 213, no more than 212, no more than 211, no more than 210, no more than 209, no more than 208, no more than 207, no more than 206, no more than 205, no more than 204, no more than 203, no more than 202, no more than 201, no more than 200, no more than 180, no more than 160, no more than 140, no more than 120, no more than 100, no more than 80, no more than 50, no more than 20, no more than 18, no more than 15, no more than 10, or no more than 9 ARMD-related susceptibility genotypes. Examples of particular ARMD-related susceptibility genotypes are shown in Tables 1A and 1B.

As used herein, the term “ARMD-related molecule” includes ARMD-related nucleic acid molecules (such as DNA, RNA or cDNA) and ARMD-related proteins. The term is not limited to those molecules listed in Table 1A and 1B (and molecules that correspond to those listed), but also includes other nucleic acid molecules and proteins that are influenced (such as to level, activity, localization) by or during ARMD, including all of such molecules listed herein.

Examples of ARMD-related genes include CFH, LOC387715, BF, C2, ABCR, Fibulin 5, VMD2, TLR4, CX3CR1, CST3, MnSOD, MEHE, paraoxonase, APOE, ELOVL4, hemicentin-1, GPR75, LAMC1, LAMC2, and LAMB3. In certain examples, abnormalities are detected in at least one ARMD-related nucleic acid, for instance in at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20 or more ARMD-related nucleic acid molecules. In particular examples, certain of the described methods employ screening no more than 500 genotypes, no more than 400, no more than 350, no more than 325, no more than 300, no more than 295, no more than 290, no more than 285, no more than 280, no more than 275, no more than 270, no more than 265, no more than 260, no more than 255, no more than 250, no more than 249, no more than 248, no more than 247, no more than 246, no more than 245, no more than 244, no more than 243, no more than 242, no more than 241, no more than 240, no more than 230, no more than 229, no more than 228, no more than 227, no more than 226, no more than 225, no more than 224, no more than 223, no more than 222, no more than 221, no more than 220, no more than 219, no more than 218, no more than 217, no more than 216, no more than 215, no more than 214, no more than 213, no more than 212, no more than 211, no more than 210, no more than 209, no more than 208, no more than 207, no more than 206, no more than 205, no more than 204, no more than 203, no more than 202, no more than 201, no more than 200, no more than 180, no more than 160, no more than 140, no more than 120, no more than 100, no more than 80, no more than 50, no more than 40, no more than 30, no more than 20, no more than 18, no more than 11, or no more than 9 ARMD-related genes.

This disclosed method (MERT-ARMD) provides a rapid, straightforward, accurate and affordable multiple genetic screening method for screening in one assay overall inherited ARMD susceptibility that has a high predictive power for identification of asymptomatic carriers. The disclosed assay can be used to reduce the incidence of ARMD by early identification of individuals at inherited risk. By detecting individuals before they develop symptoms, effective preventive measures can be instituted.

Differences in the prevalence of ARMD among races and ethnic groups and a lower prevalence in populations of African descent has been reported. Additionally, there may be differences in genes and even in sequence alterations of the same gene that are associated with ARMD susceptibility among races and ethnic groups. The majority of the mutations and or polymorphisms in the genes associated with ARMD susceptibility have been reported in Caucasian populations, but there are accumulating data from populations of Asian descent revealing differences in the frequencies in certain genetic variants. For example, although ABCR gene ARMD associated D2177N and G1961E polymorphisms have been reported to be statistically significant in association with ARMD with an approximately threefold increased risk for D1177N carriers and fivefold increased risk for G1961E carriers in Caucasian populations, they were not seen in either ARMD patients or control subjects studied in Chinese and Japanese populations, suggesting the absence of these mutations in Asians (Allikmets et al., Am. J. Hum. Genet. 67:487-491, 2000; Baum et al., Opthalmologica 217:111-114, 2003; Kuroiwa et al., Br. J. Opthalmol. 83:613-615, 1999). On the other hand, ARMD associated rare ABCR T1428M mutation which has been found in only 1/167 ARMD patients and none in 220 control subjects in Caucasians, was found to be more frequent in Asian populations with occurrences of 7/80 in ARMD patients and 8/100 in control subjects from Japan and occurrences of 18/140 in ARMD patients and 15/95 in control subjects from China appearing as a common polymorphism (Allilmets et al., Science. 277:1805-1807, 1997; Kuroiwa et al., Br. J. Opthalmol. 83:613-615, 1999; Baum et al., Opthalmologica 217:111-114, 2003). In addition, two ARMD-associated ABCR mutations have been found in Chinese ARMD patients that have not been reported in Caucasians previously.

Other examples are the lack of association between CFH Y402H polymorphism, a variant that is considered to be a genetic risk factor for ARMD in Caucasians, and ARMD in Japanese patients and the absence of protective effect of ApoE ε4 allele in Chinese ARMD patients (Gotoh et al., Hum. Genet. 120:139-143, 2006; Pang et al., Opthalmologica 214:289-291, 2000). Based on this information, one can select particular mutations or polymorphisms to screen for, depending on the race of the subject to be screened.

### Clinical Specimens

Appropriate specimens for use with the current disclosure in determining a subject's genetic predisposition to ARMD include any conventional clinical samples, for instance blood or blood-fractions (such as serum). Techniques for acquisition of such samples are well known in the art (for example see Schluger et al. J. Exp. Med. 176:1327-33, 1992, for the collection of serum samples). Serum or other blood fractions can be prepared in the conventional manner. For example, about 200 μL of serum can be used for the extraction of DNA for use in amplification reactions.

Once a sample has been obtained, the sample can be used directly, concentrated (for example by centrifugation or filtration), purified, or combinations thereof, and an amplification reaction performed. For example, rapid DNA preparation can be performed using a commercially available kit (such as the InstaGene Matrix, BioRad, Hercules, Calif.; the NucliSens isolation kit, Organon Telnika, Netherlands). In one example, the DNA preparation method yields a nucleotide preparation that is accessible to, and amenable to, nucleic acid amplification.

### Amplification of Nucleic Acid Molecules

The nucleic acid samples obtained from the subject containing CFH, LOC387715, BF, C2, ABCR, Fibulin 5, VMD2, TLR4, CX3CR1, CST3, MnSOD, MEHE, paraoxonase, APOE, ELOVL4, hemicentin-1, GPR75, LAMC1, LAMC2, and LAMB3 sequences can be amplified from the clinical sample prior to detection. In one example, DNA sequences are amplified. In another example, RNA sequences are amplified.

Any nucleic acid amplification method can be used. In one specific, non-limiting example, polymerase chain reaction (PCR) is used to amplify the nucleic acid sequences associated with ARMD. Other exemplary methods include, but are not limited to, RT-PCR and transcription-mediated amplification (TMA).

The target sequences to be amplified from the subject include CFH, LOC387715, BF, C2, ABCR, Fibulin 5, VMD2, TLR4, CX3CR1, CST3, MnSOD, MEHE, paraoxonase, APOE, ELOVL4, hemicentin-1, GPR75, LAMC1, LAMC2, and LAMB3 sequences. In particular examples, the ARMD-associated target sequences to be amplified consist essentially of, or consist only of CFH, LOC387715, BF, C2, ABCR, Fibulin 5, VMD2, TLR4, CX3CR1, CST3, MnSOD, MEHE, paraoxonase, APOE, ELOVL4 and hemicentin-1. In other examples, the ARMD-associated target sequences to be amplified consist essentially of, or consist only of CFH, LOC387715, ABCR, TLR4, CX3CR1, CST3, MnSOD, MEHE, and paraoxonase.

Primers can be utilized in the amplification reaction. One or more of the primers can be labeled, for example with a detectable radiolabel, fluorophore, or biotin molecule. For example, a pair of primers for a gene includes an upstream primer (which binds 5′ to the downstream primer) and a downstream primer (which binds 3′ to the upstream primer). The primers used in the amplification reaction are selective primers which permit amplification of a nucleic acid involved in ARMD. Primers can be selected to amplify a nucleic acid molecule listed in Table 1A and 1B, or represented by those listed in Table 1A and 1B.

An additional set of primers can be included in the amplification reaction as an internal control. For example, these primers can be used to amplify a “housekeeping” nucleic acid molecule and serve to provide confirmation of appropriate amplification. In another example, a target nucleic acid molecule including primer hybridization sites can be constructed and included in the amplification reactor. One of skill in the art will readily be able to identify primer sets to serve as internal control primers.

### Arrays for Detecting Nucleic Acid Sequences

In particular examples, methods for detecting an abnormality in at least one ARMD-related gene use the arrays disclosed herein. Such arrays can include nucleic acid molecules. In one example, the array includes nucleic acid oligonucleotide probes that can hybridize to wild-type or mutant ARMD gene sequences, such as CFH, LOC387715, BF, C2, ABCR, Fibulin 5, VMD2, TLR4, CX3CR1, CST3, MnSOD, MEHE, paraoxonase, APOE, ELOVL4, hemicentin-1, GPR75, LAMC1, LAMC2, and LAMB3. In a particular example, an array includes oligonucleotides that can recognize the 105 ARMD-associated recurrent mutations listed in Table 1A, Table 1B or subsets thereof. In other examples, an array includes oligonucleotide probes that can recognize both mutant and wild-type CFH, LOC387715, BF, C2, ABCR, Fibulin 5, VMD2, TLR4, CX3CR1, CST3, MnSOD, MEHE, paraoxonase, APOE, ELOVL4 and hemicentin-1 sequences. Certain of such arrays (as well as the methods described herein) can include ARMD-related molecules that are not listed in Table 1A and 1B, as well as other sequences, such as one or more probes that recognize one or more housekeeping genes.

Arrays can be used to detect the presence of amplified sequences involved in ARMD, such as CFH, LOC387715, BF, C2, ABCR, Fibulin 5, VMD2, TLR4, CX3CR1, CST3, MnSOD, MEHE, paraoxonase, APOE, ELOVL4 hemicentin-1 GPR75, LAMC1, LAMC2, and LAMB3 sequences, using specific oligonucleotide probes. The arrays herein termed “ARMD detection arrays,” are used to determine the genetic susceptibility of a subject to developing ARMD. In one example, a set of oligonucleotide probes such as those shown in SEQ ID NOs: 1-210 (or a subset thereof) is attached to the surface of a solid support for use in detection of the ARMD-associated sequences, such as those amplified nucleic acid sequences obtained from the subject. Additionally, if an internal control nucleic acid sequence was amplified in the amplification reaction (see above), an oligonucleotide probe can be included to detect the presence of this amplified nucleic acid molecule.

The oligonucleotide probes bound to the array can specifically bind sequences amplified in the amplification reaction (such as under high stringency conditions). Thus, sequences of use with the method are oligonucleotide probes that recognize the ARMD-related sequences, such as CFH, LOC387715, BF, C2, ABCR, Fibulin 5, VMD2, TLR4, CX3CR1, CST3, MnSOD, MEHE, paraoxonase, APOE, ELOVL4, hemicentin-1 GPR75, LAMC1, LAMC2, and LAMB3 gene sequences. Such sequences can be determined by examining the sequences of the different species, and choosing primers that specifically anneal to a particular wild-type or mutant sequence (such as those listed in Table 1A and 1B or represented by those listed in Table 1A and 1B), but not others. Although particular examples are shown in SEQ ID NOs: 1-210, the disclosure is not limited to use of those exact probes. One of skill in the art will be able to identify other ARMD-associated oligonucleotide molecules that can be attached to the surface of a solid support for the detection of other amplified ARMD-associated nucleic acid sequences. Oligonucleotides comprising at least 15, 20, 25, 30, 35, 40, or more consecutive nucleotides of the ARMD-associated sequences such as CFH, LOC387715, BF, C2, ABCR, Fibulin 5, VMD2, TLR4, CX3CR1, CST3, MnSOD, MEHE, paraoxonase, APOE, ELOVL4, hemicentin-1, GPR75, LAMC1, LAMC2, and LAMB3 sequences, may be used.

The methods and apparatus in accordance with the present disclosure takes advantage of the fact that under appropriate conditions oligonucleotides form base-paired duplexes with nucleic acid molecules that have a complementary base sequence. The stability of the duplex is dependent on a number of factors, including the length of the oligonucleotides, the base composition, and the composition of the solution in which hybridization is effected. The effects of base composition on duplex stability may be reduced by carrying out the hybridization in particular solutions, for example in the presence of high concentrations of tertiary or quaternary amines.

The thermal stability of the duplex is also dependent on the degree of sequence similarity between the sequences. By carrying out the hybridization at temperatures close to the anticipated Tₘ's of the type of duplexes expected to be formed between the target sequences and the oligonucleotides bound to the array, the rate of formation of mis-matched duplexes may be substantially reduced.

The length of each oligonucleotide sequence employed in the array can be selected to optimize binding of target ARMD-associated nucleic acid sequences. An optimum length for use with a particular ARMD-associated nucleic acid sequence under specific screening conditions can be determined empirically. Thus, the length for each individual element of the set of oligonucleotide sequences including in the array can be optimized for screening. In one example, oligonucleotide probes are from about 20 to about 35 nucleotides in length or about 25 to about 40 nucleotides in length.

The oligonucleotide probe sequences forming the array can be directly linked to the support, for example via the 5′- or 3′-end of the probe. In one example, the oligonucleotides are bound to the solid support by the 5′ end. However, one of skill in the art can determine whether the use of the 3′ end or the 5′ end of the oligonucleotide is suitable for bonding to the solid support. In general, the internal complementarity of an oligonucleotide probe in the region of the 3′ end and the 5′ end determines binding to the support. Alternatively, the oligonucleotide probes can be attached to the support by non-ARMD-associated sequences such as oligonucleotides or other molecules that serve as spacers or linkers to the solid support.

### Microarray Material

In particular examples, the microarray material is formed from glass (silicon dioxide). Suitable silicon dioxide types for the solid support include, but are not limited to: aluminosilicate, borosilicate, silica, soda lime, zinc titania and fused silica (for example see Schena, Microarray Analysis. John Wiley & Sons, Inc, Hoboken, N.J., 2003). The attachment of nucleic acids to the surface of the glass can be achieved by methods known in the art, for example by surface treatments that form from an organic polymer. Particular examples include, but are not limited to: polypropylene, polyethylene, polybutylene, polyisobutylene, polybutadiene, polyisoprene, polyvinylpyrrolidine, polytetrafluroethylene, polyvinylidene difluroide, polyfluoroethylene-propylene, polyethylenevinyl alcohol, polymethylpentene, polycholorotrifluoroethylene, polysulformes, hydroxylated biaxially oriented polypropylene, aminated biaxially oriented polypropylene, thiolated biaxially oriented polypropylene, etyleneacrylic acid, thylene methacrylic acid, and blends of copolymers thereof (see U.S. Pat. No. 5,985,567, herein incorporated by reference), organosilane compounds that provide chemically active amine or aldehyde groups, epoxy or polylysine treatment of the microarray. Another example of a solid support surface is polypropylene.

In general, suitable characteristics of the material that can be used to form the solid support surface include: being amenable to surface activation such that upon activation, the surface of the support is capable of covalently attaching a biomolecule such as an oligonucleotide thereto; amenability to “in situ” synthesis of biomolecules; being chemically inert such that at the areas on the support not occupied by the oligonucleotides are not amenable to non-specific binding, or when non-specific binding occurs, such materials can be readily removed from the surface without removing the oligonucleotides.

In one example, the surface treatment is amine-containing silane derivatives. Attachment of nucleic acids to an amine surface occurs via interactions between negatively charged phosphate groups on the DNA backbone and positively charged amino groups (Schena, Micraoarray Analysis. John Wiley & Sons, Inc, Hoboken, N.J., 2003, herein incorporated by reference). In another example, reactive aldehyde groups are used as surface treatment. Attachment to the aldehyde surface is achieved by the addition of 5′-amine group or amino linker to the DNA of interest. Binding occurs when the nonbonding electron pair on the amine linker acts as a nucleophile that attacks the electropositive carbon atom of the aldehyde group (Id.).

A wide variety of array formats can be employed in accordance with the present disclosure. One example includes a linear array of oligonucleotide bands, generally referred to in the art as a dipstick. Another suitable format includes a two-dimensional pattern of discrete cells (such as 4096 squares in a 64 by 64 array). As is appreciated by those skilled in the art, other array formats including, but not limited to slot (rectangular) and circular arrays are equally suitable for use (see U.S. Pat. No. 5,981,185, herein incorporated by reference). In one example, the array is formed on a polymer medium, which is a thread, membrane or film. An example of an organic polymer medium is a polypropylene sheet having a thickness on the order of about 1 mil. (0.001 inch) to about 20 mil., although the thickness of the film is not critical and can be varied over a fairly broad range. Particularly disclosed for preparation of arrays at this time are biaxially oriented polypropylene (BOPP) films; in addition to their durability, BOPP films exhibit a low background fluorescence. In a particular example, the array is a solid phase, Allele-Specific Oligonucleotides (ASO) based nucleic acid array.

The array formats of the present disclosure can be included in a variety of different types of formats. A “format” includes any format to which the solid support can be affixed, such as microtiter plates, test tubes, inorganic sheets, dipsticks, and the like. For example, when the solid support is a polypropylene thread, one or more polypropylene threads can be affixed to a plastic dipstick-type device; polypropylene membranes can be affixed to glass slides. The particular format is, in and of itself, unimportant. All that is necessary is that the solid support can be affixed thereto without affecting the functional behavior of the solid support or any biopolymer absorbed thereon, and that the format (such as the dipstick or slide) is stable to any materials into which the device is introduced (such as clinical samples and hybridization solutions).

The arrays of the present disclosure can be prepared by a variety of approaches. In one example, oligonucleotide sequences are synthesized separately and then attached to a solid support (see U.S. Pat. No. 6,013,789, herein incorporated by reference). In another example, sequences are synthesized directly onto the support to provide the desired array (see U.S. Pat. No. 5,554,501, herein incorporated by reference). Suitable methods for covalently coupling oligonucleotides to a solid support and for directly synthesizing the oligonucleotides onto the support are known to those working in the field; a summary of suitable methods can be found in Matson et al., Anal. Biochem. 217:306-10, 1994. In one example, the oligonucleotides are synthesized onto the support using conventional chemical techniques for preparing oligonucleotides on solid supports (such as see PCT applications WO 85/01051 and WO 89/10977, or U.S. Pat. No. 5,554,501, herein incorporated by reference).

A suitable array can be produced using automated means to synthesize oligonucleotides in the cells of the array by laying down the precursors for the four bases in a predetermined pattern. Briefly, a multiple-channel automated chemical delivery system is employed to create oligonucleotide probe populations in parallel rows (corresponding in number to the number of channels in the delivery system) across the substrate. Following completion of oligonucleotide synthesis in a first direction, the substrate can then be rotated by 90° to permit synthesis to proceed within a second (2°) set of rows that are now perpendicular to the first set. This process creates a multiple-channel array whose intersection generates a plurality of discrete cells.

In particular examples, the oligonucleotide probes on the array include one or more labels that permit detection of oligonucleotide probe:target sequence hybridization complexes.

### Detection of Nucleic Acids

The nucleic acids molecules obtained from the subject can contain one or more insertions, deletions, substitutions, or combinations thereof in one or more genes associated with ARMD, such as those listed in Table 1A and 1B. Such mutations or polymorphisms (or both) can be detected to determine if the subject has a genetic disposition to developing ARMD. Any method of detecting a nucleic acid molecule can be used, such as physical or functional assays.

Methods for labeling nucleic acid molecules such that they can be detected, are well known. Examples of such labels include non-radiolabels and radiolabels. Non-radiolabels include, but are not limited to an enzyme, chemiluminescent compound, fluorescent compound (such as FITC, Cy3, and Cy5), metal complex, hapten, enzyme, calorimetric agent, a dye, or combinations thereof. Radiolabels include, but are not limited to, ¹²⁵I and ³⁵S. For example, radioactive and fluorescent labeling methods, as well as other methods known in the art, are suitable for use with the present disclosure. In one example, the primers used to amplify the subject's nucleic acids are labeled (such as with biotin, a radiolabel, or a fluorophore). In another example, the amplified nucleic acid samples are end-labeled to form labeled amplified material. For example, amplified nucleic acid molecules can be labeled by including labeled nucleotides in the amplification reactions.

The amplified nucleic acid molecules associated with ARMD are applied to the ARMD detection array under suitable hybridization conditions to form a hybridization complex. In particular examples, the amplified nucleic acid molecules include a label. In one example, a pre-treatment solution of organic compounds, solutions that include organic compounds, or hot water, can be applied before hybridization (see U.S. Pat. No. 5,985,567, herein incorporated by reference).

Hybridization conditions for a given combination of array and target material can be optimized routinely in an empirical manner close to the Tₘ of the expected duplexes, thereby maximizing the discriminating power of the method. Identification of the location in the array, such as a cell, in which binding occurs, permits a rapid and accurate identification of sequences associated with ARMD present in the amplified material (see below).

The hybridization conditions are selected to permit discrimination between matched and mismatched oligonucleotides. Hybridization conditions can be chosen to correspond to those known to be suitable in standard procedures for hybridization to filters and then optimized for use with the arrays of the disclosure. For example, conditions suitable for hybridization of one type of target would be adjusted for the use of other targets for the array. In particular, temperature is controlled to substantially eliminate formation of duplexes between sequences other than exactly complementary ARMD-associated wild-type of mutant sequences. A variety of known hybridization solvents can be employed, the choice being dependent on considerations known to one of skill in the art (see U.S. Pat. No. 5,981,185, herein incorporated by reference).

Once the amplified nucleic acid molecules associated with ARMD have been hybridized with the oligonucleotides present in the ARMD detection array, the presence of the hybridization complex can be analyzed, for example by detecting the complexes.

Detecting a hybridized complex in an array of oligonucleotide probes has been previously described (see U.S. Pat. No. 5,985,567, herein incorporated by reference). In one example, detection includes detecting one or more labels present on the oligonucleotides, the amplified sequences, or both. In particular examples, developing includes applying a buffer. In one embodiment, the buffer is sodium saline citrate, sodium saline phosphate, tetramethylammonium chloride, sodium saline citrate in ethylenediaminetetra-acetic, sodium saline citrate in sodium dodecyl sulfate, sodium saline phosphate in ethylenediaminetetra-acetic, sodium saline phosphate in sodium dodecyl sulfate, tetramethylammonium chloride in ethylenediaminetetra-acetic, tetramethylammonium chloride in sodium dodecyl sulfate, or combinations thereof. However, other suitable buffer solutions can also be used.

Detection can further include treating the hybridized complex with a conjugating solution to effect conjugation or coupling of the hybridized complex with the detection label, and treating the conjugated, hybridized complex with a detection reagent. In one example, the conjugating solution includes streptavidin alkaline phosphatase, avidin alkaline phosphatase, or horseradish peroxidase. Specific, non-limiting examples of conjugating solutions include streptavidin alkaline phosphatase, avidin alkaline phosphatase, or horseradish peroxidase. The conjugated, hybridized complex can be treated with a detection reagent. In one example, the detection reagent includes enzyme-labeled fluorescence reagents or calorimetric reagents. In one specific non-limiting example, the detection reagent is enzyme-labeled fluorescence reagent (ELF) from Molecular Probes, Inc. (Eugene, Oreg.). The hybridized complex can then be placed on a detection device, such as an ultraviolet (UV) transilluminator (manufactured by UVP, Inc. of Upland, Calif.). The signal is developed and the increased signal intensity can be recorded with a recording device, such as a charge coupled device (CCD) camera (manufactured by Photometrics, Inc. of Tucson, Ariz.). In particular examples, these steps are not performed when radiolabels are used.

In particular examples, the method further includes quantification, for instance by determining the amount of hybridization.

### V. Kits

The present disclosure provides kits that can be used to determine whether a subject, such as an otherwise healthy human subject, is genetically predisposed to ARMD. Such kits allow one to determine if a subject has one or more genetic mutations or polymorphisms in sequences associated with ARMD, including those listed in Table 1A and 1B.

The disclosed kits include a binding molecule, such as an oligonucleotide probe that selectively hybridizes to an ARMD-related molecule (such as a mutant or wild-type nucleic acid molecule) that is the target of the kit. In one example, the kit includes the oligonucleotide probes shown in SEQ ID NOs:1-210, or subsets thereof, such as SEQ ID NOS:1, 3, 5, 7, 9, 11, 13, 15, 17, 19, 21, 23, 25, 27, 29, 31, 33, 35, 37, 39, 41, 43, 45, 47, 49, 51, 53, 55, 57, 59, 61, 63, 65, 67, 69, 71, 73, 75, 77, 79, 81, 83, 85, 87, 89, 91, 93, 95, 97, 99, 101, 103, 105, 107, 109, 111, 113, 115, 117, 119, 121, 123, 125, 127, 129, 131, 133, 135, 137, 139, 141, 143, 145, 147, 149, 151, 153, 155, 157, 159, 161, 163, 165, 167, 169, 171, 173, 175, 177, 179, 181, 183, 185, 187, 189, 191, 193, 195, 197, 199, 201, 203, 205, 207, and 209 (to detect wild-type ARMD-associated sequences), or SEQ ID NOs:2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, 190, 192, 194, 196, 198, 200, 202, 204, 206, 208 and 210 (to detect mutant ARMD-associated sequences). In another example, a kit includes at least 20 probes, at least 50, at least 75, at least 100, at least 125, at least 150, at least 175, at least 200, at least 225, or at least 250 probes designed from the sequences shown in SEQ ID NOS: 1-210. Probes can include at least 15 contiguous nucleotides of any of SEQ ID NOS: 1-210, such as at least 16 contiguous nucleotides, such as at least 17 contiguous nucleotides, such as at least 18 contiguous nucleotides, such as at least 19 contiguous nucleotides, such as at least 20 contiguous nucleotides, such as at least 21 contiguous nucleotides, such as at least 22 contiguous nucleotides, such as at least 23 contiguous nucleotides, or such as at least 24 contiguous nucleotides, of any of SEQ ID NOS: 1-210.

In a particular example, kits include antibodies capable of binding to wild-type ARMD-related proteins or to mutated or polymorphic proteins. Such antibodies have the ability to distinguish between a wild-type and a mutant or polymorphic ARMD-related protein.

The kit can further include one or more of a buffer solution, a conjugating solution for developing the signal of interest, or a detection reagent for detecting the signal of interest, each in separate packaging, such as a container. In another example, the kit includes a plurality of ARMD-related target nucleic acid sequences for hybridization with an ARMD detection array to serve as positive control. The target nucleic acid sequences can include oligonucleotides such as DNA, RNA, and peptide-nucleic acid, or can include PCR fragments.

### VI. ARMD Therapy

Methods are disclosed herein for preventing or treating ARMD. In one example, a sign or symptom of a disease or pathological condition, such as a sign or symptom of ARMD is treated. In particular examples, treatment includes preventing a disease, for example by inhibiting the full development of a disease, such as preventing development of ARMD. Prevention of a disease does not require a total absence of the disease. For example, a decrease of at least 25% can be sufficient.

In one example, the treatment includes avoiding or reducing the incidence of ARMD in a subject determined to be genetically predisposed to developing ARMD. For example, if using the screening methods described above a mutation or a polymorphism in at least one ARMD-related molecule in the subject is detected, a lifestyle choice may be undertaken by the subject in order to avoid or reduce the incidence of ARMD or to delay the onset of ARMD. For example, the subject may quit smoking, modify diet to include less fat intake, increase intake of antioxidant vitamin and mineral supplementation, or take prophylactic doses of agents that retard the development of retinal neovascularization. In some examples, the treatment selected is specific and tailored for the subject, based on the analysis of that subject's profile for one or more ARMD-related molecules. Such a treatment can be determined by a skilled clinician.

The disclosure is further illustrated by the following non-limiting Examples.

### EXAMPLE 1

### Mutations and Polymorphisms Associated with ARMD

This example provides all currently known ARMD-associated nucleic acid and protein sequences.

Tables 1A describes all currently known ARMD-associated nucleic acid and protein sequences used to design an array that allows for screening of ARMD-associated mutations and polymorphisms in twenty different genes. In an example, an array is designed to screen for 105 ARMD-associated mutations and polymorphisms in sixteen different genes in which the sixteen different genes are CFH, LOC387715, BF, C2, ABCR, Fibulin 5, VMD2, TLR4, CX3CR1, CST3, MnSOD, MEHE, paraoxonase, APOE, ELOVL4 and hemicentin-1 (Table 1B). One skilled in the art will appreciate that additional ARMD-associated mutations and polymorphisms not currently identified can also be used. For each potential site of mutation/polymorphism, two oligonucleotide probes may be designed (see Example 3).

TABLE 1A
Exemplary mutations associated with ARMD.

| | | Gene Accession No. or | |
|---|---|---|---|
| Gene | Mutation | RefSNP ID: | Reference: |
| CFH wildtype | IVS1 | RefSNP ID: rs529825 | Hageman et al., PNAS 102: |
| (Gene | | | 7227-7237, 2005 |
| Accession No: | Y402H | RefSNP ID: rs1061170 | |
| DQ233256) | I62V | RefSNP ID: rs800292 | |
| | IVS2 insTT | | Hageman et al., PNAS 102: |
| | | | 7227-7237, 2005. |
| | A307A | RefSNP ID: rs1061147 | Haines et al., Scienceexpress, |
| | | | published online 10 Mar. |
| | | | 2005; 10.1126/scienc.1110359. |
| | A473A | RefSNP ID: rs2274700 | Haines et al., Scienceexpress, |
| | | | published online 10 Mar. |
| | | | 2005; 10.1126/scienc.1110359. |
| | IVS6 | RefSNP ID: rs3766404 | Hageman et al., PNAS 102: |
| | | | 7227-7237, 2005. |
| | IVS10 | RefSNP ID: rs203674 | Hageman et al., PNAS 102: |
| | | | 7227-7237, 2005. |
| | IVS14 | RefSNP ID: rs1410996 | |
| | IVS9 | RefSNP ID: rs7535263 | |
| | IVS15 | RefSNP ID: rs10801559 | |
| | IVS12 | RefSNP ID: rs3766405 | |
| | IVS9 | RefSNP ID: rs10754199 | |
| | IVS15 | RefSNP ID: rs1329428 | |
| | IVS11 | RefSNP ID: rs10922104 | |
| | IVS9 | RefSNP ID: rs1887973 | |
| | IVS11 | RefSNP ID: rs10922105 | |
| | IVS9 | RefSNP ID: rs4658046 | |
| | IVS11 | RefSNP ID: rs10465586 | |
| | IVS11 | RefSNP ID: rs3753395 | |
| | IVS9 | RefSNP ID: rs402056 | |
| | IVS7 | RefSNP ID: rs7529589 | |
| | IVS15 | RefSNP ID: rs7514261 | |
| | IVS9 | RefSNP ID: rs10922102 | |
| | IVS9 | RefSNP ID: rs10922103 | |
| | IVS15 | RefSNP ID: rs412852 | |
| LOC387715 | Ala69Ser (G/T) | RefSNP ID: rs10490924 | |
| wildtype | | | |
| (Gene | | | |
| Accession No: | | | |
| NW_924884 | | | |
| ABCR | D2177N | | |
| wildtype | G1961E | | |
| (Gene | E471K | | |
| Accession No: | P940R | | |
| NM_000350) | T1428M | | |
| | R1517S | | |
| | I1562T | | |
| | G1578R | | |
| | 5196 + 1G→A | | |
| | R1898H | | |
| | L1970F | | |
| | 6519Δ11bp | | |
| | 6568ΔC | | |
| | P862L | | |
| | His423Arg (H423R) | | |
| | Ala1038Val | | |
| | (A1038V) | | |
| | Val1433Ile (V1433I) | | |
| | Asp1817Glu | | |
| | (N1817E) | | |
| | Val2050Leu | | |
| | (V2050L) | | |
| | 769 − 32 T→C | | |
| | 2588 − 12 C→G | | |
| | 2653 + 60 G→C | | |
| | 2654 − 48 G→C | | |
| | 4129 − 35 A→T | | |
| | 4254 − 47 T→C | | |
| | 4539 + 21 delg | | |
| | 4773 + 48 C→T | | |
| | 5836 − 24 G→A | | |
| | 5898 + 22 C→A | | |
| | 6006 − 16 G→A | | |
| | 6282 + 7 G→A | | |
| | 6816 + 28 C→G | | |
| | 6823 + 26 C→A | | |
| | IVS6 − 5T > G | | |
| | IVS33 + 1G > T | | |
| VMD2 | T216I | | |
| wildtype | L567F | | |
| (Gene | IVS6 − 9 (insTCC) | | |
| Accession No: | IVS10 − 27 T→C | | |
| NM_004183) | 1951insG | | |
| | Arg105Cys (R105C) | | |
| | Glu119Gln (E119Q) | | |
| | Lys149Stop | | |
| | Val275Ile (V275I) | | |
| TLR4 | D299G (A/G) | | |
| wildtype | | | |
| (Gene | | | |
| Accession No: | | | |
| NM_138554) | | | |
| Fibulin 5 | Val60Leu (gtt→ctt) | | |
| wildtype | (V60L) | | |
| (Gene | Arg71Gln | | |
| Accession No: | (cgg→cag) (R71Q) | | |
| NM_006329) | Pro87Ser (ccc→tcc) | | |
| | (P87S) | | |
| | Gln124Pro | | |
| | (caa→cca) (Q124P) | | |
| | Ile169Thr (att→act) | | |
| | (I169T) | | |
| | Gly267Ser | | |
| | (ggc→agc) (G267S) | | |
| | Arg351Trp | | |
| | (cgg→tgg) (R351W) | | |
| | Ala363Thr (gct→act) | | |
| | (A363T) | | |
| | Gly412Glu | | |
| | (ggg→gag) (G412E) | | |
| CX3CR1 | V249I (G/A) | | |
| wildtype | T280M (C/T) | | |
| (Gene | | | |
| Accession No: | | | |
| NM_001337) | | | |
| CST3 wildtype | −157G/C | | |
| (Gene | −72 A/C | | |
| Accession No: | +73 G/A | | |
| NM_000099) | | | |
| MnSOD | Val/Ala | | Kimura et al., Am. J. |
| wildtype | polymorphism | | Ophthalmol. 130: 769-773, |
| (Gene | | | 2000. |
| Accession No: | | | |
| X65965) | | | |
| MEHE | H113T (cac→tac) | | Kimura et al., Am. J. |
| wildtype | | | Ophthalmol. 130: 769-773, |
| (Gene | | | 2000. |
| Accession No: | | | |
| NM_000446) | | | |
| Paraoxonase | Gln192Arg | | |
| wildtype | Leu54Met | | |
| (Gene | | | |
| Accession No: | | | |
| NM_000446) | | | |
| ApoE wildtype | ε2 | | |
| (Gene | ε3 | | |
| Accession No: | ε4 | | |
| NM_000041) | | | |
| EVLOV4 | Met299Val | | |
| wildtype | G105E | | |
| (Gene | | | |
| Accession No: | | | |
| AF279654) | | | |
| Hemicentin-1 | Met2328Ile | | |
| wildtype | Ala2463Pro | | |
| (Gene | Glu2494Gln | | |
| Accession No: | Ile4638Val | | |
| NM_031935) | Asp4744Glu | | |
| | Asp5088Val | | |
| | Arg5173His | | |
| | His5245Gln | | |
| | Ile5256Thr | | |
| | Gln5345Arg | | |
| | Leu5372Phe | | |
| GPR75 | −4G > A | | |
| wildtype | N78K | | |
| (Gene | P99L | | |
| Accession No: | S108T | | |
| NM_006794) | T135P | | |
| | Q234X | | Sauer et al., Br. J. Ophthalmol. |
| | | | 85: 969-975, 2001. |
| LAMC1 | IVS16 − 105 ins3bp | | Hayashi et al., Ophthalmic |
| wildtype | (AAT) | | Genetics 25: 111-119, 2004. |
| (Gene | IVS 17 + 43 T→C | | Hayashi et al., Ophthalmic |
| Accession No: | | | Genetics 25: 111-119, 2004. |
| NM_002293) | IVS 17 + 95 G→A | | Hayashi et al., Ophthalmic |
| | | | Genetics 25: 111-119, 2004. |
| LAMC2 | IVS 10 − 57 G→A | | Hayashi et al., Ophthalmic |
| wildtype(Gene | | | Genetics 25: 111-119, 2004. |
| Accession No: | 2396 del3bp (AAG) | | Hayashi et al., Ophthalmic |
| AH006634) | | | Genetics 25: 111-119, 2004. |
| | 2681 G→A | | Hayashi et al., Ophthalmic |
| | | | Genetics 25: 111-119, 2004. |
| | IVS18 + 9 T→C | | Hayashi et al., Ophthalmic |
| | | | Genetics 25: 111-119, 2004. |
| | IVS 18 + 12 T→C | | Hayashi et al., Ophthalmic |
| | | | Genetics 25: 111-119, 2004. |
| | IVS 22 + 25 C→T | | Hayashi et al., Ophthalmic |
| | | | Genetics 25: 111-119, 2004. |
| | IVS 22 + 108 G→A | | Hayashi et al., Ophthalmic |
| | | | Genetics 25: 111-119, 2004. |
| | IVS 22 + 140 C→T | | Hayashi et al., Ophthalmic |
| | | | Genetics 25: 111-119, 2004. |
| LAMB3 | | | |
| wildtype | | | |
| (Gene | IVS 15 + 37 insC | | Hayashi et al., Ophthalmic |
| Accession No: | | | Genetics 25: 111-119, 2004. |
| L25541) | | | |

TABLE 1B

Exemplary nucleic acid probes that can be used to detect 105
ARMD-associated mutations in sixteen different genes.

| | | | |
|---|---|---|---|
| | | Exemplary wild type | Exemplary mutation |
| Gene | Mutation | specific probe | Specific probe |

| | | | | | |
|---|---|---|---|---|---|
| CFH | IVS1 | TTTACACAGTACAA | SEQ ID | TTTACACAGTACGA | SEQ ID |
| gene | (A/G) | TAGACTTACCC | NO: 1 | TAGACTTACCC | NO: 2 |
| | I62V | TCTCTTGGAAATAT | SEQ ID | TCTCTTGGAAATGT | SEQ ID |
| | (A/G) | AATAATGGTAT | NO: 3 | AATAATGGTAT | NO: 4 |
| | IVS2 | ACTAATTCATAACT | SEQ ID | ACTAATTCATAACT | SEQ ID |
| | insTT | TTTTTTTTTTC | NO: 5 | TTTTTTTTCGT | NO: 6 |
| | IVS6 | ACATTTAGGACTCA | SEQ ID | ACATTTAGGACTTA | SEQ ID |
| | (C/T) | TTTGAAGTTAG | NO: 7 | TTTGAAGTTAG | NO: 8 |
| | A307A | GGGAAATACAGCC | SEQ ID | GGGAAATACAGCA | SEQ ID |
| | (C/A) | AAATGCACAAGT | NO: 9 | AAATGCACAAGT | NO: 10 |
| | A473A | GCATTGATATTTAG | SEQ ID | GCATTGATATTTGG | SEQ ID |
| | (A/G) | CTTTTTCTTTT | NO: 11 | CTTTTTCTTTT | NO: 12 |
| | Y402H | TATAATCAAAATTA | SEQ ID | TATAATCAAAATCA | SEQ ID |
| | (T/C) | TGGAAGAAAGT | NO: 13 | TGGAAGAAAGT | NO: 14 |
| | IVS10 | TATTTATTAGTAGA | SEQ ID | TATTTATTAGTATA | SEQ ID |
| | (G/T) | TCTAATCAATA | NO: 15 | TCTAATCAATA | NO: 16 |
| | IVS 14 | TATAGCTGAGTGA | SEQ ID | TATAGCTGAGTGGC | SEQ ID |
| | (A/G) | CATGAGGTAGTC | NO: 17 | ATGAGGTAGTC | NO: 18 |
| | IVS 9 | TTACTGTTCCTCAT | SEQ ID | TTACTGTTCCTCGT | SEQ ID |
| | (A/G) | CTTCTTTGAAC | NO: 19 | CTTCTTTGAAC | NO: 20 |
| | IVS 15 | ACTGCTTTAGCTAT | SEQ ID | ACTGCTTTAGCTGT | SEQ ID |
| | (A/G) | GTCCCAGAATG | NO: 21 | GTCCCAGAATG | NO: 22 |
| | IVS 12 | TAGTGTGGGCTGTA | SEQ ID | TAGTGTGGGCTGCA | SEQ ID |
| | (T/C) | ACTTAAGTTTC | NO: 23 | ACTTAAGTTTC | NO: 24 |
| | IVS 9 | CTTTCCACTGGGGC | SEQ ID | CTTTCCACTGGGAC | SEQ ID |
| | (G/A) | AGACCCAGAGA | NO: 25 | AGACCCAGAGA | NO: 26 |
| | IVS 15 | CAGAAGTAAGAGT | SEQ ID | CAGAACTAAGAGC | SEQ ID |
| | (T/C) | TTTAGAATACAG | NO: 27 | TTTAGAATACAG | NO: 28 |
| | IVS 11 | TAAGAGACTCATG | SEQ ID | TAAGAGACTCATAA | SEQ ID |
| | (G/A) | AATTTCTTTTCT | NO: 29 | ATTTCTTTTCT | NO: 30 |
| | IVS 9 | TTTATGCACCACCG | SEQ ID | TTTATGCACCACGG | SEQ ID |
| | (C/G) | ACAACAGAAGG | NO: 31 | ACAACAGAAGG | NO: 32 |
| | IVS 11 | AAATATCTCTTCCT | SEQ ID | AAATATCTCTTCAT | SEQ ID |
| | (C/A) | ATCCTTTGTCC | NO: 33 | ATCCTTTGTCC | NO: 34 |
| | IVS 9 | ATCTGACAATCTTG | SEQ ID | ATCTGACAATCTCG | SEQ ID |
| | (T/C) | TAACTATTTGT | NO: 35 | TAACTATTTGT | NO: 36 |
| | IVS 11 | TCCAGAGATTTTTT | SEQ ID | TCCAGAGATTTTAT | SEQ ID |
| | (T/A) | TCTAATATAAG | NO: 37 | TCTAATATAAG | NO: 38 |
| | IVS 11 | TAACAAAAATGGT | SEQ ID | TAACAAAAATGGA | SEQ ID |
| | (T/A) | TTTTAATAGAGT | NO: 39 | TTTTAATAGAGT | NO: 40 |
| | IVS 9 | AAAGGAGTCTCAA | SEQ ID | AAAGGAGTCTCAGT | SEQ ID |
| | (A/G) | TAAGGTCCAGGA | NO: 41 | AAGGTCCAGGA | NO: 42 |
| | IVS 7 | AAATATATTAAAC | SEQ ID | AAATATATTAAATA | SEQ ID |
| | (C/T) | AGGTCTGTGCAT | NO: 43 | GGTCTGTGCAT | NO: 44 |
| | IVS 15 | TCCTTGGCAGTTAT | SEQ ID | TCCTTGGCAGTTGT | SEQ ID |
| | (A/G) | TTTCTTTCAGA | NO: 45 | TTTCTTTCAGA | NO: 46 |
| | IVS 9 | TGAGCGATCATAT | SEQ ID | TGAGCGATCATACA | SEQ ID |
| | (T/C) | ATTGTACCTTCA | NO: 47 | TTGTACCTTCA | NO: 48 |
| | IVS 9 | TAAGAAGGAAGAA | SEQ ID | TAAGAAGGAAGAG | SEQ ID |
| | (A/G) | GAATGAGATGAA | NO: 49 | GAATGAGATGAA | NO: 50 |
| | IVS 15 (→) | TTACTTTAGGGGAT | SEQ ID | TTACTTTAGGGGGT | SEQ ID |
| | (A/G) | TGCAGGAGGCT | NO: 51 | TGCAGGAGGCT | NO: 52 |
| LOC3 | Ala69Ser | ATGATCCCAGCTGC | SEQ ID | ATGATCCCAGCTTC | SEQ ID |
| 87715 | (G/T) | TAAAATCCACA | NO: 53 | TAAAATCCACA | NO: 54 |
| gene | | | | | |
| TRL4 | D299G | ACTACCTCGATGAT | SEQ ID | ACTACCTCGATGGT | SEQ ID |
| gene | (A/G) | ATTATTGACTT | NO: 55 | ATTATTGACTT | NO: 56 |
| CX3C | V249I | ACACCCTACAACG | SEQ ID | ACACCCTACAACAT | SEQ ID |
| R1 | (G/A) | TTATGATTTTCC | NO: 57 | TATGATTTTCC | NO: 58 |
| gene | T280M | GTGTGACTGAGAC | SEQ ID | GTGTGACTGAGATG | SEQ ID |
| | (C/T) | GGTTGCATTTAG | NO: 59 | GTTGCATTTAG | NO: 60 |
| CST3 | −157 | GGAGTGCAGGCCG | SEQ ID | GGAGTGCAGGCCC | SEQ ID |
| gene: | G/C | CGGTGGGGTGGG | NO: 61 | CGGTGGGGTGGG | NO: 62 |
| | −72 | CCTCGGTATCGCAG | SEQ ID | CCTCGGTATCGCCG | SEQ ID |
| | A/C | CGGGTCCTCTC | NO: 63 | CGGGTCCTCTC | NO: 64 |
| | +73 | GTGAGCCCCGCGG | SEQ ID | GTGAGCCCCGCGAC | SEQ ID |
| | G/A | CCGGCTCCAGTC | NO: 65 | CGGCTCCAGTC | NO: 66 |
| MnSO | Val/Ala | AGCTGGCTCCGGTT | SEQ ID | AGCTGGCTCCGGCT | SEQ ID |
| D | (GTT/GCT) | TTGGGGTATCT | NO: 67 | TTGGGGTATCT | NO: 68 |
| gene: | | | | | |
| MEHE | His113Tyr | ATTCTCAACAGAC | SEQ ID | ATTCTCAACAGATA | SEQ ID |
| gene | (CAC/TAC) | ACCCTCACTTCA | NO: 69 | CCCTCACTTCA | NO: 70 |
| Para- | Gln192Arg | ACCCCTACTTACAA | SEQ ID | ACCCCTACTTACGA | SEQ ID |
| oxonase | (CAA/CGA) | TCCTGGGAGAT | NO: 71 | TCCTGGGAGAT | NO: 72 |
| gene | Met54Leu | GGCTCTGAAGACA | SEQ ID | GGCTCTGAAGAGCT | SEQ ID |
| | (ATG/CTG) | TGGAGATACTGC | NO: 73 | GGAGATACTGC | NO: 74 |
| ABCR | 769-32 T/C | CAAACATATATAT | SEQ ID | CAAACATATATACA | SEQ ID |
| gene | (IVS6-32t/c | ATTTAAAAAATT | NO: 75 | TTTAAAAAATT | NO: 76 |
| | tatat/tacat) | | | | |
| | nt 769 | | | | |
| | IVS6-5 T/G | TTTACTGTCAATTA | SEQ ID | TTTACTGTCAATGA | SEQ ID |
| | (IVS6-5t/g | CAGCTTCCCAC | NO: 77 | CAGCTTCCCAC | NO: 78 |
| | attac/atgac) | | | | |
| | nt 769 | | | | |
| | H423R (His | AAGAACTGGAACA | SEQ ID | AAGAACTGGAACG | SEQ ID |
| | 423 Arg | CGTTAGGAAGTT | NO: 79 | CGTTAGGAAGTT | NO: 80 |
| | CAC/CGC) | | | | |
| | nt 1268 | | | | |
| | E471K (Glu | CAGCTTGGTGAAG | SEQ ID | CAGCTTGGTGAAAA | SEQ ID |
| | 471 Lys | AAGGTATTACTG | NO: 81 | AGGTATTACTG | NO: 82 |
| | GAA/AAA) | | | | |
| | nt 1411 | | | | |
| | P862L (Pro | ATCAGGTGTTTCCA | SEQ ID | ATCAGGTGTTTCTA | SEQ ID |
| | 862 Leu | GGTAAGCATCC | NO: 83 | GGTAAGCATCC | NO: 84 |
| | CCA/CTA) | | | | |
| | nt 2585 | | | | |
| | 2588-12 C/G | CTGTTTATTTGTCT | SEQ ID | GTGTTTATTTGTGT | SEQ ID |
| | (IVS16- | CTATTTTTAGG | NO: 85 | CTATTTTTAGG | NO: 86 |
| | 12c/g | | | | |
| | gtctc/gtgtc) | | | | |
| | nt 2588 | | | | |
| | 2653 + 60 | GGCTCTGTGCAAG | SEQ ID | GGCTCTGTGCAACA | SEQ ID |
| | G/C | ATGTATATGGAT | NO: 87 | TGTATATGGAT | NO: 88 |
| | (IVS17 + 60g/ | | | | |
| | c | | | | |
| | aagat/aacat) | | | | |
| | nt 2653 | | | | |
| | 2654-48 | CTGCCTTTGCTCGT | SEQ ID | GTGCCTTTGCTCCT | SEQ ID |
| | G/C (IVS17- | TCTCAGCTCCC | NO: 89 | TCTCAGCTCCC | NO: 90 |
| | 48g/c | | | | |
| | tcgtt/tcctt) | | | | |
| | nt 2653 | | | | |
| | P940R (Pro | AGATTTTTGAGCCC | SEQ ID | AGATTTTTGAGCGC | SEQ ID |
| | 940 Arg | TGTGGCCGGCC | NO: 91 | TGTGGCCGGCC | NO: 92 |
| | CCC/CGC) | | | | |
| | nt 2820 | | | | |
| | A1038V | CCCAGGAGGAGGC | SEQ ID | CCCAGGAGGAGGT | SEQ ID |
| | (Ala 1038 | CCAGCTGGAGAT | NO: 93 | CCAGCTGGAGAT | NO: 94 |
| | Val | | | | |
| | GCC/GTC) | | | | |
| | nt 3113 | | | | |
| | 4129-35 A/T | CATCTCCATGCCAC | SEQ ID | CATCTCCATGCCTC | SEQ ID |
| | (IVS27-35a/t | AGTCATGTTTA | NO: 95 | AGTCATGTTTA | NO: 96 |
| | ccaca/cctca) | | | | |
| | nt 4129 | | | | |
| | 4254-47 T/C | AGTTGCATGATGTT | SEQ ID | AGTTGCATGATGCT | SEQ ID |
| | (IVS28-47t/c | GGCACGCGCCT | NO: 97 | GGCACGCGCCT | NO: 98 |
| | tgttg/tgctg) | | | | |
| | nt 4254 | | | | |
| | T1428M | GTGAGCAGTTCAC | SEQ ID | GTGAGCAGTTCATG | SEQ ID |
| | (Thr 1428 | GGTACTTGCAGA | NO: 99 | GTACTTGCAGA | NO: 100 |
| | Met | | | | |
| | ACG/ATG) | | | | |
| | nt 4283 | | | | |
| | V1433I (Val | GTACTTGGAGACGT | SEQ ID | GTACTTGCAGACAT | SEQ ID |
| | 1433 Ile | CCTCCTGAATA | NO: 101 | CCTCCTGAATA | NO: 102 |
| | GTC/ATC) | | | | |
| | nt 4297 | | | | |
| | 4539 + 21 | CCTCCAAACAACG | SEQ ID | CCTCCAAACAAC_G | SEQ ID |
| | delG | GGGCCCCAGGTC | NO: 103 | GGCCCCAGGTCT | NO: 104 |
| | (IVS30 + 21 | | | | |
| | delg | | | | |
| | acggg/ac_gg) | | | | |
| | nt 4539 | | | | |
| | R1517S (Arg | CAGAGAACACAGC | SEQ ID | CAGAGAACACAGA | SEQ ID |
| | 1517 Ser | GCAGCACGGAAA | NO: 105 | GCAGCACGGAAA | NO: 106 |
| | CGC/AGC) | | | | |
| | nt 4549 | | | | |
| | I1562T (Ile | GAGGAATTTCCATT | SEQ ID | GAGGAATTTCCACT | SEQ ID |
| | 1562 Thr | GGAGGAAAGCT | NO: 107 | GGAGGAAAGCT | NO: 108 |
| | ATT/ACT) | | | | |
| | nt 4685 | | | | |
| | G1578R | GAAGCACTTGTTG | SEQ ID | GAAGGACTTGTTAG | SEQ ID |
| | (Gly 1578 | GGTTTTTAAGCG | NO: 109 | GTTTTTAAGCG | NO: 110 |
| | Arg | | | | |
| | GGG/AGG) | | | | |
| | nt 4732 | | | | |
| | IVS33 + 1 | AATGTGAGCGGGG | SEQ ID | AATGTGAGCGGGTT | SEQ ID |
| | G/T | TATGTAAACAGA | NO: 111 | ATGTAAACAGA | NO: 112 |
| | (IVS33 + 1g/t | | | | |
| | GG gta/GG | | | | |
| | tta) nt 4773 | | | | |
| | 4773 + 48 | TGACTTGCTTAACT | SEQ ID | TGACTTGCTTAATT | SEQ ID |
| | C/T | ACCATGAATGA | NO: 113 | ACCATGAATGA | NO: 114 |
| | (IVS33 + 48c/ | | | | |
| | t aacta/aatta) | | | | |
| | nt 4773 | | | | |
| | 5196 + 1 G/A | CTCTGGGACATCGT | SEQ ID | CTCTGGGACATCAT | SEQ ID |
| | (IVS36 + 1 | AAGTGTCAGTT | NO: 115 | AAGTGTCAGTT | NO: 116 |
| | g/a, ATC | | | | |
| | gtaag/ATC | | | | |
| | ataag) nt | | | | |
| | 5196 + 1 | | | | |
| | D1817E | GGAATTATTTGATA | SEQ ID | GGAATTATTTGAGA | SEQ ID |
| | (Asp 1817 | ATAACCGGGTG | NO: 117 | ATAACCGGGTG | NO: 118 |
| | Glu, | | | | |
| | GAT/GAG) | | | | |
| | nt 5451 | | | | |
| | R1898H | TGCTGGTCCAGCGC | SEQ ID | TGCTGGTCCAGCAC | SEQ ID |
| | (Arg1898His | CACTTCTTCCT | NO: 119 | CACTTCTTCCT | NO: 120 |
| | CGC/CAC) | | | | |
| | nt 5693 | | | | |
| | L1970F (Leu | TAGTGCTTTGGCCT | SEQ ID | TAGTGCTTTGGCTT | SEQ ID |
| | 1970 Phe | CCTGGGAGTGA | NO: 121 | CCTGGGAGTGA | NO: 122 |
| | CTC/TTC) | | | | |
| | nt 5908 | | | | |
| | 6006-16 G/A | TACTCAGTAATTGC | SEQ ID | TACTCAGTAATTAC | SEQ ID |
| | (IVS43- | TTTTTTTCTTG | NO: 123 | TTTTTTTCTTG | NO: 124 |
| | 16g/a | | | | |
| | ttgct/ttact) | | | | |
| | nt 6006 | | | | |
| | V2050L (Val | TCTCTTCCCTAGGT | SEQ ID | TCTCTTCCCTAGCT | SEQ ID |
| | 2050 Leu | TGCAAACTGGA | NO: 125 | TGCAAACTGGA | NO: 126 |
| | GTT/CTT) | | | | |
| | nt 6148 | | | | |
| | 6282 + 7 G/A | CTGCTGGTAACTGC | SEQ ID | CTGCTGGTAACTAC | SEQ ID |
| | (IVS45 + 7g/a | GGGCTTGGGCC | NO: 127 | GGGCTTGGGCC | NO: 128 |
| | ctgcg/ctacg) | | | | |
| | nt 6282 | | | | |
| | 6519del11bp | TCAAATCCCCGAA | SEQ ID | TGAAGATCAAATC\| | SEQ ID |
| | (TCC CCG | GGACGACCTGCT | NO: 129 | ACCTGCTTCCTG | NO: 130 |
| | AAG GAC | | | | |
| | GAC/TC_{—} | | | | |
| | _{—— —— ——} | | | | |
| | _AC) nt | | | | |
| | 6519-6529 | | | | |
| | 6568delC | GAGCAGTTCTTCCA | SEQ ID | GAGCAGTTCTTC_A | SEQ ID |
| | (TTC | GGGGAACTTCC | NO: 131 | GGGGAACTTCCC | NO: 132 |
| | CAG/TTC | | | | |
| | _AG) nt | | | | |
| | 6568 | | | | |
| | 6816 + 28 | ATGCAGTCCACAG | SEQ ID | ATGCAGTCCACACC | SEQ ID |
| | G/C | CTTGAGGCAGTT | NO: 133 | TTGAGGCAGTT | NO: 134 |
| | (IVS49 + 28g/ | | | | |
| | c | | | | |
| | cagct/cacct) | | | | |
| | 6823 + 26 | TC GTTCC TGCAG | SEQ ID | TC GTTCC TGCAG | SEQ ID |
| | C/A | CCAGAAAGGAACT | NO: 135 | ACAGAAAGGAACT | NO: 136 |
| | (3 UTR + 26c/ | | | | |
| | a | | | | |
| | agcca/agaca) | | | | |
| | G1961E | GGCTGTGTGTCGG | SEQ ID | GGCTGTGTGTCGAA | SEQ ID |
| | (Gly 1961 | AGTTCGCCCTGG | NO: 137 | GTTCGCCCTGG | NO: 138 |
| | Glu | | | | |
| | GGA/GAA) | | | | |
| | nt 5882 | | | | |
| | D2177N | TCCCCGAAGGACG | SEQ ID | TCCCCGAAGGACA | SEQ ID |
| | (Asp 2177 | ACCTGCTTCCTG | NO: 139 | ACCTGCTTCCTG | NO: 140 |
| | Asn | | | | |
| | GAC/AAC) | | | | |
| | nt 6529 | | | | |
| Fibu- | Val60Leu | GACATGATGTGTGT | SEQ ID | GACATGATGTGTCT | SEQ ID |
| lin 5 | (GTT/CTT) | TAACCAAAATG | NO: 141 | TAACCAAAATG | NO: 142 |
| gene | Arg71Gln | TATGCATTCCCCGG | SEQ ID | TATGCATTCCCCAG | SEQ ID |
| | CGG/CAG) | ACAAACCCTGT | NO: 143 | ACAAACCCTGT | NO: 144 |
| | Pro87Ser | CCCTACTCGACCCC | SEQ ID | CCCTACTCGACCTC | SEQ ID |
| | (CCC/TCC) | CTACTCAGGTC | NO: 145 | CTACTCAGGTC | NO: 146 |
| | Gln124Pro | ATGAAAGCAACCA | SEQ ID | ATGAAAGCAACCC | SEQ ID |
| | (CAA/CCA) | ATGTGTGGATGT | NO: 147 | ATGTGTGGATGT | NO: 148 |
| | Ile169Thr | AGTGCTTAGACATT | SEQ ID | AGTGCTTAGACACT | SEQ ID |
| | (ATT/ACT) | GATGAATGTCG | NO: 149 | GATGAATGTCG | NO: 150 |
| | Gly267Ser | GTGAACCAGCCCG | SEQ ID | GTGAACCAGGCCA | SEQ ID |
| | (GGC/AGC) | GCACATACTTCT | NO: 151 | GCACATACTTCT | NO: 152 |
| | Arg351Trp | ACCATCTTGTACCG | SEQ ID | ACCATCTTGTACTG | SEQ ID |
| | (CGG/TGG) | GGACATGGACG | NO: 153 | GGACATGGACG | NO: 154 |
| | Ala363Thr | CGCTCCGTTCCCGC | SEQ ID | CGCTCCGTTCCCAC | SEQ ID |
| | (GCT/ACT) | TGACATCTTCC | NO: 155 | TGACATCTTCC | NO: 156 |
| | Gly412Glu | GCCCCATCAAAGG | SEQ ID | GCCCCATCAAAGA | SEQ ID |
| | (GGG/GAG) | GCCCCGGGAAAT | NO: 157 | GCCCCGGGAAAT | NO: 158 |
| VMD2 | Arg105Cys | CCGTGGCCCGACC | SEQ ID | CCGTGGCCCGACTG | SEQ ID |
| gene | (R105C): | GCCTCATGAGCC | NO: 159 | CCTCATGAGCC | NO: 160 |
| | CGC/TGC | | | | |
| | Glu119Gln | GAAGGCAAGGACG | SEQ ID | GAAGGCAAGGACC | SEQ ID |
| | (E119Q): | AGCAAGGCCGGC | NO: 161 | AGCAAGGCCGGC | NO: 162 |
| | GAG/CAG | | | | |
| | Lys149Stop: | ACCGCAGTCTACA | SEQ ID | ACCGCAGTCTACTA | SEQ ID |
| | AAG/TAG | AGCGCTTCCCCA | NO: 163 | GCGCTTCCCCA | NO: 164 |
| | IVS5-6 C/T | CCCTCTTCTGCCCC | SEQ ID | CCCTCTTCTGCCTC | SEQ ID |
| | | CCAGGAGATGA | NO: 165 | CCAGGAGATGA | NO: 166 |
| | Thr216Ile | AGGAGATGAACAC | SEQ ID | AGGAGATGAACAT | SEQ ID |
| | (T216I): | CTTGCGTACTCA | NO: 167 | CTTGCGTACTCA | NO: 168 |
| | ACC/ATC | | | | |
| | Val275Ile | CTCGTTGTGCCCGT | SEQ ID | CTCGTTGTGCCCAT | SEQ ID |
| | (V275I): | CTTCACGTTCC | NO: 169 | CTTCAGGTTCC | NO: 170 |
| | GTC/ATC | | | | |
| | Leu567Phe | ATACACACTACACT | SEQ ID | ATACACACTACATT | SEQ ID |
| | (L567F): | CAAAGATCACA | NO: 171 | CAAAGATCACA | NO: 172 |
| | CTC/TTC | | | | |
| | IVS10-27 | CTTCCATACTTATG | SEQ ID | CTTCCATACTTACG | SEQ ID |
| | T/C | CTGTTAATACT | NO: 173 | CTGTTAATACT | NO: 174 |
| Hemic- | Met2328Ile: | AGTGACCTGGATG | SEQ ID | AGTGACCTGGATAA | SEQ ID |
| entin-1 | ATG/ATA | AAAGATGGCCAC | NO: 175 | AAGATGGCCAC | NO: 176 |
| gene | (G7210A) | | | | |
| | Ala2463Pro: | GTTGTAAGGAATG | SEQ ID | GTTGTAAGGAATCC | SEQ ID |
| | GCA/CCA | GAGCTGGTGAAG | NO: 177 | AGCTGGTGAAG | NO: 178 |
| | (G7613C) | | | | |
| | Glu2494Gln: | GTGAAGGTAAAAG | SEQ ID | GTGAAGGTAAAAC | SEQ ID |
| | GAG/CAG | AGAAACAGAGTG | NO: 179 | AGAAACAGAGTG | NO: 180 |
| | (G7706C) | | | | |
| | Ile4638Val: | ATTATGTGCAACAT | SEQ ID | ATTATGTGCAACGT | SEQ ID |
| | ATT/GTT | TAGGCCTTGCC | NO: 181 | TAGGCCTTGCC | NO: 182 |
| | (A14138G) | | | | |
| | Asp4744Glu: | CGAAGGGAGTGAT | SEQ ID | CGAAGGGAGTGAA | SEQ ID |
| | GAT/GAA | GTCCAGAGTGAT | NO: 183 | GTCCAGAGTGAT | NO: 184 |
| | T14458A) | | | | |
| | Asp5088Val: | TATCCAAAGGAGA | SEQ ID | TATCCAAAGGAGTT | SEQ ID |
| | GAT/GTT | TCGCAGTAATCA | NO: 185 | CGCAGTAATCA | NO: 186 |
| | (A15489T) | | | | |
| | Arg5173His: | TTGGATCTTATCGC | SEQ ID | TTGGATCTTATCAC | SEQ ID |
| | CGC/CAC | TGTGTGGTCCG | NO: 187 | TGTGTGGTCCG | NO: 188 |
| | (G15744A) | | | | |
| | His5245Gln: | ACCAGATCAGCAC | SEQ ID | ACCAGATCAGCAGT | SEQ ID |
| | CAC/CAG | TGTAAGAACACC | NO: 189 | GTAAGAACACC | NO: 190 |
| | C15961G) | | | | |
| | Ile5256Thr: | GCTATAAGTGCATT | SEQ ID | GCTATAAGTGCACT | SEQ ID |
| | ATT/ACT | GATCTTTGTCC | NO: 191 | GATCTTTGTCC | NO: 192 |
| | (T15993C) | | | | |
| | Gln5345Arg: | GTCCACCAGGACA | SEQ ID | GTCCACCAGGACG | SEQ ID |
| | CAA/CGA | ACATTTATTAGG | NO: 193 | ACATTTATTAGG | NO: 194 |
| | (A16263G) | | | | |
| | Leu5372Phe: | AGTAGCTATAACCT | SEQ ID | AGTAGCTATAACTT | SEQ ID |
| | CTT/TTT | TGCACGGTTCT | NO: 195 | TGCACGGTTCT | NO: 196 |
| | (C16343T) | | | | |
| APOE | ε4 | ATGGAGGACGTGT | SEQ ID | ATGGAGGACGTGC | SEQ ID |
| gene | (Cys112Arg): | GCGGCCGCCTGG | NO: 197 | GCGGCCGCCTGG | NO: 198 |
| | T/C | | | | |
| | 1ε2 | GACCTGCAGAAGC | SEQ ID | GACCTGCAGAAGT | SEQ ID |
| | (Arg158Cys): | GCCTGGCAGTGT | NO: 199 | GCCTGGCAGTGT | NO: 200 |
| | C/T | | | | |
| Com- | 1L9H (26 | TCAGCCCCCAACTC | SEQ ID | TCAGCCCCCAACAC | SEQ ID |
| plement | T→A) | TGCCTGATGCC | NO: 201 | TGCCTGATGCC | NO: 202 |
| Factor | 1R32Q | GGTCTTTGGCCCGG | SEQ ID | GGTCTTTGGCCCAG | SEQ ID |
| B (BF) | (95G→A) | CCCCAGGGATC | NO: 203 | CCCCAGGGATC | NO: 204 |
| gene | | | | | |
| Com- | 1E318D | GGATATGACTGAG | SEQ ID | GGATATGACTGACG | SEQ ID |
| plement | (G/C) | GTGATCAGCAGC | NO: 205 | TGATCAGCAGC | NO: 206 |
| C2 | 1IVS10 | CCAGAGGCCCGTG | SEQ ID | CCAGAGGCCCGTTT | SEQ ID |
| gene: 2 | (G/T) | TTGGGAACCTGG | NO: 207 | TGGGAACCTGG | NO: 208 |
| variants | | | | | |
| ELOV | 1M299V | GAAAAACAACTCA | SEQ ID | GAAAAACAACTCG | SEQ ID |
| L4 | (A/G) | TGATAGAAAATG | NO: 209 | TGATAGAAAATG | NO: 210 |
| gene | | | | | |

### EXAMPLE 2

### Statistical Analysis in the Prediction of ARMD

This example demonstrates that MERT-ARMD offers a high magnitude clinical validity by assessing ARMD associated 105 genotypes simultaneously in identifying individuals at very high risk of developing ARMD, even if the contribution of each genotype to the risk is small and not enough to cause ARMD.

The results described below demonstrate that genetic susceptibility prediction for age-related macular degeneration is greatly improved by considering multiple predisposing genetic factors concurrently. To show how concurrent use of multiple genetic tests for age-related macular degeneration improves the prediction of genetic susceptibility to age-related macular degeneration, the likelihood ratio for each single ARMD risk-associated genetic defect was computed by logistic regression using real data for age-related macular degeneration associated genetic susceptibility and then the combined likelihood ratio (LR) for the panel of ARMD risk associated susceptibility gene tests was calculated as the product of the likelihood ratios (LRs) of the individual tests thinking each test is independent until proven otherwise.

The positive predictive value for each ARMD associated genotype-positive test result and then the positive predictive value of the combination of a panel of test results were calculated to test the clinical validation of MERT-ARMD.

For the calculations, 14 ARMD risk-associated genotypes in eleven ARMD risk-associated genes with an established prevalence both in control subjects and ARMD patients were selected.

The genotype frequencies were derived for CFH Y402H polymorphism, LOC387715 Ala69Ser polymorphism, TLR4 D299G polymorphism, Fibulin 5 ARMD-associated mutation, ABCR D2177N polymorphism, ABCR G1961E polymorphism, ABCR ARMD-associated mutation, VMD2 ARMD-associated mutation, CX3CR1 polymorphism, CST B/B genotype, MnSOD polymorphism, MEHE polymorphism, Paraoxonase Gln-Arg 192 polymorphism and Paraoxonase Leu-Met 54 polymorphism using previously reported data (Edwards et al., Science. 308:421-424, 2005; Zareparsi et al., Am. J. Hum. Genet. 77:149-153, 2005; Hageman et al., PNAS 102:7227-7232, 2005; Allikmets et al., Am. J. Hum. Genet. 67:487-491, 2000; Allikmets et al., Science 277:1805-1807, 1997; De La Paz et al., Opthalmology 106:1531-1536, 1999; Webster et al., Invest. Opthalmol. Vis. Sci. 42:1179-1189, 2001, Baum et al., Ophtlalmologica 217:111-114, 2003; Allilmets et al., Hum. Genet. 104:449-453, 1999; Lotery et al. Inves. Opthalmol Vis. Sci. 41:1292-1296, 2000; Stone et al. N. Engl. J. Med. 352:346-353, 2004; Tuo et al., FASEB. J. 18:1297-1299, 2004; Zurdel et al., Br. J. Opthalmol. 86:214-219, 2002; Kimura et al., Am. J. Opthalmol. 130:769-773, 2000; Ikeda et al., Am. J. Ophtlalmol. 132:191-195, 2001; Rivera et al., Hum. Mol. Genet. 14:3227-3236, 2005; and Zareparsi et al., Hum. Mol. Genet. 14: 1449-1455, 2005) (Table 2).

TABLE 2
Frequencies of ARMD risk-associated genotypes among patients
with age-related macular degeneration and matched control subjects

| | | Patients | | Control Subjects | |
|---|---|---|---|---|---|
| | | No. | | No. | |
| Gene | Mutation; Reference | Total | No. Affected | Total | No. Affected |
| CFH | Y402H polymorphism (CC); | 1968 | 651 (33%) | 880 | 106 (12%) |
| | 1, 2, 3 | | | | |
| LOC387715 | Ala69Ser polymorphism; 14 | 1120 | 735 (65.6%) | 922 | 331 (35.9%) |
| ABCR | D2177N polymorphism; 4 | 1189 | 21 (1.77%) | 1258 | 8 (0.64%) |
| | G1961E polymorphism; 4 | 1218 | 19 (1.56%) | 1258 | 4 (0.32%) |
| | ARMD-associated mutation; | 579 | 54 (9.3%) | 466 | 0 |
| | 4, 5, 6, 7 | | | | |
| Fibulin 5 | ARMD-associated mutation; 8 | 402 | 7 (1.7%) | 429 | 0 |
| VMD2 | ARMD-associated mutation; | 580 | 11 (1.9%) | 388 | 0 |
| | 4, 9 | | | | |
| TLR4 | D299G polymorphism; 15 | 667 | 83 (12.4%) | 438 | 26 (6%) |
| CX3CR1 | T280M polymorphism; 10 | 117 | 46 (39.3%) | 276 | 66 (23.9%) |
| CST3 | polymorphism (BB); 11 | 167 | 11 (6.6%) | 517 | 12 (2.3%) |
| MnSOD | polymorphism (ala/ala); 12 | 99 | 9 (9.1%) | 197 | 2 (1%) |
| MEHE | polymorphism (try/try); 12 | 98 | 32 (32.7%) | 66 | 33 (19.9%) |
| Paraoxonase | Gln-Arg192 polymorphism; | 72 | 38 (52.7%) | 140 | 49 (35%) |
| | 13 | | | | |
| | Leu-Met54 polymorphism; | 72 | 66 (91.7%) | 140 | 108 (77.1%) |
| | 13 | | | | |

1 Edwards et al., Science.308: 421-424, 2005.
2 Zareparsi et al., Am. J. Hum. Genet.77: 149-153, 2005.
3 Hageman et al., PNAS. 102: 7227-7232, 2005.
4 Allikmets et al., Am. J. Hum. Genet.67: 487-491, 2000.
5 Webster et al., Invest, Ophthalmol. Vis. Sci.42: 1179-1189, 2001.
6 De La Paz et al., Ophthalmology. 106: 1531-1536, 1999.
7 Baum et al., Ophthalmologica. 217: 111-114, 2003.
8 Stone et al., N. Engl. J. Med. 352: 346-353, 2004.
9 Lotery et al., Inves. Ophthalmol. Vis. Sci. 41: 1292-1296, 2000.
10 Tuo et al., FASEB. J.18: 1297-1299, 2004.
11 Zurdel et al., Br. J. Ophthalmol. 86: 214-219, 2002.
12 Kimura et al., Am. J. Ophthalmol. 130: 769-773, 2000.
13 Ikeda et al., Am. J. Ophthalmol. 132: 191-195, 2001.
14 Rivera et al., Hum. Mol. Genet. 14: 3227-3236, 2005.
15 Zareparsi et al., Hum. Mol. Genet. 14: 1449-1455, 2005.

LR for each of the 14 ARMD risk-associated genotypes in eleven ARMD risk-associated genes was calculated by exponentiation of the result of the logistic regression by using the data retrieved from the previously reported case control studies regarding for each ARMD associated genotypes as previously described (Albert, Clin. Chem. 28:1113-9, 1982; McCullagh and Nelder, Chapman and Hall, London, 1989; Yang et al., Am. J. Hum. Genet., 72:636-49, 2003).

The posterior probability of age-related macular degeneration (the probability of developing age-related macular degeneration) was determined for the individuals with genotype-positive test results for each genetic test (also known as positive predictive value of each genetic test) by using the pretest risk of age-related macular degeneration (the overall incidence rate of age-related macular degeneration in the general population) which has been estimated to be 1 per 1,359 person (0.07%) in US.

Since LRs for Fibulin 5 ARMD-associated mutation, ABCR ARMD-associated mutation and VMD2 ARMD-associated mutation demonstrated extreme values such as 1722435010 for Fibulin 5 ARMD-associated mutation, 1153423138 for ABCR ARMD-associated mutation and 1080866402 for VMD2 ARMD-associated mutation possibly related to their absence in control subjects, they were excluded from the rest of the calculations even though they were found to be significantly frequent in ARMD patients than in controls.

Then, by considering each of the eleven genetic defects in the nine different genes independent, combined LR was calculated for the panel of eleven ARMD-associated genetic susceptibility tests as the product of the likelihood ratios of the individual test results (Yang et al., Am. J Hum. Genet. 72:639-646, 2003). Calculated likelihood ratios and positive predictive values for each of the 11 ARMD risk-associated susceptibility gene test and combination of tests were demonstrated in Table 3.

TABLE 3
Likelihood ratios and Positive predictive values of single susceptibility
genes and multiple genetic screening with M.E.R.T.-ARMD
for assessing genetic risk for age-related macular degeneration.

| | | Posterior probability of |
|---|---|---|
| Single susceptibility test analysis | LR | developing ARMD |
| CFH Y402H polymorphism (CC) | 2.75 | 0.2% |
| LOC387715 Ala69Ser | 1.83 | 0.14% |
| polymorphism | | |
| ABCR | | |
| D2177 polymorphism | 2.78 | 0.2% |
| G1961E polymorphism | 13.34 | 0.98% |
| TLR4 D299G polymorphism | 2.1 | 0.16% |
| CX3CR1 T280M polymorphism | 2.26 | 0.17% |
| CST3 polymorphism (BB) | 2.84 | 0.21% |
| MnSOD polymorphism (ala/ala) | 8.95 | 0.66% |
| MEHE polymorphism (try/try) | 1.64 | 0.12% |
| Paraoxonase | | |
| Gln-Arg192 | 1.51 | 0.11% |
| polymorphism (BB) | | |
| Leu-Met54 | 1.19 | 0.1% |
| polymorphism (LL) | | |
| Concurrent screening of 11 | 66347.01 | 98% |
| polymorphisms in 9 genes with | | |
| M.E.R.T.-ARMD | | |

As shown in Table 3, whereas each genetic test provides limited predictive information about the probability of developing age-related macular degeneration (the posterior probabilities of disease range from 0.1% to 0.98% for each test alone), the posterior probability of age-related macular degeneration occurring increases to 98% by using MERT-ARMD, an increase of >90-fold.

### EXAMPLE 3

### Array for Detecting Susceptibility to ARMD

For each potential site of mutation/polymorphism (Table 1A and 1B), two oligonucleotide probes are designed. The first is complementary to the wild type sequence (SEQ ID NOS: 1, 3, 5, 7, 9, 11, 13, 15, 17, 19, 21, 23, 25, 27, 29, 31, 33, 35, 37, 39, 41, 43, 45, 47, 49, 51, 53, 55, 57, 59, 61, 63, 65, 67, 69, 71, 73, 75, 77, 79, 81, 83, 85, 87, 89, 91, 93, 95, 97, 99, 101, 103, 105, 107, 109, 111, 113, 115, 117, 119, 121, 123, 125, 127, 129, 131, 133, 135, 137, 139, 141, 143, 145, 147, 149, 151, 153, 155, 157, 159, 161, 163, 165, 167, 169, 171, 173, 175, 177, 179, 181, 183, 185, 187, 189, 191, 193, 195, 197, 199, 201, 203, 205, 207, and 209) and the second is complementary to the mutated sequence (SEQ ID NOS: 2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, 190, 192, 194, 196, 198, 200, 202, 204, 206, 208 and 210). For example, a first probe is complementary to a wild-type CFH sequence, and a second probe is complementary to a mutant CFH sequence, which can be used to detect the presence of the Y402H variant. The oligonucleotide probes can further include one or more detectable labels, to permit detection of hybridization signals between the probe and a target sequence.

Compilation of “loss” and “gain” of hybridization signals will reveal the genetic status of the individual with respect to the 105 ARMD-associated defects.

### EXAMPLE 4

### Nucleic Acid-Based Analysis

The ARMD-related nucleic acid molecules provided herein can be used in methods of genetic testing for predisposition to ARMD owing to ARMD-related nucleic acid molecule polymorphism/mutation in comparison to a wild-type nucleic acid molecule. For such procedures, a biological sample of the subject is assayed for a polymorphism or mutation (or both) in an ARMD-related nucleic acid molecule, such as those listed in Tables 1A and 1B. Suitable biological samples include samples containing genomic DNA or RNA (including mRNA) obtained from cells of a subject, such as those present in peripheral blood, urine, saliva, tissue biopsy, surgical specimen, amniocentesis samples and autopsy material.

The detection in the biological sample of a polymorphism/mutation in one or more ARMD-related nucleic acid molecules, such as those listed in Tables 1A and 1B, can be achieved by methods such as hybridization using allele specific oligonucleotides (ASOs) (Wallace et al., CSHL Symp. Quant. Biol. 51:257-61, 1986), direct DNA sequencing (Church and Gilbert, Proc. Natl. Acad. Sci. USA 81:1991-1995, 1988), the use of restriction enzymes (Flavell et al., Cell 15:25, 1978; Geever et al., 1981), discrimination on the basis of electrophoretic mobility in gels with denaturing reagent (Myers and Maniatis, Cold Spring Harbor Symp. Quant. Biol. 51:275-84, 1986), RNase protection (Myers et al., Science 230:1242, 1985), chemical cleavage (Cotton et al., Proc. Natl. Acad. Sci. USA 85:4397-401, 1985), and the ligase-mediated detection procedure (Landegren et al., Science 241:1077, 1988).

Oligonucleotides specific to wild-type or mutated ARMD-related sequences can be chemically synthesized using commercially available machines. These oligonucleotides can then be labeled, for example with radioactive isotopes (such as ³²P) or with non-radioactive labels such as biotin (Ward and Langer et al., Proc. Natl. Acad. Sci. USA 78:6633-6657, 1981) or a fluorophore, and hybridized to individual DNA samples immobilized on membranes or other solid supports by dot-blot or transfer from gels after electrophoresis. These specific sequences are visualized, for example by methods such as autoradiography or fluorometric (Landegren et al., Science 242:229-237, 1989) or colorimetric reactions (Gebeyehu et al., Nucleic Acids Res. 15:4513-4534, 1987). Using an ASO specific for a wild-type allele, the absence of hybridization would indicate a mutation or polymorphism in the particular region of the gene. In contrast, if an ASO specific for a mutant allele hybridizes to a clinical sample then that would indicate the presence of a mutation or polymorphism in the region defined by the ASO.

### EXAMPLE 5

### Protein-Based Analysis

This example describes methods that can be used to detect defects in an amount of an ARMD-related protein, or to detect changes in the amino acid sequence itself. ARMD-related protein sequences can be used in methods of genetic testing for predisposition to ARMD owing to ARMD-related protein polymorphism or mutation (or both) in comparison to a wild-type protein. For such procedures, a biological sample of the subject is assayed for a polymorphism or mutation in an ARMD-related protein, such as those listed in Tables 1A and 1B. Suitable biological samples include samples containing protein obtained from cells of a subject, such as those present in peripheral blood, urine, saliva, tissue biopsy, surgical specimen, amniocentesis samples and autopsy material.

A change in the amount of one or more ARMD-related proteins in a subject can indicate that the subject has an increased susceptibility to developing ARMD. Similarly, the presence of one or more mutations or polymorphisms in an ARMD-related protein in comparison to a wild-type protein can indicate that the subject has an increased susceptibility to developing ARMD.

The determination of altered (such as decreased or increased) ARMD-related protein levels, in comparison to such expression in a normal subject (such as a subject not predisposed to developing ARMD), is an alternative or supplemental approach to the direct determination of the presence of ARMD-related nucleic acid mutations or polymorphisms by the methods outlined above. The availability of antibodies specific to particular ARMD-related protein(s) will facilitate the detection and quantitation of cellular ARMD-related protein(s) by one of a number of immunoassay methods which are well known in the art, such as those presented in Harlow and Lane (Antibodies, A Laboratory Manual, CSHL, New York, 1988). Methods of constructing such antibodies are known in the art.

The determination of the presence of one or more mutations or polymorphisms in an ARMD-related protein, in comparison to a wild-type ARMD-related protein, is another alternative or supplemental approach to the direct determination of the presence of ARMD-related nucleic acid mutations or polymorphisms by the methods outlined above. Antibodies that can distinguish between a mutant or polymorphic protein and a wild-type protein can be prepared using methods known in the art.

Any standard immunoassay format (such as ELISA, Western blot, or RIA assay) can be used to measure ARMD-related polypeptide or protein levels, and to detect mutations or polymorphisms in ARMD-related proteins. A comparison to wild-type (normal) ARMD-related protein levels and a change in ARMD-related polypeptide levels is indicative of predisposition to developing ARMD. Similarly, the presence of one or more mutant or polymorphic ARMD-related proteins is indicative of predisposition to developing ARMD. Immunohistochemical techniques can also be utilized for ARMD-related polypeptide or protein detection and quantification. For example, a tissue sample can be obtained from a subject, and a section stained for the presence of a wild-type or polymorphic or mutant ARMD-related protein using the appropriate ARMD-related protein specific binding agents and any standard detection system (such as one that includes a secondary antibody conjugated to horseradish peroxidase). General guidance regarding such techniques can be found in Bancroft and Stevens (Theory and Practice of Histological Techniques, Churchill Livingstone, 1982) and Ausubel et al. (Current Protocols in Molecular Biology, John Wiley & Sons, New York, 1998).

For the purposes of quantitating an ARMD-related protein, a biological sample of the subject, which sample includes cellular proteins, can be used. Quantitation of an ARMD-related protein can be achieved by immunoassay and the amount compared to levels of the protein found in cells from a subject not genetically predisposed to developing ARMD. A significant change in the amount of one or more ARMD-related proteins in the cells of a subject compared to the amount of the same ARMD-related protein found in normal human cells is usually about a 30% or greater difference. Substantial underexpression or over expression of one or more ARMD-related protein(s) can be indicative of a genetic predisposition to developing ARMD.

### EXAMPLE 6

### Kits

Kits are provided to determine whether a subject has one or more mutations (such as polymorphism) in an ARMD-related nucleic acid sequence (such as kits containing ARMD detection arrays). Kits are also provided that contain the reagents need to detect hybridization complexes formed between oligonucleotides on an array and ARMD-related nucleic acids amplified from a subject. These kits can each include instructions, for instance instructions that provide calibration curves or charts to compare with the determined (such as experimentally measured) values.

In one example, the kit includes primers capable of amplifying ARMD-related nucleic acid molecules, such as those listed in Tables 1A and 1B. In particular examples, the primers are provided suspended in an aqueous solution or as a freeze-dried or lyophilized powder. The container(s) in which the primers are supplied can be any conventional container that is capable of holding the supplied form, for instance, microfuge tubes, ampoules, or bottles. In some applications, pairs of primers are be provided in pre-measured single use amounts in individual, typically disposable, tubes, or equivalent containers.

The amount of each primer supplied in the kit can be any amount, depending for instance on the market to which the product is directed. For instance, if the kit is adapted for research or clinical use, the amount of each oligonucleotide primer provided likely would be an amount sufficient to prime several in vitro amplification reactions. Those of ordinary skill in the art know the amount of oligonucleotide primer that is appropriate for use in a single amplification reaction. General guidelines may for instance be found in Innis et al. (PCR Protocols, A Guide to Methods and Applications, Academic Press, Inc., San Diego, Calif., 1990), Sambrook et al. (In Molecular Cloning: A Laboratory Manual, Cold Spring Harbor, New York, 1989), and Ausubel et al. (In Current Protocols in Molecular Biology, John Wiley & Sons, New York, 1998).

In particular examples, a kit includes an array with oligonucleotides that recognize wild-type, mutant or polymorphic ARMD-related sequences, such as those listed in Tables 1A and 1B. The array can include other oligonucleotides, for example to serve as negative or positive controls. The oligonucleotides that recognize the wild-type and mutant sequences can be on the same array, or on different arrays. A particular array is disclosed in Example 3. For example, the kit can include oligonucleotides comprising fragments of SEQ ID NOS: 1-210, or subsets thereof, such as at least 10 oligonucleotides comprising fragments of SEQ ID NOS:1-210, for example at least 20, at least 50, at least 100, at least 143, or even at least 250 oligonucleotides comprising fragments of SEQ ID NOS:1-210.

In some examples, kits further include the reagents necessary to carry out hybridization and detection reactions, including, for instance appropriate buffers. Written instructions can also be included.

Kits are also provided for the detection of ARMD-related protein expression, for instance under expression of a protein encoded for by a nucleic acid molecule listed in Table 1A and 1B. Such kits include one or more wild-type or mutant CFH, LOC387715, BF, C2, ABCR, Fibulin 5, VMD2, TLR4, CX3CR1, CST3, MnSOD, MEHE, paraoxonase, APOE, ELOVL4, hemicentin-1, GPR75, LAMC1, LAMC2, and LAMB3 proteins (full-length, fragments, or fusions) or specific binding agent (such as a polyclonal or monoclonal antibody or antibody fragment), and can include at least one control. The ARMD-related protein specific binding agent and control can be contained in separate containers. The kits can also include a means for detecting ARMD-related protein:agent complexes, for instance the agent may be detectably labeled. If the detectable agent is not labeled, it can be detected by second antibodies or protein A, for example, either of both of which also can be provided in some kits in one or more separate containers. Such techniques are well known.

Additional components in some kits include instructions for carrying out the assay. Instructions permit the tester to determine whether ARMD-linked expression levels are reduced in comparison to a control sample. Reaction vessels and auxiliary reagents such as chromogens, buffers, enzymes, etc. can also be included in the kits.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

In view of the many possible embodiments to which the principles of our disclosure may be applied, it should be recognized that the illustrated embodiments are only examples of the disclosure and should not be taken as a limitation on the scope of the disclosure. Rather, the scope of the disclosure is defined by the following claims. We therefore claim as our invention all that comes within the scope and spirit of these claims.

We claim:

1. A method of detecting genetic predisposition to age-related macular degeneration (ARMD) in a subject, comprising determining whether the subject has one or more mutations in at least nine ARMD risk-associated molecules, wherein the at least nine ARMD molecules are selected from the group consisting of CFH, LOC387715, BF, C2, ABCR, Fibulin 5, VMD2, TLR4, CX3CR1, CST3, MnSOD, MEHE, paraoxonase, APOE, ELOVL4 and hemicentin-1, and wherein the presence of one or more mutations indicates that the subject has a genetic predisposition for ARMD.

2. The method of claim 1, wherein the one or more mutations comprise one or more mutations listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

3. The method of claim 2, wherein the at least one or more mutations comprise 11 of the mutations listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

4. The method of claim 1, wherein the method comprises determining whether the subject has one or more mutations in at least 20 of the mutations listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

5. The method of claim 1, wherein the method comprises determining whether the subject has one or more mutations in at least 105 of the mutations listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

6. The method of claim 1, wherein the method comprises determining whether the subject has one or more mutations in no more than 11 of the mutations listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

7. The method of claim 1, wherein the method provides a probability of developing ARMD ranging from about 80% to about 98%.

8. The method of claim 1, wherein the at least nine ARMD-related molecules comprise nucleic acid molecules.

9. The method of claim 8, wherein the nucleic acid molecules are amplified from the subject, thereby generating amplification products, and wherein the amplification products are hybridized with oligonucleotide probes that detect the one or more mutations.

10. The method of claim 9, wherein hybridizing the oligonucleotides comprises:
a) incubating the amplification products with the oligonucleotide probes for a time sufficient to allow hybridization between the amplification products and oligonucleotide probes, thereby forming amplification products:oligonucleotide probe complexes; and,
b) analyzing the amplification products:oligonucleotide probe complexes to determine if the amplification products comprise one or more mutations in the ARMD-associated nucleic acids, wherein the presence of one or more mutations indicates that the subject has a genetic predisposition for ARMD.

11. The method of claim 10, wherein analyzing the amplification products:oligonucleotide probe complexes comprises determining an amount of nucleic acid hybridization, and wherein a greater amount of hybridization to one or more of the mutated sequences, as compared to an amount of hybridization to a corresponding wild-type sequence, indicates that the subject has a genetic predisposition for ARMD.

12. The method of claim 10, wherein analyzing the amplification products:oligonucleotide probe complexes includes detecting and quantifying the complexes.

13. The method of claim 9, wherein the oligonucleotide probes are present on an array substrate.

14. The method of claim 13, wherein the array further comprises oligonucleotide probes complementary to wild-type ARMD-related nucleic acid molecules.

15. The method of claim 14, wherein the wild-type ARMD-related nucleic acid molecules comprise oligonucleotide probes complementary to wild-type CFH, wild-type LOC387715, wild-type BF, wild-type C2, wild-type ABCR, wild-type Fibulin 5, wild-type VMD2, wild-type TRL4, wild-type CX3CR1, wild-type CST3, wild-type MnSOD, wild-type MEHE, wild-type paraoxonase, wild-type APOE, wild-type ELOVL4 and wild-type hemicentin-1 nucleic acid sequences, or a combination thereof.

16. The method of claim 1, wherein the at least nine ARMD-related molecules consist of sequences from CFH, LOC387715, ABCR, TRL4, CX3CR1, CST3, MnSOD, MEHE, and paraoxonase.

17. The method of claim 1, wherein the subject is in a group potentially at risk of developing an ARMD.

18. The method of claim 17, wherein the subject smokes.

19. The method of claim 9, wherein the nucleic acid molecules obtained from the subject are obtained from serum.

20. A method of detecting genetic predisposition to ARMD in a subject, comprising:
a) applying amplification products obtained from the subject to an array, wherein the array comprises oligonucleotide probes complementary to nine or more mutations or polymorphisms in at least nine molecules selected from the group consisting of CFH, LOC387715, BF, C2, ABCR, Fibulin 5, VMD2, TLR4, CX3CR1, CST3, MnSOD, MEHE, paraoxonase, APOE, ELOVL4 and hemicentin-1;
b) incubating the amplification products with the array under conditions sufficient to allow hybridization between the amplification products and oligonucleotide probes, thereby forming amplification products:oligonucleotide probe complexes; and,
c) analyzing the amplification products:oligonucleotide probe complexes to determine if the amplification products comprise one or more mutations or polymorphisms in the at least nine molecules, wherein the presence of one or more mutations or polymorphisms indicates that the subject has a genetic predisposition for ARMD.

21. A method of selecting an ARMD therapy, comprising:
a) detecting a mutation in at least one ARMD-related molecule of a subject, using the method of claim 1; and,
b) if such mutation is identified, selecting a treatment to treat ARMD.

22. An array comprising oligonucleotide probes complementary to wild-type gene sequences, mutated gene sequences, or both, wherein the gene sequences comprise coding or non-coding sequences from CFH, LOC387715, BF, C2, ABCR, Fibulin 5, VMD2, TLR4, CX3CR1, CST3, MnSOD, MEHE, paraoxonase, APOE, ELOVL4 and hemicentin-1, or a combination thereof.

23. The array of claim 22, wherein the mutated gene sequences comprise eleven or more mutations or polymorphisms listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

24. The array of claim 23, wherein the mutated gene sequences consist essentially of the mutations or polymorphisms listed for CFH, LOC387715, BF, C2, ABCR, Fibulin 5, VMD2, TLR4, CX3CR1, CST3, MnSOD, MEHE, paraoxonase, APOE, ELOVL4 and hemicentin-1 in Table 1A.

25. A method of detecting a genetic predisposition to age-related macular degeneration (ARMD) in a subject, comprising:
a) applying amplification products to the array of claim 22, wherein the amplification products comprise amplified nucleic acids obtained from the subject, wherein the nucleic acids comprise coding or non-coding sequences from at least nine molecules selected from the group consisting of CFH, LOC387715, BF, C2, ABCR, Fibulin 5, VMD2, TLR4, CX3CR1, CST3, MnSOD, MEHE, paraoxonase, APOE, ELOVL4 and hemicentin-1;
b) incubating the amplification products with the array under conditions sufficient to allow hybridization between the amplification products and oligonucleotide probes, thereby forming amplification products:oligonucleotide probe complexes; and
c) analyzing the amplification products:oligonucleotide probe complexes to determine if the amplification products comprise one or more mutations or polymorphisms in the at least nine molecules, wherein the presence of one or more mutations or polymorphisms indicates that the subject has a genetic predisposition for ARMD.

26. A kit for detecting a genetic predisposition to age-related macular degeneration (ARMD) in a subject, comprising the array of claim 22.

27. The kit of claim 26, further comprising primers for amplifying nucleic acid molecules obtained from the subject to obtain amplification products, in separate packaging, wherein the amplification products comprise sequences from CFH, LOC387715, BF, C2, ABCR, Fibulin 5, VMD2, TLR4, CX3CR1, CST3, MnSOD, MEHE, paraoxonase, APOE, ELOVL4 and hemicentin-1 genes.

28. The kit of claim 26, further comprising an amplification enzyme, in separate packaging.

29. The kit of claim 26, further comprising a buffer solution, in separate packaging.

30. The kit of claim 27, wherein the array further comprises oligonucleotides capable of hybridizing under stringent conditions to a wild-type CFH, wild-type LOC387715, wild-type BF, wild type C2, wild-type ABCR, wild-type Fibulin 5, wild-type VMD2, wild-type TRL4, wild-type CX3CR1, wild-type CST3, wild-type MnSOD, wild-type MEHE, wild-type paraoxonase, wild-type APOE, wild-type ELOVL4, and wild-type hemicentin-1.


SEQUENCE LISTING (210 sequences)

SEQ ID NO: 1 - DNA, 25 bp, Artificial Sequence
  Synthetic oligonucleotide probe
tttacacagtacaatagacttaccc

SEQ ID NO: 2 - DNA, 25 bp, Artificial Sequence
  Synthetic oligonucleotide probe
tttacacagtacgatagacttaccc

SEQ ID NO: 3 - DNA, 25 bp, Artificial Sequence
  Synthetic oligonucleotide probe
tctcttggaaatataataatggtat

SEQ ID NO: 4 - DNA, 25 bp, Artificial Sequence
  Synthetic oligonucleotide probe
tctcttggaaatgtaataatggtat

SEQ ID NO: 5 - DNA, 25 bp, Artificial Sequence
  Synthetic oligonucleotide probe
actaattcataactttttttttttc

SEQ ID NO: 6 - DNA, 25 bp, Artificial Sequence
  Synthetic oligonucleotide probe
actaattcataactttttttttcgt

SEQ ID NO: 7 - DNA, 25 bp, Artificial Sequence
  Synthetic oligonucleotide probe
acatttaggactcatttgaagttag

SEQ ID NO: 8 - DNA, 25 bp, Artificial Sequence
  Synthetic oligonucleotide probe
acatttaggacttatttgaagttag

SEQ ID NO: 9 - DNA, 25 bp, Artificial Sequence
  Synthetic oligonucleotide probe
gggaaatacagccaaatgcacaagt

SEQ ID NO: 10 - DNA, 25 bp, Artificial Sequence
  Synthetic oligonucleotide probe
gggaaatacagcaaaatgcacaagt

SEQ ID NO: 11 - DNA, 25 bp, Artificial Sequence
  Synthetic oligonucleotide probe
gcattgatatttagctttttctttt

SEQ ID NO: 12 - DNA, 25 bp, Artificial Sequence
  Synthetic oligonucleotide probe
gcattgatatttggctttttctttt

SEQ ID NO: 13 - DNA, 25 bp, Artificial Sequence
  Synthetic oligonucleotide probe
tataatcaaaattatggaagaaagt

SEQ ID NO: 14 - DNA, 25 bp, Artificial Sequence
  Synthetic oligonucleotide probe
tataatcaaaatcatggaagaaagt

SEQ ID NO: 15 - DNA, 25 bp, Artificial Sequence
  Synthetic oligonucleotide probe
tatttattagtagatctaatcaata

SEQ ID NO: 16 - DNA, 25 bp, Artificial Sequence
  Synthetic oligonucleotide probe
tatttattagtatatctaatcaata

SEQ ID NO: 17 - DNA, 25 bp, Artificial Sequence
  Synthetic oligonucleotide probe
tatagctgagtgacatgaggtagtc

SEQ ID NO: 18 - DNA, 25 bp, Artificial Sequence
  Synthetic oligonucleotide probe
tatagctgagtggcatgaggtagtc

SEQ ID NO: 19 - DNA, 25 bp, Artificial Sequence
  Synthetic oligonucleotide probe
ttactgttcctcatcttctttgaac

SEQ ID NO: 20 - DNA, 25 bp, Artificial Sequence
  Synthetic oligonucleotide probe
ttactgttcctcgtcttctttgaac

SEQ ID NO: 21 - DNA, 25 bp, Artificial Sequence
  Synthetic oligonucleotide probe
actgctttagctatgtcccagaatg

SEQ ID NO: 22 - DNA, 25 bp, Artificial Sequence
  Synthetic oligonucleotide probe
actgctttagctgtgtcccagaatg

SEQ ID NO: 23 - DNA, 25 bp, Artificial Sequence
  Synthetic oligonucleotide probe
tagtgtgggctgtaacttaagtttc

SEQ ID NO: 24 - DNA, 25 bp, Artificial Sequence
  Synthetic oligonucleotide probe
tagtgtgggctgcaacttaagtttc

SEQ ID NO: 25 - DNA, 25 bp, Artificial Sequence
  Synthetic oligonucleotide probe
ctttccactggggcagacccagaga

SEQ ID NO: 26 - DNA, 25 bp, Artificial Sequence
  Synthetic oligonucleotide probe
ctttccactgggacagacccagaga

SEQ ID NO: 27 - DNA, 25 bp, Artificial Sequence
  Synthetic oligonucleotide probe
cagaactaagagttttagaatacag

SEQ ID NO: 28 - DNA, 25 bp, Artificial Sequence
  Synthetic oligonucleotide probe
cagaactaagagctttagaatacag

SEQ ID NO: 29 - DNA, 25 bp, Artificial Sequence
  Synthetic oligonucleotide probe
taagagactcatgaatttcttttct

SEQ ID NO: 30 - DNA, 25 bp, Artificial Sequence
  Synthetic oligonucleotide probe
taagagactcataaatttcttttct

SEQ ID NO: 31 - DNA, 25 bp, Artificial Sequence
  Synthetic oligonucleotide probe
tttatgcaccaccgacaacagaagg

SEQ ID NO: 32 - DNA, 25 bp, Artificial Sequence
  Synthetic oligonucleotide probe
tttatgcaccacggacaacagaagg

SEQ ID NO: 33 - DNA, 25 bp, Artificial Sequence
  Synthetic oligonucleotide probe
aaatatctcttcctatcctttgtcc

SEQ ID NO: 34 - DNA, 25 bp, Artificial Sequence
  Synthetic oligonucleotide probe
aaatatctcttcatatcctttgtcc

SEQ ID NO: 35 - DNA, 25 bp, Artificial Sequence
  Synthetic oligonucleotide probe
atctgacaatcttgtaactatttgt

SEQ ID NO: 36 - DNA, 25 bp, Artificial Sequence
  Synthetic oligonucleotide probe
atctgacaatctcgtaactatttgt

SEQ ID NO: 37 - DNA, 25 bp, Artificial Sequence
  Synthetic oligonucleotide probe
tccagagatttttttctaatataag

SEQ ID NO: 38 - DNA, 25 bp, Artificial Sequence
  Synthetic oligonucleotide probe
tccagagattttattctaatataag

SEQ ID NO: 39 - DNA, 25 bp, Artificial Sequence
  Synthetic oligonucleotide probe
taacaaaaatggtttttaatagagt

SEQ ID NO: 40 - DNA, 25 bp, Artificial Sequence
  Synthetic oligonucleotide probe
taacaaaaatggattttaatagagt

SEQ ID NO: 41 - DNA, 25 bp, Artificial Sequence
  Synthetic oligonucleotide probe
aaaggagtctcaataaggtccagga

SEQ ID NO: 42 - DNA, 25 bp, Artificial Sequence
  Synthetic oligonucleotide probe
aaaggagtctcagtaaggtccagga

SEQ ID NO: 43 - DNA, 25 bp, Artificial Sequence
  Synthetic oligonucleotide probe
aaatatattaaacaggtctgtgcat

SEQ ID NO: 44 - DNA, 25 bp, Artificial Sequence
  Synthetic oligonucleotide probe
aaatatattaaataggtctgtgcat

SEQ ID NO: 45 - DNA, 25 bp, Artificial Sequence
  Synthetic oligonucleotide probe
tccttggcagttattttctttcaga

SEQ ID NO: 46 - DNA, 25 bp, Artificial Sequence
  Synthetic oligonucleotide probe
tccttggcagttgttttctttcaga

SEQ ID NO: 47 - DNA, 25 bp, Artificial Sequence
  Synthetic oligonucleotide probe
tgagcgatcatatattgtaccttca

SEQ ID NO: 48 - DNA, 25 bp, Artificial Sequence
  Synthetic oligonucleotide probe
tgagcgatcatacattgtaccttca

SEQ ID NO: 49 - DNA, 25 bp, Artificial Sequence
  Synthetic oligonucleotide probe
taagaaggaagaagaatgagatgaa

SEQ ID NO: 50 - DNA, 25 bp, Artificial Sequence
  Synthetic oligonucleotide probe
taagaaggaagaggaatgagatgaa

SEQ ID NO: 51 - DNA, 25 bp, Artificial Sequence
  Synthetic oligonucleotide probe
ttactttaggggattgcaggaggct

SEQ ID NO: 52 - DNA, 25 bp, Artificial Sequence
  Synthetic oligonucleotide probe
ttactttagggggttgcaggaggct

SEQ ID NO: 53 - DNA, 25 bp, Artificial Sequence
  Synthetic oligonucleotide probe
atgatcccagctgctaaaatccaca

SEQ ID NO: 54 - DNA, 25 bp, Artificial Sequence
  Synthetic oligonucleotide probe
atgatcccagcttctaaaatccaca

SEQ ID NO: 55 - DNA, 25 bp, Artificial Sequence
  Synthetic oligonucleotide probe
actacctcgatgatattattgactt

SEQ ID NO: 56 - DNA, 25 bp, Artificial Sequence
  Synthetic oligonucleotide probe
actacctcgatggtattattgactt

SEQ ID NO: 57 - DNA, 25 bp, Artificial Sequence
  Synthetic oligonucleotide probe
acaccctacaacgttatgattttcc

SEQ ID NO: 58 - DNA, 25 bp, Artificial Sequence
  Synthetic oligonucleotide probe
acaccctacaacattatgattttcc

SEQ ID NO: 59 - DNA, 25 bp, Artificial Sequence
  Synthetic oligonucleotide probe
gtgtgactgagacggttgcatttag

SEQ ID NO: 60 - DNA, 25 bp, Artificial Sequence
  Synthetic oligonucleotide probe
gtgtgactgagatggttgcatttag

SEQ ID NO: 61 - DNA, 25 bp, Artificial Sequence
  Synthetic oligonucleotide probe
ggagtgcaggccgcggtggggtggg

SEQ ID NO: 62 - DNA, 25 bp, Artificial Sequence
  Synthetic oligonucleotide probe
ggagtgcaggccccggtggggtggg

SEQ ID NO: 63 - DNA, 25 bp, Artificial Sequence
  Synthetic oligonucleotide probe
cctcggtatcgcagcgggtcctctc

SEQ ID NO: 64 - DNA, 25 bp, Artificial Sequence
  Synthetic oligonucleotide probe
cctcggtatcgccgcgggtcctctc

SEQ ID NO: 65 - DNA, 25 bp, Artificial Sequence
  Synthetic oligonucleotide probe
gtgagccccgcggccggctccagtc

SEQ ID NO: 66 - DNA, 25 bp, Artificial Sequence
  Synthetic oligonucleotide probe
gtgagccccgcgaccggctccagtc

SEQ ID NO: 67 - DNA, 25 bp, Artificial Sequence
  Synthetic oligonucleotide probe
agctggctccggttttggggtatct

SEQ ID NO: 68 - DNA, 25 bp, Artificial Sequence
  Synthetic oligonucleotide probe
agctggctccggctttggggtatct

SEQ ID NO: 69 - DNA, 25 bp, Artificial Sequence
  Synthetic oligonucleotide probe
attctcaacagacaccctcacttca

SEQ ID NO: 70 - DNA, 25 bp, Artificial Sequence
  Synthetic oligonucleotide probe
attctcaacagataccctcacttca

SEQ ID NO: 71 - DNA, 25 bp, Artificial Sequence
  Synthetic oligonucleotide probe
acccctacttacaatcctgggagat

SEQ ID NO: 72 - DNA, 25 bp, Artificial Sequence
  Synthetic oligonucleotide probe
acccctacttacgatcctgggagat

SEQ ID NO: 73 - DNA, 25 bp, Artificial Sequence
  Synthetic oligonucleotide probe
ggctctgaagacatggagatactgc

SEQ ID NO: 74 - DNA, 25 bp, Artificial Sequence
  Synthetic oligonucleotide probe
ggctctgaagacctggagatactgc

SEQ ID NO: 75 - DNA, 25 bp, Artificial Sequence
  Synthetic oligonucleotide probe
caaacatatatatatttaaaaaatt

SEQ ID NO: 76 - DNA, 25 bp, Artificial Sequence
  Synthetic oligonucleotide probe
caaacatatatacatttaaaaaatt

SEQ ID NO: 77 - DNA, 25 bp, Artificial Sequence
  Synthetic oligonucleotide probe
tttactgtcaattacagcttcccac

SEQ ID NO: 78 - DNA, 25 bp, Artificial Sequence
  Synthetic oligonucleotide probe
tttactgtcaatgacagcttcccac

SEQ ID NO: 79 - DNA, 25 bp, Artificial Sequence
  Synthetic oligonucleotide probe
aagaactggaacacgttaggaagtt

SEQ ID NO: 80 - DNA, 25 bp, Artificial Sequence
  Synthetic oligonucleotide probe
aagaactggaacgcgttaggaagtt

SEQ ID NO: 81 - DNA, 25 bp, Artificial Sequence
  Synthetic oligonucleotide probe
cagcttggtgaagaaggtattactg

SEQ ID NO: 82 - DNA, 25 bp, Artificial Sequence
  Synthetic oligonucleotide probe
cagcttggtgaaaaaggtattactg

SEQ ID NO: 83 - DNA, 25 bp, Artificial Sequence
  Synthetic oligonucleotide probe
atcaggtgtttccaggtaagcatcc

SEQ ID NO: 84 - DNA, 25 bp, Artificial Sequence
  Synthetic oligonucleotide probe
atcaggtgtttctaggtaagcatcc

SEQ ID NO: 85 - DNA, 25 bp, Artificial Sequence
  Synthetic oligonucleotide probe
ctgtttatttgtctctatttttagg

SEQ ID NO: 86 - DNA, 25 bp, Artificial Sequence
  Synthetic oligonucleotide probe
ctgtttatttgtgtctatttttagg

SEQ ID NO: 87 - DNA, 25 bp, Artificial Sequence
  Synthetic oligonucleotide probe
ggctctgtgcaagatgtatatggat

SEQ ID NO: 88 - DNA, 25 bp, Artificial Sequence
  Synthetic oligonucleotide probe
ggctctgtgcaacatgtatatggat

SEQ ID NO: 89 - DNA, 25 bp, Artificial Sequence
  Synthetic oligonucleotide probe
ctgcctttgctcgttctcagctccc

SEQ ID NO: 90 - DNA, 25 bp, Artificial Sequence
  Synthetic oligonucleotide probe
ctgcctttgctccttctcagctccc

SEQ ID NO: 91 - DNA, 25 bp, Artificial Sequence
  Synthetic oligonucleotide probe
agatttttgagccctgtggccggcc

SEQ ID NO: 92 - DNA, 25 bp, Artificial Sequence
  Synthetic oligonucleotide probe
agatttttgagcgctgtggccggcc

SEQ ID NO: 93 - DNA, 25 bp, Artificial Sequence
  Synthetic oligonucleotide probe
cccaggaggaggcccagctggagat

SEQ ID NO: 94 - DNA, 25 bp, Artificial Sequence
  Synthetic oligonucleotide probe
cccaggaggaggtccagctggagat

SEQ ID NO: 95 - DNA, 25 bp, Artificial Sequence
  Synthetic oligonucleotide probe
catctccatgccacagtcatgttta

SEQ ID NO: 96 - DNA, 25 bp, Artificial Sequence
  Synthetic oligonucleotide probe
catctccatgcctcagtcatgttta

SEQ ID NO: 97 - DNA, 25 bp, Artificial Sequence
  Synthetic oligonucleotide probe
agttgcatgatgttggcacgcgcct

SEQ ID NO: 98 - DNA, 25 bp, Artificial Sequence
  Synthetic oligonucleotide probe
agttgcatgatgctggcacgcgcct

SEQ ID NO: 99 - DNA, 25 bp, Artificial Sequence
  Synthetic oligonucleotide probe
gtgagcagttcacggtacttgcaga

SEQ ID NO: 100 - DNA, 25 bp, Artificial Sequence
  Synthetic oligonucleotide probe
gtgagcagttcatggtacttgcaga

SEQ ID NO: 101 - DNA, 25 bp, Artificial Sequence
  Synthetic oligonucleotide probe
gtacttgcagacgtcctcctgaata

SEQ ID NO: 102 - DNA, 25 bp, Artificial Sequence
  Synthetic oligonucleotide probe
gtacttgcagacatcctcctgaata

SEQ ID NO: 103 - DNA, 25 bp, Artificial Sequence
  Synthetic oligonucleotide probe
cctccaaacaacggggccccaggtc

SEQ ID NO: 104 - DNA, 25 bp, Artificial Sequence
  Synthetic oligonucleotide probe
cctccaaacaacgggccccaggtct

SEQ ID NO: 105 - DNA, 25 bp, Artificial Sequence
  Synthetic oligonucleotide probe
cagagaacacagcgcagcacggaaa

SEQ ID NO: 106 - DNA, 25 bp, Artificial Sequence
  Synthetic oligonucleotide probe
cagagaacacagagcagcacggaaa

SEQ ID NO: 107 - DNA, 25 bp, Artificial Sequence
  Synthetic oligonucleotide probe
gaggaatttccattggaggaaagct

SEQ ID NO: 108 - DNA, 25 bp, Artificial Sequence
  Synthetic oligonucleotide probe
gaggaatttccactggaggaaagct

SEQ ID NO: 109 - DNA, 25 bp, Artificial Sequence
  Synthetic oligonucleotide probe
gaagcacttgttgggtttttaagcg

SEQ ID NO: 110 - DNA, 25 bp, Artificial Sequence
  Synthetic oligonucleotide probe
gaagcacttgttaggtttttaagcg

SEQ ID NO: 111 - DNA, 25 bp, Artificial Sequence
  Synthetic oligonucleotide probe
aatgtgagcggggtatgtaaacaga

SEQ ID NO: 112 - DNA, 25 bp, Artificial Sequence
  Synthetic oligonucleotide probe
aatgtgagcgggttatgtaaacaga

SEQ ID NO: 113 - DNA, 25 bp, Artificial Sequence
  Synthetic oligonucleotide probe
tgacttgcttaactaccatgaatga

SEQ ID NO: 114 - DNA, 25 bp, Artificial Sequence
  Synthetic oligonucleotide probe
tgacttgcttaattaccatgaatga

SEQ ID NO: 115 - DNA, 25 bp, Artificial Sequence
  Synthetic oligonucleotide probe
ctctgggacatcgtaagtgtcagtt

SEQ ID NO: 116 - DNA, 25 bp, Artificial Sequence
  Synthetic oligonucleotide probe
ctctgggacatcataagtgtcagtt

SEQ ID NO: 117 - DNA, 25 bp, Artificial Sequence
  Synthetic oligonucleotide probe
ggaattatttgataataaccgggtg

SEQ ID NO: 118 - DNA, 25 bp, Artificial Sequence
  Synthetic oligonucleotide probe
ggaattatttgagaataaccgggtg

SEQ ID NO: 119 - DNA, 25 bp, Artificial Sequence
  Synthetic oligonucleotide probe
tgctggtccagcgccacttcttcct

SEQ ID NO: 120 - DNA, 25 bp, Artificial Sequence
  Synthetic oligonucleotide probe
tgctggtccagcaccacttcttcct

SEQ ID NO: 121 - DNA, 25 bp, Artificial Sequence
  Synthetic oligonucleotide probe
tagtgctttggcctcctgggagtga

SEQ ID NO: 122 - DNA, 25 bp, Artificial Sequence
  Synthetic oligonucleotide probe
tagtgctttggcttcctgggagtga

SEQ ID NO: 123 - DNA, 25 bp, Artificial Sequence
  Synthetic oligonucleotide probe
tactcagtaattgctttttttcttg

SEQ ID NO: 124 - DNA, 25 bp, Artificial Sequence
  Synthetic oligonucleotide probe
tactcagtaattactttttttcttg

SEQ ID NO: 125 - DNA, 25 bp, Artificial Sequence
  Synthetic oligonucleotide probe
tctcttccctaggttgcaaactgga

SEQ ID NO: 126 - DNA, 25 bp, Artificial Sequence
  Synthetic oligonucleotide probe
tctcttccctagcttgcaaactgga

SEQ ID NO: 127 - DNA, 25 bp, Artificial Sequence
  Synthetic oligonucleotide probe
ctgctggtaactgcgggcttgggcc

SEQ ID NO: 128 - DNA, 25 bp, Artificial Sequence
  Synthetic oligonucleotide probe
ctgctggtaactacgggcttgggcc

SEQ ID NO: 129 - DNA, 25 bp, Artificial Sequence
  Synthetic oligonucleotide probe
tcaaatccccgaaggacgacctgct

SEQ ID NO: 130 - DNA, 25 bp, Artificial Sequence
  Synthetic oligonucleotide probe
tgaagatcaaatcacctgcttcctg

SEQ ID NO: 131 - DNA, 25 bp, Artificial Sequence
  Synthetic oligonucleotide probe
gagcagttcttccaggggaacttcc

SEQ ID NO: 132 - DNA, 25 bp, Artificial Sequence
  Synthetic oligonucleotide probe
gagcagttcttcaggggaacttccc

SEQ ID NO: 133 - DNA, 25 bp, Artificial Sequence
  Synthetic oligonucleotide probe
atgcagtccacagcttgaggcagtt

SEQ ID NO: 134 - DNA, 25 bp, Artificial Sequence
  Synthetic oligonucleotide probe
atgcagtccacaccttgaggcagtt

SEQ ID NO: 135 - DNA, 25 bp, Artificial Sequence
  Synthetic oligonucleotide probe
tcgttcctgcagccagaaaggaact

SEQ ID NO: 136 - DNA, 25 bp, Artificial Sequence
  Synthetic oligonucleotide probe
tcgttcctgcagacagaaaggaact

SEQ ID NO: 137 - DNA, 25 bp, Artificial Sequence
  Synthetic oligonucleotide probe
ggctgtgtgtcggagttcgccctgg

SEQ ID NO: 138 - DNA, 25 bp, Artificial Sequence
  Synthetic oligonucleotide probe
ggctgtgtgtcgaagttcgccctgg

SEQ ID NO: 139 - DNA, 25 bp, Artificial Sequence
  Synthetic oligonucleotide probe
tccccgaaggacgacctgcttcctg

SEQ ID NO: 140 - DNA, 25 bp, Artificial Sequence
  Synthetic oligonucleotide probe
tccccgaaggacaacctgcttcctg

SEQ ID NO: 141 - DNA, 25 bp, Artificial Sequence
  Synthetic oligonucleotide probe
gacatgatgtgtgttaaccaaaatg

SEQ ID NO: 142 - DNA, 25 bp, Artificial Sequence
  Synthetic oligonucleotide probe
gacatgatgtgtcttaaccaaaatg

SEQ ID NO: 143 - DNA, 25 bp, Artificial Sequence
  Synthetic oligonucleotide probe
tatgcattccccggacaaaccctgt

SEQ ID NO: 144 - DNA, 25 bp, Artificial Sequence
  Synthetic oligonucleotide probe
tatgcattccccagacaaaccctgt

SEQ ID NO: 145 - DNA, 25 bp, Artificial Sequence
  Synthetic oligonucleotide probe
ccctactcgaccccctactcaggtc

SEQ ID NO: 146 - DNA, 25 bp, Artificial Sequence
  Synthetic oligonucleotide probe
ccctactcgacctcctactcaggtc

SEQ ID NO: 147 - DNA, 25 bp, Artificial Sequence
  Synthetic oligonucleotide probe
atgaaagcaaccaatgtgtggatgt

SEQ ID NO: 148 - DNA, 25 bp, Artificial Sequence
  Synthetic oligonucleotide probe
atgaaagcaacccatgtgtggatgt

SEQ ID NO: 149 - DNA, 25 bp, Artificial Sequence
  Synthetic oligonucleotide probe
agtgcttagacattgatgaatgtcg

SEQ ID NO: 150 - DNA, 25 bp, Artificial Sequence
  Synthetic oligonucleotide probe
agtgcttagacactgatgaatgtcg

SEQ ID NO: 151 - DNA, 25 bp, Artificial Sequence
  Synthetic oligonucleotide probe
gtgaaccagcccggcacatacttct

SEQ ID NO: 152 - DNA, 25 bp, Artificial Sequence
  Synthetic oligonucleotide probe
gtgaaccagcccagcacatacttct

SEQ ID NO: 153 - DNA, 25 bp, Artificial Sequence
  Synthetic oligonucleotide probe
accatcttgtaccgggacatggacg

SEQ ID NO: 154 - DNA, 25 bp, Artificial Sequence
  Synthetic oligonucleotide probe
accatcttgtactgggacatggacg

SEQ ID NO: 155 - DNA, 25 bp, Artificial Sequence
  Synthetic oligonucleotide probe
cgctccgttcccgctgacatcttcc

SEQ ID NO: 156 - DNA, 25 bp, Artificial Sequence
  Synthetic oligonucleotide probe
cgctccgttcccactgacatcttcc

SEQ ID NO: 157 - DNA, 25 bp, Artificial Sequence
  Synthetic oligonucleotide probe
gccccatcaaagggccccgggaaat

SEQ ID NO: 158 - DNA, 25 bp, Artificial Sequence
  Synthetic oligonucleotide probe
gccccatcaaagagccccgggaaat

SEQ ID NO: 159 - DNA, 25 bp, Artificial Sequence
  Synthetic oligonucleotide probe
ccgtggcccgaccgcctcatgagcc

SEQ ID NO: 160 - DNA, 25 bp, Artificial Sequence
  Synthetic oligonucleotide probe
ccgtggcccgactgcctcatgagcc

SEQ ID NO: 161 - DNA, 25 bp, Artificial Sequence
  Synthetic oligonucleotide probe
gaaggcaaggacgagcaaggccggc

SEQ ID NO: 162 - DNA, 25 bp, Artificial Sequence
  Synthetic oligonucleotide probe
gaaggcaaggaccagcaaggccggc

SEQ ID NO: 163 - DNA, 25 bp, Artificial Sequence
  Synthetic oligonucleotide probe
accgcagtctacaagcgcttcccca

SEQ ID NO: 164 - DNA, 25 bp, Artificial Sequence
  Synthetic oligonucleotide probe
accgcagtctactagcgcttcccca

SEQ ID NO: 165 - DNA, 25 bp, Artificial Sequence
  Synthetic oligonucleotide probe
ccctcttctgccccccaggagatga

SEQ ID NO: 166 - DNA, 25 bp, Artificial Sequence
  Synthetic oligonucleotide probe
ccctcttctgcctcccaggagatga

SEQ ID NO: 167 - DNA, 25 bp, Artificial Sequence
  Synthetic oligonucleotide probe
aggagatgaacaccttgcgtactca

SEQ ID NO: 168 - DNA, 25 bp, Artificial Sequence
  Synthetic oligonucleotide probe
aggagatgaacatcttgcgtactca

SEQ ID NO: 169 - DNA, 25 bp, Artificial Sequence
  Synthetic oligonucleotide probe
ctcgttgtgcccgtcttcacgttcc

SEQ ID NO: 170 - DNA, 25 bp, Artificial Sequence
  Synthetic oligonucleotide probe
ctcgttgtgcccatcttcacgttcc

SEQ ID NO: 171 - DNA, 25 bp, Artificial Sequence
  Synthetic oligonucleotide probe
atacacactacactcaaagatcaca

SEQ ID NO: 172 - DNA, 25 bp, Artificial Sequence
  Synthetic oligonucleotide probe
atacacactacattcaaagatcaca

SEQ ID NO: 173 - DNA, 25 bp, Artificial Sequence
  Synthetic oligonucleotide probe
cttccatacttatgctgttaatact

SEQ ID NO: 174 - DNA, 25 bp, Artificial Sequence
  Synthetic oligonucleotide probe
cttccatacttacgctgttaatact

SEQ ID NO: 175 - DNA, 25 bp, Artificial Sequence
  Synthetic oligonucleotide probe
agtgacctggatgaaagatggccac

SEQ ID NO: 176 - DNA, 25 bp, Artificial Sequence
  Synthetic oligonucleotide probe
agtgacctggataaaagatggccac

SEQ ID NO: 177 - DNA, 25 bp, Artificial Sequence
  Synthetic oligonucleotide probe
gttgtaaggaatgcagctggtgaag

SEQ ID NO: 178 - DNA, 25 bp, Artificial Sequence
  Synthetic oligonucleotide probe
gttgtaaggaatccagctggtgaag

SEQ ID NO: 179 - DNA, 25 bp, Artificial Sequence
  Synthetic oligonucleotide probe
gtgaaggtaaaagagaaacagagtg

SEQ ID NO: 180 - DNA, 25 bp, Artificial Sequence
  Synthetic oligonucleotide probe
gtgaaggtaaaacagaaacagagtg

SEQ ID NO: 181 - DNA, 25 bp, Artificial Sequence
  Synthetic oligonucleotide probe
attatgtgcaacattaggccttgcc

SEQ ID NO: 182 - DNA, 25 bp, Artificial Sequence
  Synthetic oligonucleotide probe
attatgtgcaacgttaggccttgcc

SEQ ID NO: 183 - DNA, 25 bp, Artificial Sequence
  Synthetic oligonucleotide probe
cgaagggagtgatgtccagagtgat

SEQ ID NO: 184 - DNA, 25 bp, Artificial Sequence
  Synthetic oligonucleotide probe
cgaagggagtgaagtccagagtgat

SEQ ID NO: 185 - DNA, 25 bp, Artificial Sequence
  Synthetic oligonucleotide probe
tatccaaaggagatcgcagtaatca

SEQ ID NO: 186 - DNA, 25 bp, Artificial Sequence
  Synthetic oligonucleotide probe
tatccaaaggagttcgcagtaatca

SEQ ID NO: 187 - DNA, 25 bp, Artificial Sequence
  Synthetic oligonucleotide probe
ttggatcttatcgctgtgtggtccg

SEQ ID NO: 188 - DNA, 25 bp, Artificial Sequence
  Synthetic oligonucleotide probe
ttggatcttatcactgtgtggtccg

SEQ ID NO: 189 - DNA, 25 bp, Artificial Sequence
  Synthetic oligonucleotide probe
accagatcagcactgtaagaacacc

SEQ ID NO: 190 - DNA, 25 bp, Artificial Sequence
  Synthetic oligonucleotide probe
accagatcagcagtgtaagaacacc

SEQ ID NO: 191 - DNA, 25 bp, Artificial Sequence
  Synthetic oligonucleotide probe
gctataagtgcattgatctttgtcc

SEQ ID NO: 192 - DNA, 25 bp, Artificial Sequence
  Synthetic oligonucleotide probe
gctataagtgcactgatctttgtcc

SEQ ID NO: 193 - DNA, 25 bp, Artificial Sequence
  Synthetic oligonucleotide probe
gtccaccaggacaacatttattagg

SEQ ID NO: 194 - DNA, 25 bp, Artificial Sequence
  Synthetic oligonucleotide probe
gtccaccaggacgacatttattagg

SEQ ID NO: 195 - DNA, 25 bp, Artificial Sequence
  Synthetic oligonucleotide probe
agtagctataaccttgcacggttct

SEQ ID NO: 196 - DNA, 25 bp, Artificial Sequence
  Synthetic oligonucleotide probe
agtagctataactttgcacggttct

SEQ ID NO: 197 - DNA, 25 bp, Artificial Sequence
  Synthetic oligonucleotide probe
atggaggacgtgtgcggccgcctgg

SEQ ID NO: 198 - DNA, 25 bp, Artificial Sequence
  Synthetic oligonucleotide probe
atggaggacgtgcgcggccgcctgg

SEQ ID NO: 199 - DNA, 25 bp, Artificial Sequence
  Synthetic oligonucleotide probe
gacctgcagaagcgcctggcagtgt

SEQ ID NO: 200 - DNA, 25 bp, Artificial Sequence
  Synthetic oligonucleotide probe
gacctgcagaagtgcctggcagtgt

SEQ ID NO: 201 - DNA, 25 bp, Artificial Sequence
  Synthetic oligonucleotide probe
tcagcccccaactctgcctgatgcc

SEQ ID NO: 202 - DNA, 25 bp, Artificial Sequence
  Synthetic oligonucleotide probe
tcagcccccaacactgcctgatgcc

SEQ ID NO: 203 - DNA, 25 bp, Artificial Sequence
  Synthetic oligonucleotide probe
ggtctttggcccggccccagggatc

SEQ ID NO: 204 - DNA, 25 bp, Artificial Sequence
  Synthetic oligonucleotide probe
ggtctttggcccagccccagggatc

SEQ ID NO: 205 - DNA, 25 bp, Artificial Sequence
  Synthetic oligonucleotide probe
ggatatgactgaggtgatcagcagc

SEQ ID NO: 206 - DNA, 25 bp, Artificial Sequence
  Synthetic oligonucleotide probe
ggatatgactgacgtgatcagcagc

SEQ ID NO: 207 - DNA, 25 bp, Artificial Sequence
  Synthetic oligonucleotide probe
ccagaggcccgtgttgggaacctgg

SEQ ID NO: 208 - DNA, 25 bp, Artificial Sequence
  Synthetic oligonucleotide probe
ccagaggcccgttttgggaacctgg

SEQ ID NO: 209 - DNA, 25 bp, Artificial Sequence
  Synthetic oligonucleotide probe
gaaaaacaactcatgatagaaaatg

SEQ ID NO: 210 - DNA, 25 bp, Artificial Sequence
  Synthetic oligonucleotide probe
gaaaaacaactcgtgatagaaaatg